(19) United States
(12) Patent Application Publication
(10) Pub. No.: US 2024/0236941 A1
(43) Pub. Date: Jul. 11, 2024

(54) METHODS, ARCHITECTURES, APPARATUSES AND SYSTEMS FOR DOWNLINK SMALL DATA TRANSMISSION (DL SDT) AND RECEPTION IN INACTIVE RADIO ACCESS NETWORK (RAN) STATE

(71) Applicant: InterDigital Patent Holdings, Inc., Wilmington, DE (US)

(72) Inventors: Ali Esswie, Montreal (CA); Hussain Elkotby, Conshohocken, PA (US); Ravikumar Pragada, Warrington, PA (US)

(21) Appl. No.: 18/279,948

(22) PCT Filed: Mar. 7, 2022
(86) PCT No.: PCT/US2022/019112

§ 371 Date: Sep. 1, 2023

Related U.S. Application Data
(60) Provisional application No. 63/158,186, filed on Mar. 8, 2021.
(60) Provisional application No. 63/225,681, filed on Jul. 26, 2021.

(51) Int. Cl. H04W 68/02; H04L 1/1829; H04W 74/0833

(52) U.S. Cl. CPC H04W 68/02; H04L 1/1864; H04W 74/0833

(57) ABSTRACT

Procedures, methods, architectures, apparatuses, systems, devices, and computer program products are disclosed that may be implemented in a wireless transmit/receive unit (WTRU), such as where the WTRU is in an inactive and/or idle (e.g., RRC) state. In one representative method, the WTRU may receive a downlink (DL) small data transmission (SDT) indication with respect to a paging occasion. The WTRU may receive the indicated DL SDT payload which may be multiplexed with a paging record for the paging occasion and/or with one or more configured DL SDT PDSCH resources. Hybrid automatic repeat request (HARQ) feedback information for the DL SDT payload may be transmitted using configured PUCCH resources and/or may be multiplexed with a random access channel (RACH) procedure. The DL SDT payload may be received by the WTRU without transitioning to a connected (e.g., RRC) state.

### CROSS-REFERENCE TO RELATED APPLICATIONS

This application claims the benefit of U.S. Provisional Patent Application Nos. (i) 63/158,186 filed 8 Mar. 2021, and (ii) 63/225,681 filed 26 Jul. 2021; each of which is incorporated herein by reference.

### BACKGROUND

The present disclosure is generally directed to the fields of communications, software and encoding, including, for example, to methods, architectures, apparatuses, systems directed to wireless communications and, for example to methods, apparatus and systems for downlink small data transmission and reception for a wireless transmit/receive unit (WTRU) in an inactive radio resource control (RRC) state.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating a procedure for small data transmission in the downlink direction;

FIG. 3 is a diagram illustrating a representative procedure for enabling small data transmission in the downlink direction;

FIG. 4 is a diagram illustrating a representative procedure for configuring downlink small data transmission with respect to a paging occasion;

FIG. 5 is a diagram illustrating a representative communication sequence for downlink small data transmission;

FIG. 6 is a diagram illustrating a representative procedure for configuring downlink small data transmission with respect to multiple paging occasions;

FIG. 7 is a diagram illustrating another representative procedure for enabling small data transmission in the downlink direction;

FIG. 8 is a diagram illustrating another representative communication sequence for downlink small data transmission;

FIG. 9 is a diagram illustrating another representative procedure for enabling small data transmission in the downlink direction;

FIG. 10 is a diagram illustrating another representative communication sequence for downlink small data transmission;

FIG. 11 is a diagram illustrating a representative procedure for downlink small data transmission feedback;

FIG. 12 is a diagram illustrating another representative communication sequence for downlink small data transmission;

FIG. 13 is a diagram illustrating a representative procedure for channel state information (CSI) reporting;

FIG. 14 is a diagram illustrating a representative procedure for configuring downlink small data transmission and CSI reporting;

FIG. 15 is a diagram illustrating a representative communication sequence for downlink small data transmission and CSI reporting;

FIG. 16 is a diagram illustrating multiple representative downlink small data transmission paging procedures;

FIG. 17 is a diagram illustrating a representative procedure for downlink small data early paging indication downlink control information for early paging;

FIG. 18 is a diagram illustrating another representative procedure for downlink small data early paging indication downlink control information for early paging;

FIG. 19 is a diagram illustrating a representative paging record;

FIG. 20 is a diagram illustrating representative downlink small data transmission paging with feedback procedures;

FIG. 21 is a diagram illustration a representative procedure for a WTRU to receive a DL SDT payload and provide HARQ ACK/NACK associated with the DL SDT payload FIG. 22 is a diagram;

FIG. 22 is a diagram illustration another representative procedure for a WTRU to receive a DL SDT payload and provide HARQ ACK/NACK associated with the DL SDT payload FIG. 24 is a diagram;

FIG. 23 is a diagram illustration yet another representative procedure for a WTRU to receive a DL SDT payload and provide HARQ ACK/NACK associated with the DL SDT payload;

FIG. 24 is a diagram illustration a representative procedure for a network entity to send a DL SDT payload and receive HARQ ACK/NACK associated with the DL SDT payload;

FIG. 25 is a diagram illustration another representative procedure for a network entity to send a DL SDT payload and receive HARQ ACK/NACK associated with the DL SDT payload;

FIG. 26 is a diagram illustration yet another representative procedure for a network entity to send a DL SDT payload and receive HARQ ACK/NACK associated with the DL SDT payload;

FIG. 27 is a diagram illustration a representative procedure for a WTRU to receive a DL SDT payload;

FIG. 28 is a diagram illustration a representative procedure for a network entity to send a DL SDT payload;

FIG. 29 is a diagram illustration a representative procedure for configuring a WTRU to receive a DL SDT payload;

FIG. 30 is a diagram illustration a representative procedure for a network entity to configure a WTRU to receive a DL SDT payload;

FIG. 31 is a diagram illustration a representative procedure for a WTRU to send a CSI report;

FIG. 32 is a diagram illustration another representative procedure for a WTRU to send a CSI report;

FIG. 33 is a diagram illustration a representative procedure for a network entity to receive a CSI report;

FIG. 34 is a diagram illustration another representative procedure for a network entity to receive a CSI report;

FIG. 35 is a diagram illustration a representative procedure for a WTRU to receive a DL SDT payload; and

FIG. 36 is a diagram illustration another representative procedure for a network entity to receive a DL SDT payload.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

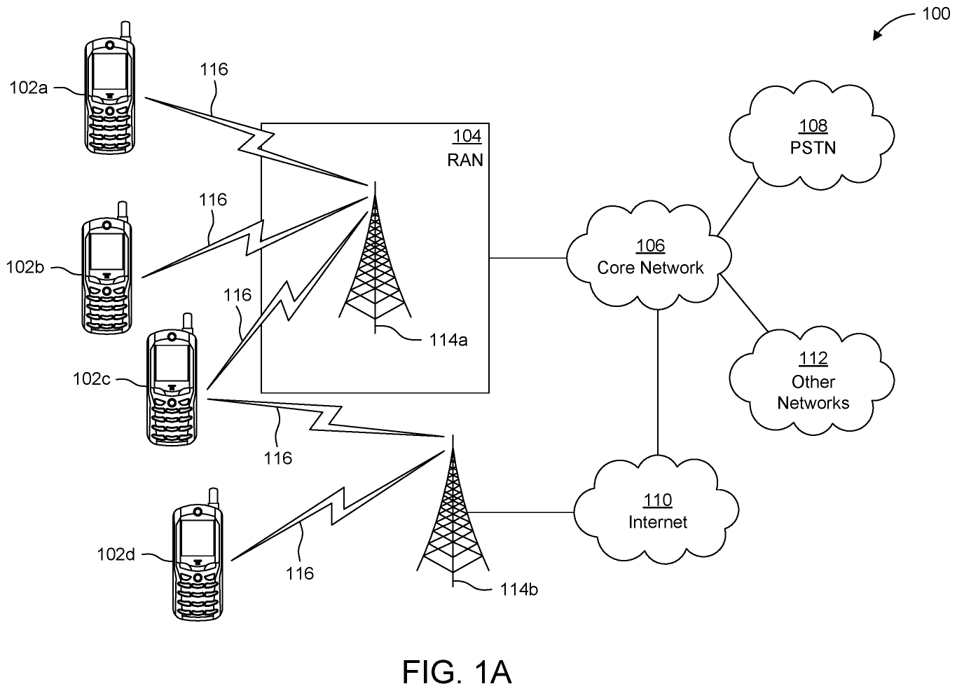

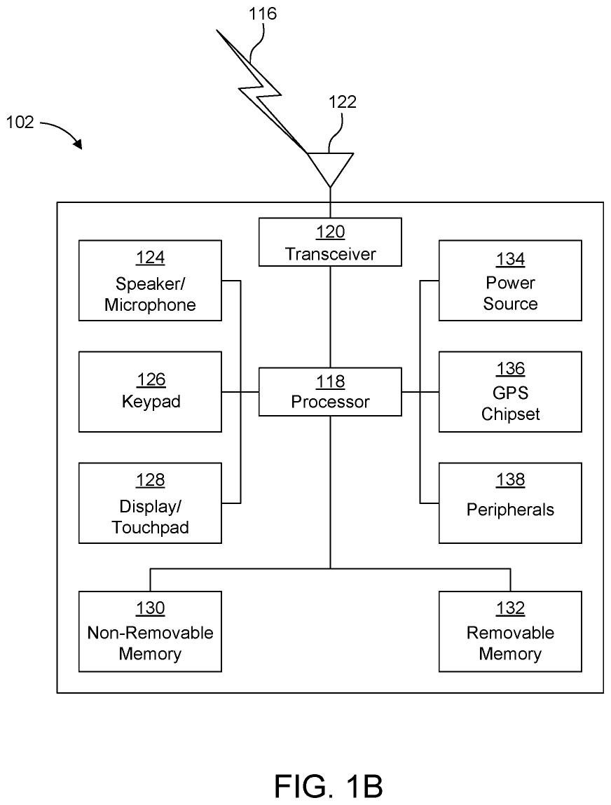

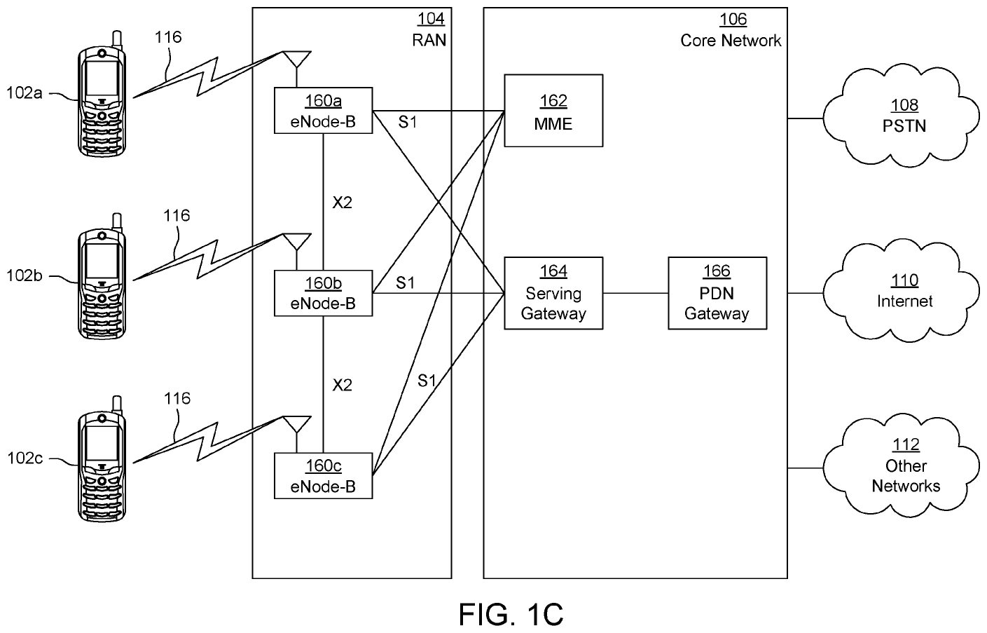

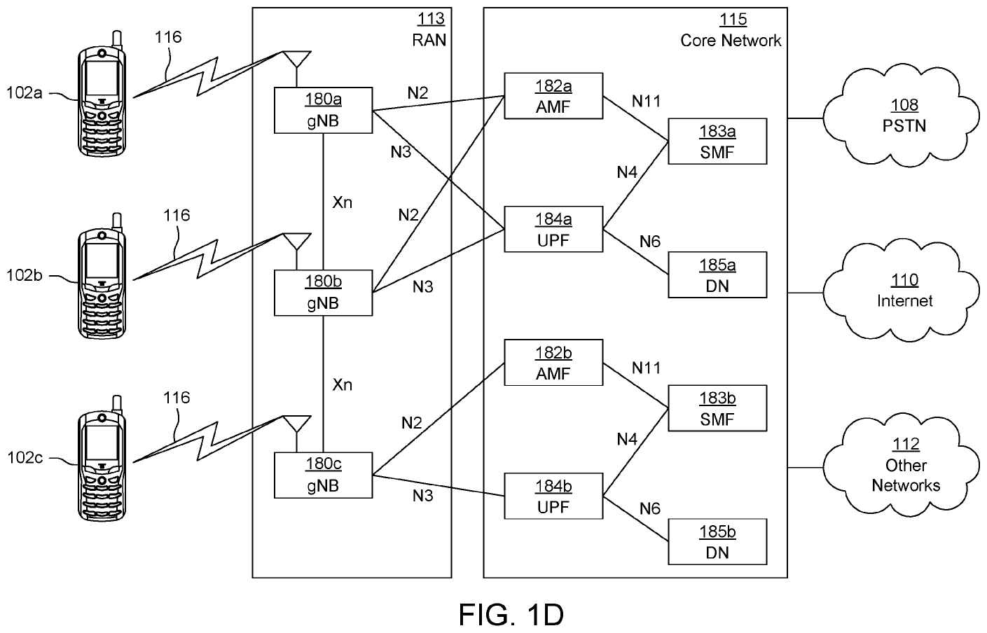

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHZ, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

In certain representative embodiments, methods, apparatus and systems may be implemented for configuration procedures (e.g., dynamic configuration procedures) relating to downlink small data transmission (DL SDT) for one or more WTRUs which are in an INACTIVE mode (e.g., not connected to a RAN).

In certain representative embodiments, methods, apparatus and systems may be implemented for procedures to (e.g., flexibly) handle DL SDT, decode DL SDT and/or manage (e.g., reliably manage) DL SDT.

In certain representative embodiments, methods, apparatus and systems may include a WTRU (e.g., a WTRU in a RRC INACTIVE mode, otherwise referred to herein as an “inactive WTRU”) which is configured to transmit information regarding a DL SDT capability (e.g., a DL SDT capability indication) in an RAN uplink direction to a RAN. The DL SDT capability may be stored in a WTRU specific core-network context information. A WTRU may receive one or more DL SDT configurations by higher-layer signaling (e.g., system information and/or RRC signaling). One or more of the DL SDT configurations may be dynamically updated by lower-layer signaling (e.g., DCI). A DL SDT configuration may include any of a DL SDT indication, at least one DL SDT PDSCH resource set, an indication to activate at least one (e.g., a certain) DL SDT PDSCH resource set, at least one selected DL SDT MCS, a DL SDT HARQ request, a DL SDT HARQ process ID, a DL SDT transport block (TB) size, a DL SDT PDSCH-beam association, and one or more PUCCH/CORESET resources for DL SDT HARQ feedback. An inactive WTRU may decode one or more DL SDT PDSCH occasions, and/or may perform soft-combining of DL SDT PDSCH receptions. An inactive WTRU may transmit (e.g., corresponding) DL SDT HARQ feedback while being in the INACTIVE mode (e.g., RAN inactive mode).

In certain representative embodiments, methods, apparatus and systems may include a WTRU (e.g., an inactive WTRU) may be configured to decode one or more DL SDT payloads on (e.g., indicated) one or more PDSCH resource sets. The inactive WTRU may transmit corresponding one or more-bit DL SDT HARQ feedback (e.g., ACK/NACK) on one or more (e.g., indicated) UL control channel resources, such as on condition that the WTRU is determined to be time aligned with the UL RAN. The inactive WTRU may transmit a DL SDT-specific RACH preamble over a (e.g., next) available RACH occasion, and may multiplex the one or more-bit DL SDT HARQ feedback with the RACH preamble, such as on condition that the WTRU is determined to not be time aligned with the UL RAN. The inactive WTRU may transmit a legacy RACH preamble over the (e.g., next) available RACH occasion, and may multiplex the one or more-bit DL SDT HARQ feedback with a subsequent (e.g., RRC) service request procedure while being in inactive RAN state, such as on condition that the WTRU is determined to not be time aligned with the UL RAN.

In certain representative embodiments, methods, apparatus and systems may include a WTRU (e.g., an inactive WTRU) configured to decode a DL SDT-specific RACH preamble on a (e.g., available) RACH occasion. The inactive WTRU may determine that it is being DL SDT-paged, such as when the WTRU has received one or more by DL SDT-specific configurations. The inactive WTRU may detect and measuring a set of one or more paging-specific reference signals. The inactive WTRU may transmit a DL SDT-specific CSI report while in inactive RAN state. The DL SDT-specific CSI report may be multiplexed with a DL ST-specific RACH. The DL SDT-specific CSI report may be multiplexed with subsequent service request signaling (e.g., RRC signaling).

### Overview

The following abbreviations may be used herein as follows:
RRC Radio resource control;
SSB Synchronization signal block;
SINR Signal to interference noise ratio;
DCI Downlink control information;
RAN Radio access network;
PDCCH Physical downlink control channel;
PDSCH Physical downlink shared data channel;
PUCCH Physical uplink control channel;
CORESET Control resource set;
BWP Bandwidth part;
RS Reference signal;
CSI-RS Channel state information reference signal;
TRS Tracking reference signal;
PO Paging occasion;
SIB System information block;
CE Control element;
AMF Access and mobility function;
UPF User plan function;
RACH Random access channel;
CG Configured grant;
SDT Small data transmission;
HARQ Hybrid automatic repeat request;
RNA Radio notification area;
RNTI Radio network temporary identifier;
ACK Acknowledgment;
NACK Negative ACK;
MCS Modulation and coding scheme; and
TB Transport block.

### Radio Resource Control (RRC) States

During the early stage of the 5G NR specifications of Release-15, there have been several refinements to the RRC layer. The INACTIVE RRC state has been introduced in order to minimize the power consumption and latency of a WTRU(s) attempting to access the radio interface. There are three (e.g., main) RRC states as follows:

RRC IDLE: where the RAN and core networks are unaware about the WTRU status and mobility. No measurement reports nor mobility control may be required. The WTRU context information is not saved at any gNB of the network. The WTRU location is only known to the AMF on the RAN notification area level, which includes a set of neighbouring gNBs in a surrounding geographical area. An idle WTRU (e.g., a WTRU in the RRC IDLE state) may continuously (e.g., periodically) monitor experienced coverage levels of the current selected cell as well as the neighbouring cells. An idle mode WTRU may execute cell reselection operations. For example, a WTRU in the RRC IDLE state may be referred to herein as an idle WTRU. For example, a WTRU in the RRC IDLE state may be referred to herein as a WTRU in idle mode.

RRC INACTIVE: where the RAN is (e.g. fully) unaware of the WTRU status, and mobility. However, the core network entities may keep the WTRU context information such as its own subscription information, access priority, ciphering keys, etc., such that the network core is still fully aware about the WTRU information. When an inactive WTRU (e.g., a WTRU in the RRC INACTIVE state) attempts transitioning to the RRC CONNECTED state (e.g., for payload transmission and/or reception), only the RAN part needs to be established. This way, a faster and less energy consuming transition to the RRC CONNECTED state may be achieved. The 5G NR specifications define multiple triggers and ways for a WTRU to roll back to the RRC INACTIVE state. For example, a WTRU in the RRC INACTIVE state may be referred to herein as an inactive WTRU. For example, a WTRU in the RRC INACTIVE state may be referred to herein a WTRU in inactive mode.

RRC CONNECTED: where the WTRU full status is fully known and controlled by the network. The exact serving cell of a connected WTRU (e.g., a WTRU in the RRC CONNECTED state) is determined, measured, and active for its ongoing transmission. WTRU mobility is fully controlled by the network as well. For example, a WTRU in the RRC CONNECTED state may be referred to herein as a connected WTRU. For example, a WTRU in the RRC CONNECTED state may be referred to herein a WTRU in connected mode.

### Overall Paging Procedure in 5G NR Systems

Any idle/inactive WTRUs (e.g., idle and/or inactive WTRU) may ideally deep sleep (e.g., shut down their transceiver ends) as long as there is not incoming traffic for them. However, for such WTRUs to get notified and/or made aware of any incoming DL payload, the network may configure the idle/inactive WTRU with a periodic set of occasions within one or more certain (e.g., a set of) frames, where the idle/inactive WTRU may periodically wake up, monitor, and/or determine if there is a relevant paging indication (PI) (e.g., for the WTRU).

Specifically, in RRC IDLE/INACTIVE modes, a WTRU may continuously wake up, according to the configured paging cycle, in order to check if one or more WTRUs are being paged in the current paging occasion. Therefore, a WTRU (e.g., idle and/or inactive WTRU) may follow three steps before transitioning to RRC CONNECTED state for getting paged.

As the WTRU may (e.g., initially) be out of sync with the radio interface, such as due to a long sleep period, the WTRU may first attempt re-synching with the radio interface (e.g., RAN) by detecting at least one synchronization signal block (SSB). Different WTRUs, with different implementations (e.g., from various vendors) may require a different number of SSBs (e.g., radio sequences) before WTRU gets in full sync (e.g., re-sync) with the network. For instance, a WTRU in good signal-to-interference-noise-ratio (SINR) conditions may be able to re-sync with the radio network (e.g., RAN) by detecting a single SSB (e.g., sequence signal. A WTRU in poor SINR may require additional SSB instances to re-sync.

After the WTRU is in full sync with the radio network (e.g., RAN), the WTRU may attempt to blindly decode the paging downlink control information (DCI). The paging DCI may be sent on possible physical downlink control channel (PDCCH) occasions (e.g., pre-configured by higher layers). The paging DCI implies an indication to the idle/inactive WTRU that there is at least one WTRU with incoming traffic in the downlink direction. In case there is no paging DCI detected over the PDCCH resources, the WTRU may assume that there is no paging in the current paging opportunity. The WTRU may continue sleeping until the next paging occasion.

After the presence of the paging DCI is detected in a paging occasion, the WTRU may proceed to decode the subsequent physical downlink shared channel (PDSCH) data resources to read a paging record. The paging record is an indication of the ID or IDs of any WTRUs that are being paged. From the WTRU perspective, if the paging record contains its own temporary ID, the WTRU may trigger a random-access procedure in order to switch to the RRC CONNECTED state.

Power Saving Enhancements for 5G NR Idle and/or Inactive WTRUs

Enhancing the performance of the idle/inactive WTRU battery consumption (e.g., power saving capability) related to the paging procedure may be important for current and future cellular networks, such as 5G and beyond. For example, the paging indication may be refined with the aim to improve idle/inactive WTRU battery consumption. As another example, paging-specific reference signals may be provided to assist and/or aid in the paging procedure.

An idle/inactive WTRU may (e.g., always) wake up for a current paging occasion to detect whether there is any paging DCI (e.g., by blindly decoding the possible PDCCH opportunities). If there is not a paging indication, the WTRU may proceed to return to (e.g., continue) sleeping (e.g., deep sleeping) until a next paging occasion. Such blind decoding may draw a considerable amount of WTRU battery power and may be unnecessary in cases where a WTRU or multiple WTRUs are not actually paged.

An early paging indication (EPI) DCI, which precedes the paging occasion, may be provided to indicate whether or not there is a paging DCI over the PDCCH. If there is a false EPI and/or an EPI DCI is not present, a WTRU may assume that at least its paging group is not paged and may return to (e.g., continue) sleeping (e.g., deep sleeping) until a next paging occasion.

An idle/inactive WTRU may wake earlier before each paging occasion to get in full sync with the network. Without being fully synchronized with the RAN, the WTRU will not be able to detect the EPI DCI, paging DCI and/or paging record. Different WTRUs (e.g., from different vendors and/or in different SINR conditions) may require detecting various numbers of SSBs before the paging occasion. The transmission of the SSBs typically has a fixed large periodicity (e.g., minimum of 20 ms). The idle/inactive WTRU may be caused to wake up over a duration of multiple SSBs periods before each paging occasion, which may be a significant limitation on power savings for the WTRU.

The network (e.g., RAN) may transmit aiding paging-specific reference signals that are close in time to a (e.g., each) paging occasion. The idle/inactive WTRU may be caused to only wake up just slightly before an upcoming paging occasion.

### Uplink Small Data Transmission (UL SDT)

There are procedures for UL SDT under discussion and/or agreement in 3GPP, as part of the WTRU power saving efforts for future standards. Such efforts include addressing future vertical use cases such as cellular-based factory automation, where single-shot transmissions (e.g., updates) of a small payload are envisioned. The overall objective is to enable quick UL small data payloads to be transmitted while a WTRU is in the inactive mode (e.g., without running RAN connectivity). In this approach, the signaling overhead as well as the power consumption overhead at the WTRU-side for RAN connectivity activation may be avoided.

There are multiple options for an inactive WTRU to transmit a UL SDT payload without transitioning to connected mode (e.g., connected state):
4-step RACH: when an inactive WTRU has a pending UL payload ready for transmission, the WTRU may transmit a legacy RACH preamble on and/or at an appropriate RACH occasion. The RAN (e.g., gNB) may respond with a random-access response (RAR), including a small UL resource grant. The inactive WTRU may multiplex a UL SDT payload with the respective radio resource control (RRC) request messages. The WTRU may stay in inactive mode and may not transition to connected mode;
2-step RACH: when an inactive WTRU has a pending UL payload ready for transmission, the WTRU may immediately multiplex the UL SDT payload with the msg A of the 2-step RACH (that is corresponding to the RACH preamble and RRC request configurations). The RAN (e.g., gNB) may respond with a RAR success or failure. If the RACH is successful, the UE may return to sleeping (e.g., deep sleeps) and may not transition to connected mode; and
Configured grant: A WTRU may receive configured grant (CG) configurations using higher layer signaling, including periodic granted UL resources. Thus, when an inactive WTRU has a pending UL payload ready for transmission, the WTRU may multiplex the UL SDT payload directly with a RRC request configuration over a first available uplink resource CG occasion. Upon successful reception at the RAN (e.g., gNB), the RAN may respond with an RRC suspend and/or release indication such that the WTRU stays in inactive mode and may not transition to the connected RAN state.

In a case where the first UL SDT transmission has failed, the inactive WTRU may transition to the connected mode. The WTRU may then attempt to retransmit the UL SDT payload on a dynamic grant basis. The foregoing procedures address UL SDT and there remains a need for procedures which address future power and latency critical use cases in the DL direction. The representative embodiments described herein include (e.g., dynamic) procedures for delivering DL SDT and may be applied, for example, to power and/or latency critical WTRUs.

While the methods, apparatus and systems described herein are shown in the context of cellular communications, these methods, apparatus and systems are also applicable to WLAN (e.g., IEEE 802.xx systems) and/or other wireless systems.

As shown below in Table 1 from 3GPP TS 22.104, industrial factories may have the following characteristic parameters.

TABLE 1

| Characteristic parameter | | | | | | |
|---|---|---|---|---|---|---|
| Communication | Communication | | | | | |
| service | service | | Transfer | | | |
| availability: | reliability: | | interval: | | Message | |
| target value | mean time | | target value | | size [byte] | |
| (note 1) | between failures | | (note 12a) | | (note 12a) | Remarks |
| 99.999 9% | — | | <60 s | | <1,500 | Electrical Distribution - |
| | | | (steady state) | | | Distributed automated |
| | | | ≥1 ms | | | switching for isolation and |
| | | | (fault case) | | | service restoration |
| | | | | | | (A.4.4); (note 5) |
| 99.999 9% to | ~10 | years | ≤10 | ms | 1k | Control-to-control in |
| 99.999 999% | | | | | | motion control (A.2.2.2); |
| | | | | | | (note 9) |
| 99.999 9% to | ~10 | years | ≤1 | ms | | Wired-2-wireless |
| 99.999 999% | | | | | | 100 Mbit/s link |
| | | | | | | replacement (A.2.2.4) |
| 99.999 9% to | ~10 | years | ≤1 | ms | | Wired-2-wireless 1 Gbit/s |
| 99.999 999% | | | | | | link replacement (A.2.2.4) |
| 99.999 9% to | ~10 | years | ≤50 | ms | 1k | Control-to-control in |
| 99.999 999% | | | | | | motion control (A.2.2.2); |
| | | | | | | (note 9) |
| >99.999 9% | ~10 | years | 1 ms to 50 ms | | 40 to 250 | Mobile robots (A.2.2.3) |
| | | | (note 6) (note 7) | | | |
| 99.999 9% to | ~1 | month | 4 ms to 8 ms | | 40 to 250 | Mobile control panels - |
| 99.999 999% | | | (note 7) | | | remote control of e.g. |
| | | | | | | assembly robots, milling |
| | | | | | | machines (A.2.4.1); (note 9) |
| 99.999 999% | 1 | day | 8 | ms | 40 to 250 | Mobile Operation Panel: |
| | | | | | | Emergency stop |
| | | | | | | (connectivity availability) |
| | | | | | | (A.2.4.1A) |
| 99.999 99% | 1 | day | 10 | ms | <1024 | Mobile Operation Panel: |
| | | | | | | Safety data stream |
| | | | | | | (A.2.4.1A) |
| 99.999 999% | 1 | day | 10 ms to 100 ms | | 10 to 100 | Mobile Operation Panel: |
| | | | | | | Control to visualization |
| | | | | | | (A.2.4.1A) |
| 99.999 999% | 1 | day | 2 | ms | 50 | Mobile Operation Panel: |
| | | | | | | Haptic feedback data |
| | | | | | | stream (A.2.4.1A) |

| | | | | | |
|---|---|---|---|---|---|
| 99.999 9% to | ~1 | year | <12 ms | 40 to 250 | Mobile control panels - |
| 99.999 999% | | | (note 7) | | remote control of e.g. |
| | | | | | mobile cranes, mobile |
| | | | | | pumps, fixed portal |
| | | | | | cranes (A.2.4.1); (note 9) |
| 99.999 9% to | ≥1 | year | ≥10 ms | 20 | Process automation - |
| 99.999 999% | | | (note 8) | | closed loop control |
| | | | | | (A.2.3.1) |

| | | | | | |
|---|---|---|---|---|---|
| 99.999% | TBD | ~50 | ms | ~100 | Primary frequency control |
| | | | | | (A.4.2); (note 9) |
| 99.999% | TBD | ~200 | ms | ~100 | Distributed Voltage |
| | | | | | Control (A.4.3) (note 9) |

| | | | | | |
|---|---|---|---|---|---|
| >99.999 9% | ~1 | year | 10 ms to 100 ms | 15k to 250k | Mobile robots - video- |
| | | | (note 7) | | operated remote control |
| | | | | | (A.2.2.3) |
| >99.999 9% | ~1 | year | 40 ms to 500 ms | 40 to 250 | Mobile robots (A.2.2.3) |
| | | | (note 7) | | |
| 99.99% | ≥1 | week | 100 ms to 60 s | 20 to 255 | Plant asset management |
| | | | (note 7) | | (A.2.3.3) |

As shown below in Table 2 from 3GPP TS 22.804, industrial railway automation services may have the following characteristics.

TABLE 2

| | | Data rate in | | | Communication |
|---|---|---|---|---|---|
| | Main | Mbit/s per | End-to-end | | service |
| Service | direction | application | latency | | availability |
| MTTC | DL, UL | <1 | <100 | ms | >99.999% |
| Real-time CCTV | UL | >4 | <500 | ms | >99.99% |
| PIS | DL | <1 | <1 | s | <99.99% |
| Emergency voice | DL, UL | <1 | <200 | ms | >99.99% |
| Passenger | DL | ≥0.2 | <10 | s | <99.9% |
| internet access | | | | | |
| Train diagnostics | UL | >0.1 | <1 | s | <99.99% |
| CCTV | UL | ≥1000 | <100 | ms | >99.99% |
| offload/archiving | | | | | |

The characteristics shown in Tables 1 and 2 define new use cases and quality of service (QOS) requirements. The larger battery lifetimes and/or the tighter communication latency budgets call for a more flexible handling of small payload transmissions.

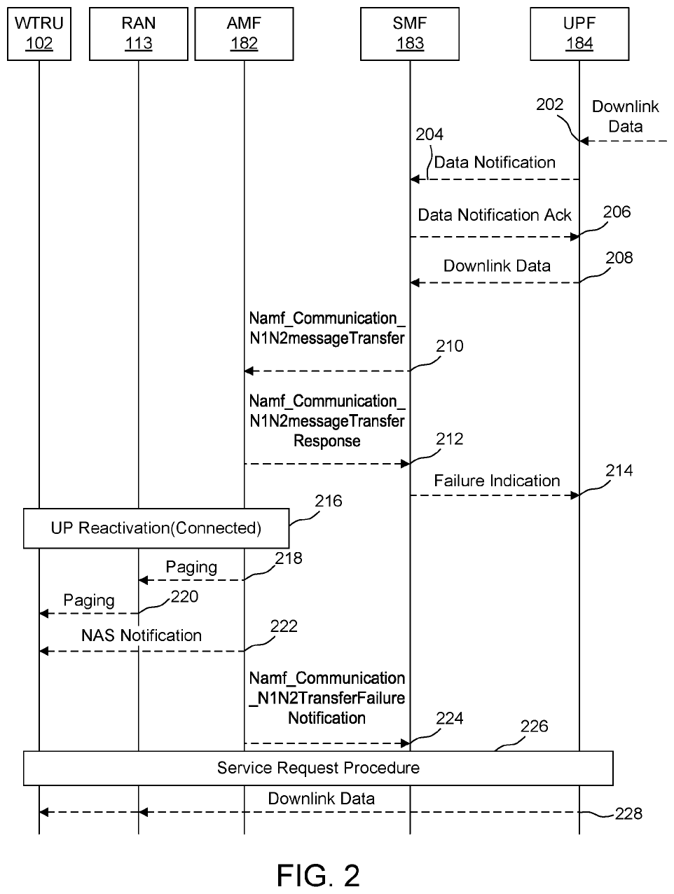

FIG. 2 is a diagram illustrating a representative procedure for small data transmission in the downlink direction. With respect to the DL direction, an arriving small data packet at the user plane function (UPF) in the 5G core network may first be buffered at 202, such as until a WTRU connection is (re-)established and the corresponding RAN bearers are activated, as depicted at 216 in FIG. 2. At 204, a data notification may be sent from the UPF to the SMF. At 206, the SMF may send a data notification acknowledgement (e.g., ACK) to the UPF. At 208, the UPF may send the downlink data to the SMF. a The SMF may send Namf_Communication_N1N2MessageTransfer to the AMF at 210. At 212, the AMF may send a Namf_Communication_N1N2MessageTransfer response to the SMF. The SMF may send a failure indication to the UPF at 214. At 218, the AFM may send a paging trigger to a last known serving cell of the intended WTRU (e.g., of the small data packet). After, the last serving cell may relay a corresponding paging indication to all other neighbouring cells in the same radio notification area (RNA) at 220. At 222, the AMF may provide a NAS notification to the WTRU 102. At 224, the AMF may provide a Namf_Communication_N1N2TransferFailure notification to the SMF. Therefore, all cells in the RNA may transmit the paging indication, during the configured paging occasions, and over which the intended inactive WTRI should be waking up and continuously monitoring. When the inactive WTRU determines it, or its group, is being paged, the WTRU may trigger the signaling-heavy RAN activation process (e.g., a service request procedure) at 226. The inactive WTRU may first send a RACH preamble on the first available RACH occasion and may use a corresponding best selected beam. Then, the RAN node may respond with a random-access response with a potential uplink grant for the WTRU to transmit its RAN context information. Upon receiving the RAR and the corresponding uplink grant, the WTRU transmits its radio context information, such as in the form of an RRCSetupRequest or RRCResumeRequest. Upon the serving RAN node accepting the radio context information and service request, the RAN node may respond back with an acknowledgment alongside a DL resource grant for transmitting the incoming small downlink packet, and any associated downlink transmission configurations. After, the WTRU may, at 228, decode the downlink small payload received over the indicated resources. Upon the RAR message indicating a RACH failure, such as due to a potential RACH collision, the inactive WTRU may retransmit the RACH preamble with an incremental power boost over a next available RACH occasion and may use a determined best radio beam.

As should be apparent from FIG. 2 for transmitting a small packet payload in the downlink direction, the inactive WTRU may monitor the paging occasions and perform the RAN re-activation procedure before the downlink small payload can be received. The WTRU has to transition into the RAN connected state before receiving downlink payload. This may lead to significant power consumption at the WTRU side due to the signaling heavy RAN re-activation procedure and the extended waking up periods. This may also lead to increased RAN signaling overhead that is larger than the actual downlink payload in cases of small data payloads.

One potential option is to (e.g., always) keep an intended WTRU in connected mode so the WTRU may quickly receive any packets which may sporadically arrive without having to monitor the paging occasion in idle/inactive mode. In cases where the inter-packet arrival rate is large, such as in Tables 1 and 2, where the mean packet arrival may be in terms of seconds, a WTRU kept in connected mode may be costly in terms of power consumption. For example, a connected WTRU may have to report channel measurements periodically, and/or continuously monitor control information for a CSI request (e.g., event-triggered) so that the serving RAN node may control the inter-node mobility of multiple WTRUs (e.g., even when data packets are not available for the WTRUs).

For example, keeping a WTRU in the RAN connected state in order to receive a small DL payload may avoid frequent transition between the inactive and the connected RAN states. This may be problematic in terms of incurring increased WTRU power consumption, such as in conditions having larger mean inter-packet arrival rates.

For example, keeping a WTRU in the inactive state and transitioning to the connected RAN state for a (e.g., every) DL small payload transmission may be problematic as it may impose significant and/or frequent overhead signaling due to performing the service request procedure prior to data reception, and additional power consumption associated therewith. As an example, an inactive WTRU may be expected to transmit hundreds of bytes to transition to the connected state in order to receive a small DL payload, such as a 50 byte-payload.

Both examples, may lead to significant power consumption at the WTRU, such as due to multiple control transmissions and receptions and extended waking up times. Relatively large RAN control signaling overhead may also be incurred as compared to the actual size of the downlink small payload. It may be desirable to implement procedures for DL small data transmissions while the WTRU is in the inactive state. Such procedures may be implemented in low-mobility use cases. Avoiding RAN re-activation signaling when a small downlink transmission is foreseen and reducing WTRU wake-up time may improve power consumption for an inactive WTRU.

As used herein, the following terms may be defined as follows.

Paging bandwidth part may refer to a radio bandwidth part where a paging procedure and corresponding signaling is performed. This may be a configured bandwidth part of the radio interface in a 5G NR system.

PDCCH capacity may refer to a control resource set (CORESET) which may be various physical resource block sizes and a duration of single or multiple OFDM symbols for a PDCC. Each bandwidth part may have up to three CORESETs. A gNB may decide the PDCCH size according to the size of control information to be sent to WTRU(s), WTRU SINR conditions (e.g., which are not known at the gNB for an inactive WTRU) and/or the size of downlink allocations. The PDCCH capacity may be a bottleneck of a radio system. The transmission of multiple control information elements transmitted may imply a larger CORESET size within a bandwidth part which accordingly reduces the available CORESET size for other data allocation information. Utilizing a maximum CORESET size of each bandwidth part may imply less resources are available for data transmission, and may cause reduced spectral efficiency.

PDCCH blind decoding may refer to where the PDCCH indicates to WTRUs about any corresponding upcoming DL or UL assignments and corresponding radio configurations. PDCCH transmissions, and respective downlink control information (DCI), have a wide sets of formats and sizes in bits. The network may need to send a larger amount of DCI bits (e.g., long DCI formats). At other times, the network may need to send a smaller amount of DCI bits (e.g., short DCI formats). In both cases, the format and/or structure of the PDCCH transmission as well as the corresponding size may dynamically vary in time. In general, WTRUs may not be aware of such dynamic adaptation. A WTRU may be configured (e.g., by higher level signaling) for several common and/or WTRU-specific resource candidates of the PDCCH transmissions. A WTRU may continuously monitor and attempt to blindly decode the PDCCH candidates using an assigned RNTI ID. The blind decoding implies that the WTRU, at the time of the decoding, is not aware whether the PDCCH transmission is meant for them or not. For example, if a WTRU detects a cyclic redundancy check (CRC) error after the decoding operation, the UE may skip the PDCCH candidate. Generally, blind decoding is not energy efficient, and the number of attempted blind decoding attempts should be minimized.

CSI-RS, TRS and/or RS may refer to a reference signal from a RAN node for the WTRU to estimate channel conditions and/or to get in a full-sync state with the network. A reference signal may be dynamically scheduled and/or transmitted in the DL direction. As used herein, a reference signal may refer to any CSI-RS, TRS and/or similar reference signal.

### Procedures for DL SDT in Inactive RAN State

In certain representative embodiments, a WTRU (e.g., an inactive WTRU) may perform procedures for DL SDT. The WTRU may perform procedures for DL SDT without transitioning to the RAN connected state. A WTRU may indicate a capability of receiving the DL SDT procedure. The WTRU may indicate such capability while being in inactive mode or another mode. Such indication may enable backward compatibility with one or more legacy WTRUs which may only receive DL packets while being in RAN connected mode. A DL SDT capable WTRU may receive one or more corresponding DL SDT configurations (e.g., using higher and/or lower level signaling) from a currently selected cell. Such configurations may inform the WTRU on how to expect and/or blindly decode an available DL SDT indication, and/or may inform the WTRU as to a corresponding payload transmission configuration. For example, a payload transmission configuration may inform the WTRU as to any of (1) whether the DL SDT is multiplexed with a certain paging message, (2) whether the DL SDT is transmitted over WTRU-dedicated and/or WTRU-group-common downlink data resources (e.g., resource sets), (3) a transmission configuration for the DL SDT such as the MCS level, and/or (4) a feedback procedure for the WTRU to follow. When an inactive WTRU receives a DL SDT indication, the WTRU may proceed to decode a DL SDT resource set, such as according to a received DL SDT configuration. On condition that a DL SDT is received successfully, the inactive WTRU may stay (e.g., remain) in inactive mode and/or may not transition into connected mode. On condition that a DL SDT is not received successfully, the WTRU may (e.g., immediately) transmit a corresponding DL SDT HARQ NACK on PUCCH resources (e.g., PUCCH resources of CORESET 0 and/or a paging BWP CORESET). The PUCCH resources may be indicated by the DL SDT configurations. On condition that a DL SDT is not received successfully, the WTRU may (e.g., in addition to or in the alternative, trigger the connected state transition signaling, and may indicate the HARQ feedback. After indicating the HARQ feedback, the WTRU may return to inactive mode.

In certain representative embodiments, a WTRU (e.g., an inactive WTRU) may perform procedures for the WTRU (e.g., an inactive WTRU) to proactively indicate any best selected DL beams and/or channel state information (CSI) reporting while in inactive mode. DL SDT transmissions may be optimized, such as by selecting appropriate MCS levels for DL SDT and/or reduced DL SDT overhead.

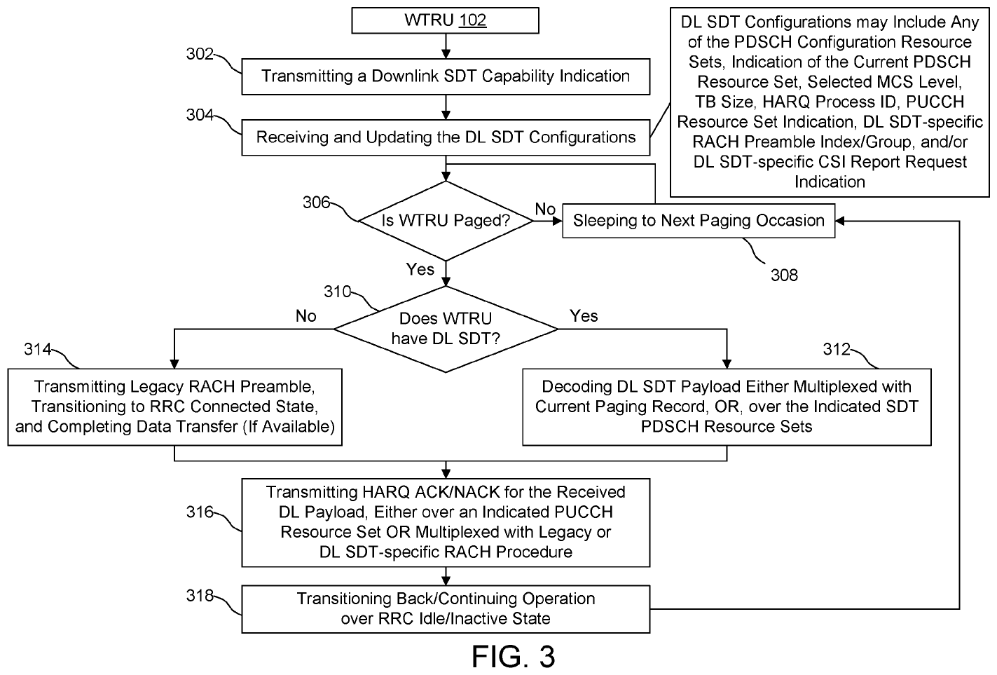

FIG. 3 is a diagram illustrating a representative procedure for enabling small data transmission in the downlink direction. As shown in FIG. 3, a WTRU (e.g., idle, inactive and/or connected WTRU) may perform a procedure to transmit a corresponding DL SDT capability indication at 302 in the RAN uplink direction which may be stored in WTRU-specific core-network context information. The WTRU may receive and/or update one or more DL SDT configurations at 304 by high-layer signaling (e.g., by system information and/or RRC signaling) and/or may be dynamically updated by lower-layer signaling (e.g., DCI). A DL SDT configuration may include any of a DL SDT indication, DL SDT PDSCH resource(s), an indication to activate certain DL SDT PDSCH resources (e.g., resource set), a DL SDT MCS, a DL SDT HARQ process ID, a DL SDT TB size, a DL SDT PDSCH-beam association, and/or PUCCH/CORESET resource(s) for DL SDT HARQ feedback. The inactive WTRU may perform decoding of one or more DL SDT PDSCH occasions, and/or may perform soft-combining of the DL SDT PDSCH receptions. The inactive UEs transmit corresponding DL SDT HARQ feedback while being in the RAN inactive mode.

In certain representative embodiments, a WTRU may transmit a DL SDT capability indication (e.g., an explicit or implicit indication) in the UL direction to a RAN node (e.g., a currently selected RAN node) at 304 as shown in FIG. 3. For example, the DL SDT capability indication may be transmitted as part of a service request procedure, such as when the WTRU was last connected to the RAN. For example, the DL SDT capability information may be stored as part of the CN context information for the WTRU in the 5G core network. When a DL payload is available (e.g., pending) for an inactive UE, the 5G CN is aware whether it can send a DL SDT paging at 306 for the corresponding WTRU or not based on the stored information.

In certain representative embodiments, the WTRU may receive one or more DL SDT configurations using higher layer signaling (SIB, RRC), and dynamically updated using lower layer signaling (DCIs) as shown in FIG. 3. A DL SDT configuration may include any of (1) a DL SDT paging indication, (2) one or more DL SDT PDSCH resources (e.g., resource sets), (3) a selected modulation and coding scheme (MCS), (4) an indication of a HARQ feedback request and/or a corresponding HARQ process ID, (5) a selected TB size, (6) PDSCH-beam association information, (7) PDSCH resource set repetition and/or validity duration information, (8) a PUCCH control resource indication, (9) an inactive CSI report request indication, (10) a DL SDT-specific RACH preamble index/group index.

A DL SDT configuration may include a DL SDT indication. The DL SDT paging indication may inform a WTRU that there is any incoming DL SDT(s) as part of the paging information. The WTRU may not transition to the RAN connected state upon receiving such indication. Upon receiving the DL SDT paging indication, an inactive WTRU may not trigger the (e.g., full) RACH procedure in order to receive the DL SDT. For example, the DL SDT paging indication may be provided in any of an EPI DCI signal, the paging DCI, and/or the paging record message.

A DL SDT configuration may include one or more DL SDT PDSCH resources (e.g., sets). The DL SDT PDSCH resources may be provided as an (e.g., explicit or implicit) indication of any (e.g., one or more) granted DL SDT PDSCH resources. The DL SDT PDSCH resources may be provided in terms of any of a slot index, a starting OFDM symbol, a duration of the grant, and/or an allocated frequency resource blocks (e.g., block groups). For example, a (e.g., serving) RAN node may indicate one or more PDSCH resource sets to a WTRU. Each PDSCH resource set may indicate (e.g., predefined) PDSCH grant information. The RAN may dynamically activate one or more PDSCH resource set for a DL SDT instance.

A default DL SDT PDSCH resource configuration may be provided by higher layer signaling and may be activated for a DL SDT indication provided via any of an EPI DCI, Paging DCI, and/or paging record. Additional DL SDT PDSCH resource set configurations can be provided by higher layers and one or more resource set(s) can be activated by any of an EPI, Paging DCI, and/or paging message.

A DL SDT configuration may include a selected MCS for transmitting a DL SDT. For example, a predefined (e.g., conservative MCS level) may be selected for SDT transmission to improve the reliability of the first transmission. Since there a standard channel measurement procedure may not be provided for an inactive WTRU, the network may be (e.g., always) unaware of the channel conditions of the inactive WTRU. A DL SDT MCS indication may be semi-statically signaled to any inactive WTRU(S) using SIB and/or RRC signaling. Such information can be broadcast information, and may be common for all DL SDT WTRUs and/or WTRU-specific configurations.

As another example, a WTRU may be configured with short CSI reporting while being in inactive mode prior to each DL SDT instance. The inactive CSI reporting may be periodical and/or event triggered based on a dynamic configuration from the RAN node (i.e., an inactive CSI report request) within any of the EPI DCI, paging DCI, and/or the paging record. The (e.g., serving) RAN node may identify the actual WTRU channel conditions before the DL SDT transmission, and hence, a DL SDT MCS may be selected (e.g., optimized) to meet the identified WTRU channel conditions. An updated data MCS level may be signaled to the WTRU prior to a current DL SDT using faster lower layer signaling (e.g., EPI DCI and/or paging DCI).

As another example, upon receiving an inactive CSI request from a RAN node, and detecting an indicated paging RS occasion, the inactive WTRU may (e.g., directly) report a desired MCS level. The desired MCS level may be provided alongside with a respective MCS table index (e.g., if multiple MCS tables are defined). It may be left up to the RAN node as to whether to adopt the WTRU-signaled MCS or not.

A DL SDT configuration may include an indication of a HARQ feedback Request and/or a (e.g., corresponding) HARQ process ID. For example, the indication may inform as to whether the inactive WTRU may report HARQ feedback or not (e.g., for a received DL SDT payload). In cases of requesting DL SDT HARQ feedback, an inactive WTRU may receive multiple DL SDTs and a HARQ process ID may be signaled. Each DL SDT payload may be associated with a dedicated HARQ process ID for the subsequent HARQ feedback. HARQ feedback of a DL SDT may also be carried using the UL SDT procedure without the inactive WTRU transitioning to the connected mode. For example, the inactive WTRU may perform multiplexing the DL SDT HARQ feedback with a 2-step RACH procedure, a 4-step RACH procedure and/or a configured grant procedure (e.g., Type 1 or 2, respectively).

A DL SDT configuration may include a selected transport block (TB) size. The TB size may vary for each DL SDT WTRU. For example, the TB size may vary depending on an incoming payload size and control headers by the upper layers of the protocol stack. To avoid blind decoding of the TB size at the WTRU, the TB indication for each DL SDT may be provided.

A DL SDT configuration may include PDSCH-beam association information. As a (e.g., serving) RAN may not be aware of the (preferred and/or best) DL beams, selected by an inactive WTRU, a RAN node may transmit one or multiple occasions of the DL SDT PDSCH resources. Each PDSCH occasion within a (e.g., indicated) DL SDT PDSCH resource set may be modulated over a certain downlink beam (e.g., PDSCH repetition over DL beams). The RAN node and/or WTRU may perform blind transmissions and/or repetitions of the PDSCH DL SDT payload. For example, there may be a one-to-one correspondence. If the RAN is transmitting N DL beams, and the RAN may transmit the (e.g., same) N DL SDT occasions, each one over a single DL beam.

An inactive WTRU may determine whether (e.g., only) to wake up and decode a DL SDT PDSCH occasion that correspond to a (e.g., selected best) DL beam, and/or decode all and/or a subset of the DL SDT PDSCH occasions and soft combine them for enhanced reliability of the first DL SDT transmission based on the PDSCH-beam association indication.

As another example, the RAN node may request the DL SDT-paged WTRU to transmit a RACH preamble and/or inactive CSI report prior to receiving a DL SDT payload. In such case, the RAN node may identify a best beam selected by the WTRU from the corresponding RACH occasion. The RAN node may then transmit the DL SDT payload (e.g., only) over the best selected DL beam of the WTRU.

A DL SDT configuration may include a PDSCH resource set repetition and/or validity duration. PDSCH resource set repetition and/or validity duration may indicate to the inactive WTRU as to the validity of an activated and/or signaled DL SDT PDSCH resource set. During the validity duration (e.g., period), the intended inactive WTRU may expect to have an intended DL SDT payload to be blindly transmitted and/or repeated. For example, the repetition and/or validity information may be provided when the RAN node configures the inactive WTRU to not report HARQ feedback for a received DL SDT payload. To enhance the DL SDT reliability, the RAN node may repeat the transmission of the DL SDT payload over multiple beams, and/or over several PDSCH resource sets. In case the first DL SDT transmission is not successfully received at the intended inactive WTRU, the WTRU may use subsequent opportunities to receive the (e.g., same) DL SDT payload.

A DL SDT configuration may include a PUCCH control resource indication. To enhance the reliability of the DL SDT transmission, a HARQ scheme should be supported. A serving RAN may indicate to DL SDT WTRU with the corresponding uplink control resources (e.g., PUCCH resources) where the WTRU may transmit back the subsequent HARQ ACK/NACK feedback to any DL SDTs. The PUCCH control resource indication may be part of the paging BWP CORESET and/or the CORESET of the active BWP.

A DL SDT configuration may include an inactive CSI report request indication. For example, the inactive CSI report request indication may inform a WTRU to detect a paging-specific reference signal. The WTRU may formulate and trigger reporting a respective DL SDT-specific CSI report as part of (e.g., multiplexed with) the DL SDT-specific RACH, and/or a temporary service request procedure.

For example, inactive CSI reporting may be configured statically, semi-statically and/or dynamically. The inactive CSI reporting may be configured statically based on a periodical and/or event triggering conditions. If periodic inactive CSI is configured, the inactive CSI reporting periodicity may be signaled by the RAN to the WTRU over SIBs. If event triggered inactive CSI reporting is configured, such as a change of reference signal received power (RSRP) levels or a change of cell for a (e.g., DL SDT-capable or not) WTRU, the RAN may signal the specific inactive RSRP triggering conditions for the CSI reporting. The inactive CSI reporting may be configured semi-statically based on UE-specific higher-layer signaling such as by RRC (e.g., RRCrelease and/or RRCsuspend) where the RAN indicates to the WTRU the updated criteria for the inactive CSI reporting. The indication may include a change of the periodicity, enabling or disabling of inactive CSI reporting. The inactive CSI reporting may be configured dynamically based on (e.g., faster) DCI signaling (e.g., as part of the EPI DCI and/or paging DCI). The RAN may request the WTRU to report the inactive CSI on dedicated occasions and/or resources and/or change a previously configured inactive CSI configuration.

A DL SDT configuration may include a DL SDT-specific RACH preamble index and/or group index. The index and/or group index may indicate for a DL SDT-capable inactive WTRU to trigger a WTRU-specific DL SDT-specific RACH preamble, such as when configured to report its best DL beam and/or DL SDT-specific CSI in case the WTRU is DL SDT-paged. Such configuration of the dedicated and/or WTRU-specific SDT RACH preamble may ensure no inter-WTRU collisions with legacy UEs (e.g., without DL SDT). The index and/or group index may serve to reduce the waking up time of the DL SDT-capable WTRU.

In certain representative embodiments, the WTRU (e.g., the inactive WTRU) may determine whether it is being paged or not and/or whether it has pending DL SDT(s) as shown at 306 in FIG. 3. For example, the inactive WTRU may blindly decode any of the EPI DCI, paging DCI, and/or paging record to determine the presence (or absence) of a DL SDT indication at 310. On condition that the inactive WTRU is not being paged, the inactive WTRU may proceed to sleep until a next paging occasion at 308. On condition that the inactive WTRU is being paged, the DL SDT indication may be scrambled by a paging-RNTI and/or paging-group-RNTI. For example, one or multiple WTRUs may decode the paging DCI when scrambling uses the paging-RNTI. One or more WTRUs may decode the paging DCI and/or paging record, such as by calculating the correct CRC using a (e.g., common) paging-RNTI. In the paging record, the inactive WTRU can determines if it is own RNTI/ID is being DL SDT paged or not.

As another example, one or multiple WTRUs (e.g., within the same paging-group RNTI) may blindly decode the paging DCI and/or paging record, such as by calculating the correct CRC using the group-paging RNTI. In the paging record, the inactive WTRU can determines if it is own RNTI/ID is being DL SDT paged or not.

In certain representative embodiments, the WTRU (e.g., the inactive WTRU) may proceed to decoding any activated and/or indicated DL SDT PDSCH resource(s) (e.g., resource sets) at 312 upon determining that the WTRU is being DL SDT paged as shown in FIG. 3. For example, an inactive WTRU may decode (e.g., only decode) any PDSCH occasion within an activated and/or indicated PDSCH resource set, such as a PDSCH occasion that corresponds to a best selected DL beam. As another example, the inactive WTRU may decode one or more PDSCH occasions on multiple DL beams, such as may be indicated by the signaled PDSCH-beam association, and/or apply soft combining thereto.

In certain representative embodiments, the WTRU (e.g., the inactive WTRU) may proceed to transmit a legacy RACH preamble, transition to the RRC connected state, and may complete data transfer (e.g., if available) upon determining that the WTRU is not being DL SDT paged at 314 as shown in FIG. 3.

In certain representative embodiments, the WTRU (e.g., the inactive WTRU) may transmit DL SDT HARQ feedback (e.g., ACK/NACK) at 316 as shown in FIG. 3. For example, the inactive WTRU may transmit one or more DL SDT HARQ feedback (e.g., ACKs/NACKs) over PUCCH resources (e.g., indicated CORESET 0 and/or paging BWP CORESET resources), such as where the inactive WTRU is still time aligned with an uplink RAN node. The determination of time alignment may be WTRU-specific and may be based on a decreasing timer, such as from a last time for which the WTRU received a time advance from the RAN and/or based on a change of a received RSRP.

The inactive WTRU may transmit a DL SDT-specific or a legacy RACH preamble as shown in FIG. 3. The DL SDT-specific or legacy RACH preamble may be transmitted on an available (e.g., first available) RACH opportunity to the serving RAN node, such as where the inactive WTRU is not time aligned with the uplink RAN node. For example, the inactive WTRU may multiplex the one or more-bit DL SDT HARQ feedback with the RACH preamble. As shown in FIG. 3, the inactive WTRU may not transition to connected mode (e.g., RRC connected state). The inactive WTRU may sleep (e.g., deep sleep) to the next paging occasion. As another example, the inactive WTRU may transmit a RACH preamble and receive a corresponding RAR message from the serving cell. After, the inactive WTRU may multiplex the one or more-bit DL SDT HARQ feedback with subsequent RRC service request signaling (e.g., RRC resume request and/or RRC setup request). As shown in FIG. 3, the inactive WTRU may not transition to connected mode. The inactive WTRU may sleep (e.g., deep sleep) to the next paging occasion.

In certain representative embodiments, on condition that the WTRU is configured by higher/lower layer signaling, the inactive WTRU may transmit a DL SDT-specific or a legacy RACH preamble over an available (e.g., first available) RACH occasion when determining the DL SDT paging indication. The preamble may be transmitted without the inactive WTRU transitioning to the RAN connected state. The RNTI of the WTRU may or may not be multiplexed with the DL SDT-specific or legacy RACH preamble, which may correspond to an incoming DL SDT. For example, multiplexing of the RNTI of the WTRU with the DL SDT-specific or legacy RACH preamble (e.g., short or long preambles) may be performed by appending the WTRU-RNTI payload at the end of each preamble sequence. The generated RACH sequence may include (e.g., in order) a cyclic prefix, a preamble sub-sequence 1, a preamble sub-sequence 2, . . . , the WTRU-RNTI, and any guard symbol(s).

As another example, the multiplexing of the RNTI of the WTRU with the SDT-specific or legacy RACH preamble (e.g., short or long preambles) may be performed at a specific position of the RACH sequence. For example, the RACH format structure may be defined (e.g., redefined) such that the RAN node may decode the WTRU RNTI information within the RACH sequence transmission.

As another example, the multiplexing of the RNTI of the WTRU may be performed with one or more of subsequent RRC messages, such as the RRCSetupRequest and/or RRCResumeRequest.

The serving RAN may identify a (e.g., WTRU preferred and/or best) DL beam from the selected RACH occasion by the inactive WTRU. The RAN may determine whether to transmit the DL SDT (e.g., only) over the identified (e.g., preferred and/or best) DL beam or on multiple DL beams. The serving RAN may indicate to the inactive UE information for the DL SDT-specific beam using the PDSCH-beam association. Using the uplink signaling of the inactive WTRU, the serving RAN may indicate the presence of the intended inactive WTRU to all cells in the corresponding RNA, such that the actual DL SDT may not need to be repeated across all cells in the RNA.

In certain representative embodiments, on condition that the WTRU is configured by higher/lower layer signaling, the inactive WTRU may formulate and reporting a (e.g., short or long) CSI report to the serving RAN while being in the inactive state. For example, the inactive WTRU may detect and measure a paging-specific set of reference signals. For example, the inactive WTR may compile a DL SDT-specific CSI report, such as by following a format configured by the serving RAN. For example, the inactive WTR may transmit a DL SDT-specific RACH multiplexed with the DL SDT-specific CSI report over the available RACH occasion on a (e.g. preferred and/or best) DL beam selected by the WTRU. For example, the inactive WTR may transmit a DL SDT-specific CSI report multiplexed with a subsequent service request procedure (e.g., multiplexed with a RRC resume request and/or RRC setup request). For example, the inactive WTRU may not transition to the RAN connected mode at 318. For example, the RAN may identify a selected cell of the intended inactive WTRU, a (e.g. preferred and/or best) DL beam and/or channel conditions, in terms of a channel quality indication (CQI), based on the received DL SDT-specific signaling from the WTRU. The serving RAN may dynamically adjust the MCS level of a subsequent DL SDT, such as based on the reported CSI. The MCS level (e.g., of the DL SDT) may be indicated to the inactive WTRU by lower layer signaling.

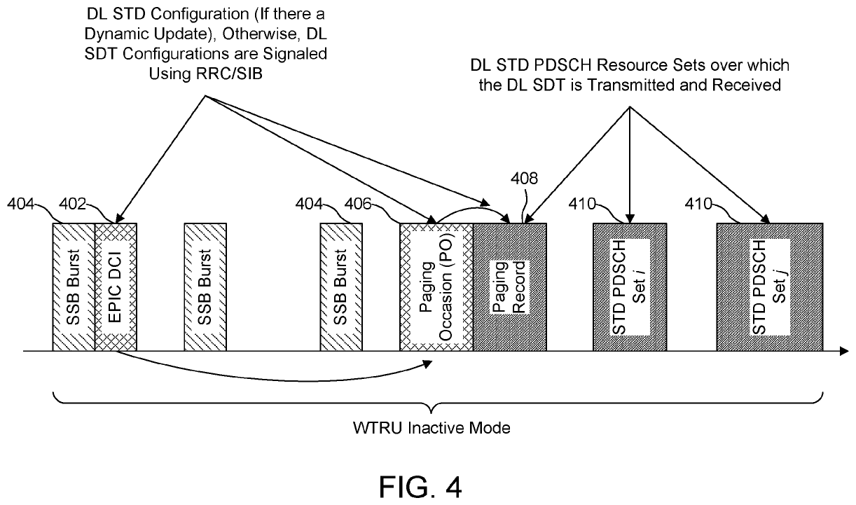

FIG. 4 is a diagram illustrating a representative procedure for configuring downlink small data transmission with respect to a paging occasion. In certain representative embodiments, a WTRU (e.g., idle, inactive and/or connected WTRU) may receive any DL SDT specific configuration by higher layer signaling (e.g., using SIBs or RRC). Any DL SDT configuration may be dynamically updated using lower-layer signaling, such as DCI (e.g., as part of the EPI DCI, or the paging DCI). As shown in FIG. 4, a DL SDT configuration may updated and/or received in any of an EPI DCI 402, such as following a (e.g., first) SSB burst 402, a paging occasion 406, and/or a paging record 408. The DL SDT configuration may updated and/or received by the inactive WTRU (e.g., while in the inactive state). As shown in FIG. 4, a DL SDT instance may be transmitted (and received) using any of a paging record and/or DL SDT PDSCH resources (e.g., resource sets) 410. The WTRU may use signaled one or more PDSCH resources (e.g., resource sets) 410 to decode and receive a corresponding DL SDT while being in the RAN inactive state. For example, a DL SDT payload may be multiplexed with a paging record and may correspond to an intended ID of an inactive WTRU (e.g., the DL SDT payload is scrambled by a WTRU-specific paging RNTI). As another example, the DL SDT payload may be transmitted on dedicated PDSCH resources, such as are indicated by the DL SDT resources signaled (e.g., of any DL SDT configuration). There may be multiple DL SDT paging occasions 406 with various offered downlink capacities (e.g., different time durations and/or frequency resource sizes). One or multiple DL SDT payloads may be fit within a single DL SDT instance.

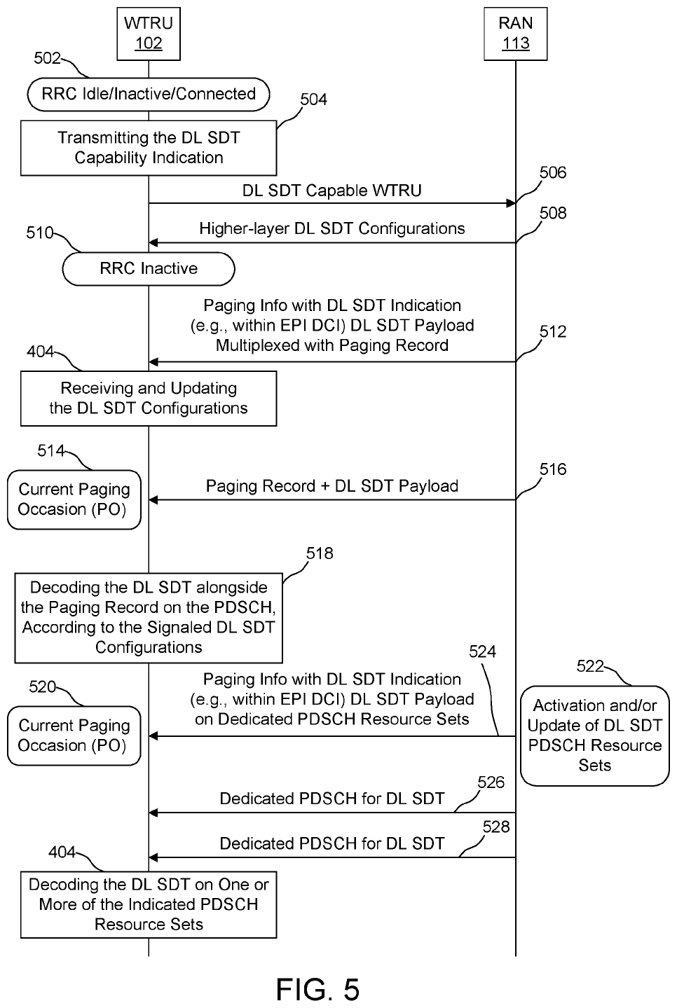

FIG. 5 is a diagram illustrating a representative communication sequence for downlink small data transmission. As shown in FIG. 5, a UE (e.g., WTRU) may begin at 502 by being in any of a RRC idle, inactive or connected state. The WTRU may indicate a DL SDT capability to the RAN interface at 504. The RAN may store information of the DL SDT capability at 506 as part of the WTRU CN context information, such as to be utilized when a small DL payload arrives for the WTRU. The RAN may configure one or more DL SDT configurations at 508, such as by using higher layer signaling, as described herein. For example, the WTRU may receive one or more DL SDT configurations, each configuration may include any of a DL SDT PDSCH resource set, an indication whether the DL SDT payload is multiplexed with a paging record or being transmitted over dedicated PDSCH resource sets, a configuration of the DL SDT resource sets, a predefined and/or default MCS level for DL SDT, and/or default PDSCH-DL-beam-association information. After, the WTRU may transition to the RRC inactive state. The inactive WTRU may, for a current paging occasion 514, receive a DL SDT indication at 512. The inactive WTRU may also receive an indication that the DL SDT payload is to be multiplexed with the paging record at 516 (e.g., of the current paging occasion 514). The inactive UE may proceed to decoding the paging record as well as the DL SDT payload at 518. The decoding may perform according to any signaled and/or activated DL SDT configurations. Over a next current paging occasion at 520, the inactive UE may be configured with (e.g., receive) any DL SDT configuration update and/or activation at 522. The update and/or activation of any DL SDT configurations may indicate dedicated PDSCH resource sets for DL SDT. The update and/or activation may be received within the EPI DCI of the current paging occasion at 524. For example, the DL SDT indication may be sent over the EPI DCI (e.g., indicating DL SDT paging of the inactive WTRU), and the inactive WTRU may skip attempting to decode the subsequent paging DCI and/or paging record. The inactive WTRU may sleep (e.g., deep sleep) over the paging DCI and/or paging record (e.g., by receiving the updated and/or activated the DL SDT configurations and PDSCH resource sets from the EPI DCI). After, the inactive WTRU may then attempt decoding at 530 for the indicated DL SDT PDSCH resource sets transmitted at 526 and 528 in order to receive the one or more DL SDT payloads.

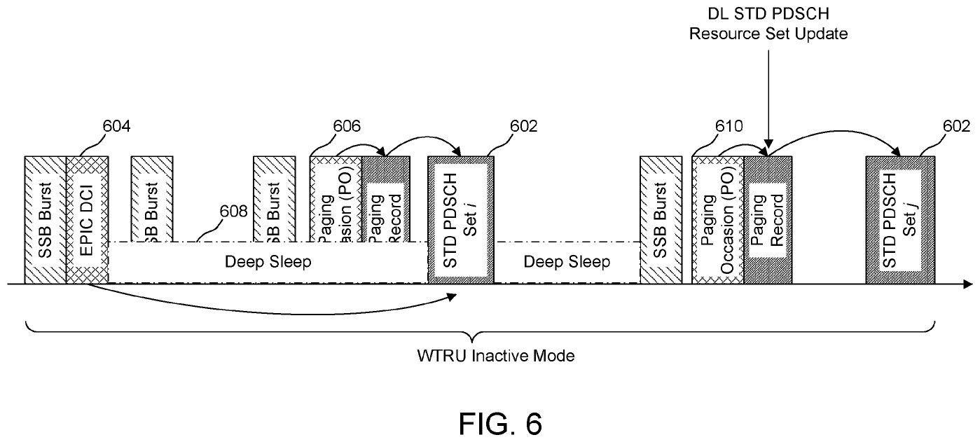

FIG. 6 is a diagram illustrating a representative procedure for configuring downlink small data transmission with respect to multiple paging occasions. As shown in FIG. 6, one or more of the DL SDT PDSCH resource sets 602 may be dynamically updated. For example, in the current EPI DCI 604 (e.g., of the first paging occasion 606), the inactive WTRU may be DL SDT-paged with a DL SDT indication scrambled with the WTRU-specific RNTI. This may provide an early indication (e.g., before the next paging occasion in which DL SDT is expected) to the WTRU of the DL SDT arrival and a configuration of the DL SDT, such as the configured DL SDT PDSCH resources 602 (e.g., one or more PDSCH resource sets). Based on the DL SDT paging (e.g., the current EPI DCI 604), the WTRU may sleep 608 (e.g., deep sleep) up until a time associated with the configured DL SDT PDSCH resources 602 (e.g., the inactive WTRU may skip blind decoding of the legacy paging DCI of the paging occasion 606 and/or decoding of the paging record) since the DL SDT payload has been scheduled on dedicated DL SDT PDSCH resources 602. For a subsequent paging occasion 610 (e.g., the second paging occasion), an EPI DCI may not be transmitted. The inactive WTRU may proceed to blindly decode the paging DCI for this paging occasion 610. If there a true paging DCI (e.g., the WTRU is being paged), the inactive WTRU may decode the paging record and may decode the configured (e.g., previously updated and/or activated) DL SDT PDSCH resources 602. For example, the DL SDT payload may be accommodated by the SDT PDSCH resource set (e.g., SDT PDSCH sets i and/or j). As another example, the DL payload may be larger than can be accommodated by the prior paging occasion 606. The serving RAN may configure the DL SDT PDSCH resources to extend the DL SDT capacity (e.g., accommodate the DL SDT payload). The serving RAN may configure the DL SDT PDSCH resources so that the DL SDT payload may be received using the SDT PDSCH resource set j 602 alone or in addition to one or more other SDT PDSCH resource sets.

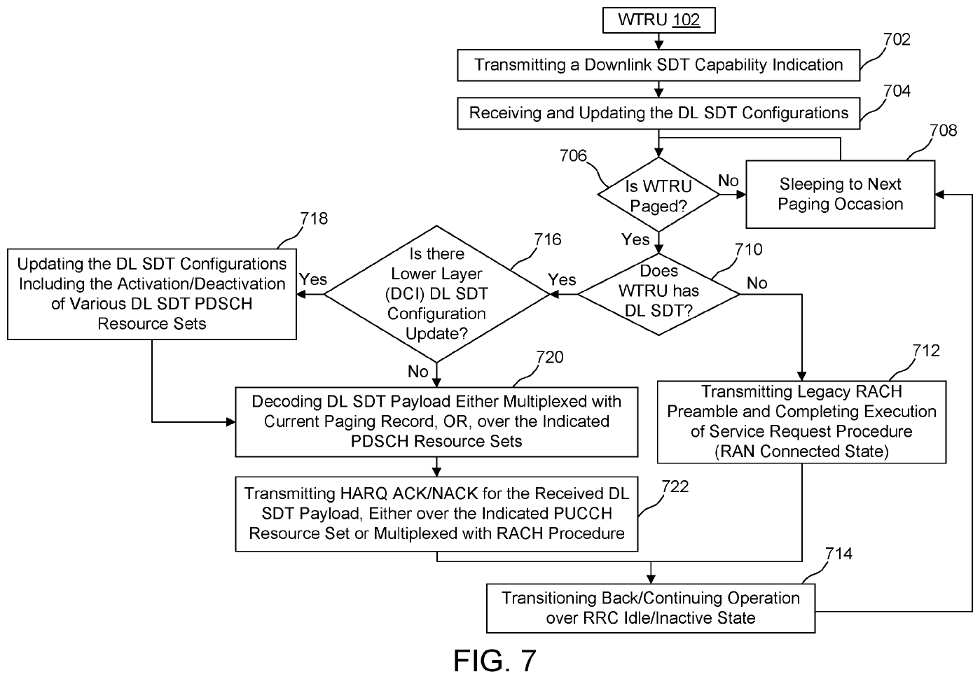

FIG. 7 is a diagram illustrating another representative procedure for enabling small data transmission in the downlink direction. As shown in FIG. 7, a WTRU (e.g., idle, inactive and/or connected WTRU) may perform a procedure to transmit a corresponding DL SDT capability indication at 702 in the RAN uplink direction which may be stored in WTRU-specific core-network context information. The WTRU may then receive and/or update one or more DL SDT configurations by high-layer signaling (e.g., by system information and/or RRC signaling) and/or may be dynamically updated by lower-layer signaling (e.g., DCI) at 704. A DL SDT configuration may include any of a DL SDT indication, DL SDT PDSCH resource(s), an indication to activate certain DL SDT PDSCH resources (e.g., resource set), a DL SDT MCS, a DL SDT HARQ process ID, a DL SDT TB size, a DL SDT PDSCH-beam association, and/or PUCCH/CORESET resource(s) for DL SDT HARQ feedback. The WTRU (e.g., the inactive WTRU) may determine whether it is being paged or not and/or whether it has pending DL SDT(s) at 706 as shown in FIG. 7. On condition that the inactive WTRU is not being paged, the inactive WTRU may proceed to sleep at 708 until a next paging occasion. On condition that the inactive WTRU is being paged as described herein, the inactive WTRU may then determine whether a DL SDT is pending at 710. On condition that there is not a DL SDT pending, the inactive WTRU may proceed to transmit a legacy RACH preamble and execute a service request procedure (e.g., to transition to the RRC CONNECTED state) at 712. After, the WTRU may transition back and/or continue operation in the RRC IDLE and/or INACTIVE state at 714. For example, the WTRU may transition to the RRC INACTIVE state or transition to the RRC IDLE state (e.g., from the RRC CONNECTED state).

On condition that there is a DL SDT pending, the inactive WTRU may then determine whether there is any lower layer signaling (e.g., DCI) of any DL SDT configuration update at 716. On condition that an update is present, the inactive WTRU may update any of the corresponding DL SDT configurations at 718, such as activating and/or deactivating any DL SDT PDSCH resource sets.

As shown in FIG. 7, the inactive WTRU may proceed to (e.g., attempt) to decode the DL SDT payload at 720. The DL SDT payload may be multiplexed with the paging record of the current paging occasion. The DL SDT may also be multiplexed over the configured (e.g., activated) DL SDT PDSCH resource set(s). The inactive WTRU may proceed to transmit HARQ ACK/NACK feedback for the received DL SDT payload at 722. The HARQ feedback may be indicated over any configured PUCCH resource set (e.g., for any activated DL SDT configurations). The HARQ feedback may also be multiplexed with a RACH procedure as described herein. After, the WTRU may transition back and/or continue operation in the RRC IDLE and/or INACTIVE state. For example, the WTRU may transition to the RRC INACTIVE state or transition to the RRC IDLE state after transmitting the HARQ feedback for the received DL SDT payload.

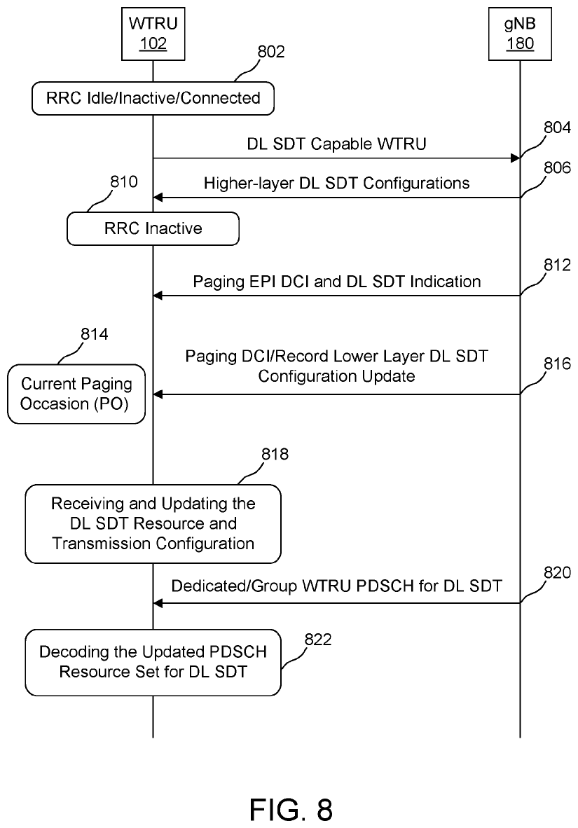

FIG. 8 is a diagram illustrating another representative communication sequence for downlink small data transmission. As shown in FIG. 8, a WTRU (e.g., idle, inactive and/or connected WTRU at 802) may transmit a corresponding DL SDT capability indication in the RAN uplink direction at 804 which may be stored in WTRU-specific core-network context information. The RAN (e.g., a gNB) may send one or more DL SDT configurations by high-layer signaling (e.g., by system information and/or RRC signaling) to the WTRU at 806. The RAN (e.g., a gNB) may send an DL SDT configuration update relating to one or more DL SDT configurations by lower-layer signaling (e.g., by DCI) to the WTRU. After, the WTRU may transition to RRC inactive at 810. The WTRU (e.g., the inactive WTRU) may receive a paging EPI DCI and/or a DL SDT indication from the RAN at 812. The WTRU may then determine whether is being paged or not and/or whether it has pending DL SDT(s) as described herein. For a current paging occasion 814, the WTRU may receive a paging DCI and/or a paging record at 816. For the current paging occasion 814, the WTRU may receive a DL SDT configuration update by lower layer signaling (e.g., DCI) at 81. The WTRU may update the DL SDT configurations according to the received DL SDT configuration update at 818, which may include activating and/or deactivating one or more DL SDT PDSCH resource sets. After, the RAN may send the DL SDT payload using the dedicated PDSCH resources (e.g., the activated PDSCH resource set(s)) at 820. The inactive WTRU may perform decoding on any (e.g., each) of the dedicated PDSCH for DL SDT to receive the DL SDT payload at 822.

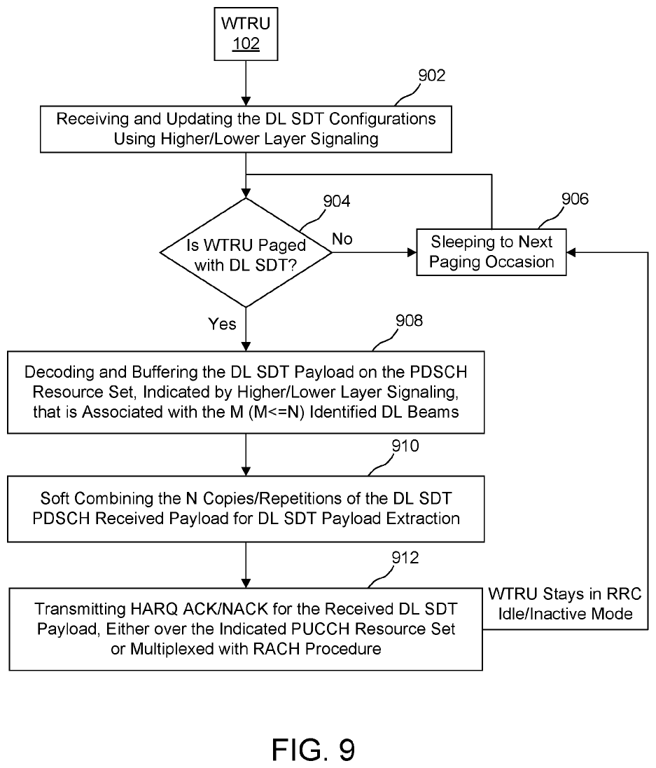

FIG. 9 is a diagram illustrating another representative procedure for enabling small data transmission in the downlink direction. As shown in FIG. 9, a WTRU (e.g., inactive WTRU) may receive one or more DL SDT configurations by high-layer signaling (e.g., by system information and/or RRC signaling) to the WTRU at 902. The RAN (e.g., a gNB) may send an DL SDT configuration update relating to one or more DL SDT configurations by lower-layer signaling (e.g., by DCI) to the WTRU at 902. After the WTRU (e.g., the inactive WTRU) may determine whether a paging EPI DCI and/or a DL SDT indication from the RAN (e.g., gNB) is received or not (e.g., for a current paging occasion) at 904. On condition that the WTRU is not being paged, the WTRU may return to sleep (e.g., deep sleep) until a next paging occasion at 906. On condition that the WTRU is being paged, the inactive WTRU may continue to detect any DL SDT-specific PDSCH occasions on various DL beams at 908. The RAN (e.g., gNB) may not be aware about a selected (e.g., best and/or preferred) DL beam of the inactive WTRU, and the RAN may transmit the DL SDT payload on multiple DL beams. The DL SDT payload transmitted on the multiple DL beams may be multiplexed in the time and/or frequency domains. As shown in FIG. 9, the inactive WTRU may perform decoding and buffering of the DL SDT payload on the one or more (e.g., activated) PDSCH resource sets on that are associated with M (where M≤N) identified DL beams. As described herein, DL beam to PDSCH resource mapping for DL SDT may be signaled to the WTRU by the PDSCH-beam association information as part of one or more DL SDT configurations (e.g., lower-layer and/or higher-layer configured). As one example, the inactive WTRU may attempt to decode (e.g., only decode and/or decode first) a DL SDT PDSCH occasion that corresponds to a selected (e.g., best or preferred) DL beam of the inactive WTRU. As another example, the inactive WTRU may buffer any received PDSCH payloads on one or more DL SDT PDSCH occasions, and perform soft-combining on N copies and/or repetitions of the buffered PDSCH payloads to extract a (e.g., final) DL SDT payload at 910. The soft-combining approach may be useful where DL data resources of the paging BWP are mostly congested and occupied by connected mode WTRUs and the serving RAN may limit the DL SDT PDSCH occasions to a smaller number of DL beams. The soft combining may enhance the reliability of the DL SDT of a first PDSCH occasion (e.g., first DL SDT transmission) by using the received DL SDT of additional beams. Finally, FIG. 8 depicts the corresponding timing diagram of DL SDT-capable UEs receiving and decoding multiple DL SDT PDSCH occasions. The inactive WTRU may proceed to transmit HARQ ACK/NACK feedback for the received DL SDT payload at 912. The HARQ feedback may be indicated over any configured PUCCH resource set (e.g., for any activated DL SDT configurations). The HARQ feedback may also be multiplexed with a RACH procedure as described herein. After, the WTRU may transition back and/or continue operation in the RRC IDLE and/or INACTIVE state. For example, the WTRU may transition to the RRC INACTIVE state or transition to the RRC IDLE state after transmitting the HARQ feedback for the received DL SDT payload

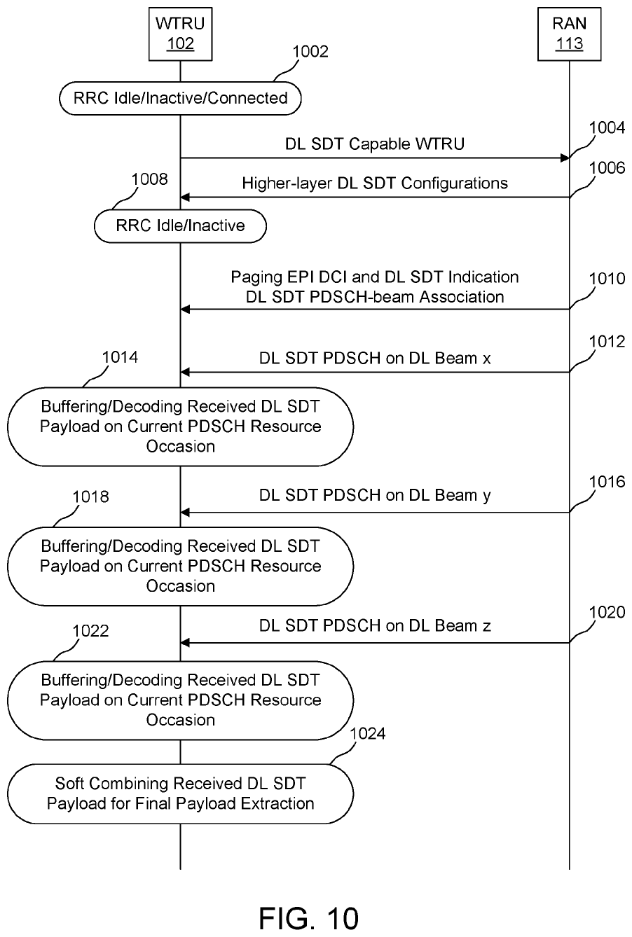

FIG. 10 is a diagram illustrating another representative communication sequence for downlink small data transmission. As shown in FIG. 10, a WTRU at 1002 (e.g., idle, inactive and/or connected WTRU) may transmit a corresponding DL SDT capability indication in the RAN uplink direction at 1004 which may be stored in WTRU-specific core-network context information. The RAN (e.g., a gNB) may send one or more DL SDT configurations by high-layer signaling (e.g., by system information and/or RRC signaling) to the WTRU at 1006. The RAN (e.g., a gNB) may send an DL SDT configuration update relating to one or more DL SDT configurations by lower-layer signaling (e.g., by DCI) to the WTRU at 1006. At least one DL SDT configuration may include DL SDT PDSCH-beam association information. After, the WTRU may transition to idle or inactive mode at 1008, and the inactive WTRU may expect to receive a paging EPI DCI and/or a DL SDT indication from the RAN in a paging occasion at 1010. On condition that the inactive WTRU finds the DL SDT indication present (e.g., for the current paging occasion), the inactive WTRU may proceed to use the DL beam to PDSCH resource mapping of the PDSCH-beam association information to determine relationships between PDSCH occasions for DL SDT and DL beams thereof. As shown in FIG. 10, the inactive WTRU may receive a (e.g., first) DL SDT PDSCH transmitted by a DL beam ‘x’ at 1012. The inactive WTRU may proceed to decode and/or buffer the DL SDT payload for the DL beam ‘x’ at 1014. The inactive WTRU may receive a (e.g., second) DL SDT PDSCH transmitted by a DL beam ‘y’ at 1016. The inactive WTRU may proceed to decode and/or buffer the DL SDT payload for the DL beam ‘y’ at 1018. The inactive WTRU may receive a (e.g., third) DL SDT PDSCH transmitted by a DL beam ‘z’ at 1020. The inactive WTRU may proceed to decode and/or buffer the DL SDT payload for the DL beam ‘z’ at 1022. While three DL beams are shown in FIG. 10, those skilled in the art that this is merely for purposes of explanation and that any plural number of DL beams and/or PDSCH resources may be used in a similar manner. After, the inactive WTRU may decode the buffered DL SDT payloads (e.g., if not already decoded) and may perform soft combining of the multiple decoded DL SDT payloads to extract a (e.g., final) DL SDT payload at 1024.

In certain representative embodiments, an inactive WTRU may decode one or more DL SDT payloads on the indicated (e.g., activated) PDSCH resources (e.g., resource sets) of one or more indicated (e.g., activated) DL SDT configurations. The inactive WTRU may transmit a corresponding one or more-bit DL SDT HARQ feedback (e.g., ACK/NACK) on the indicated uplink control channel resources, such as when the inactive WTRU is determined to be time aligned with the uplink RAN. As another example, the inactive WTRU may transmit a DL SDT-specific RACH preamble over a (e.g., next) available RACH occasion, and multiplex the one or more-bit DL SDT HARQ feedback with the RACH preamble, such as when the inactive WTRU is determined to not be time aligned (e.g., misaligned) with the uplink RAN. As another example, the inactive WTRU may transmit a legacy RACH preamble over a (e.g., next) available RACH occasion, and multiplex the one or more-bit DL SDT HARQ feedback with a subsequent service request procedure (e.g., RRC signaling) while being in RAN inactive state.

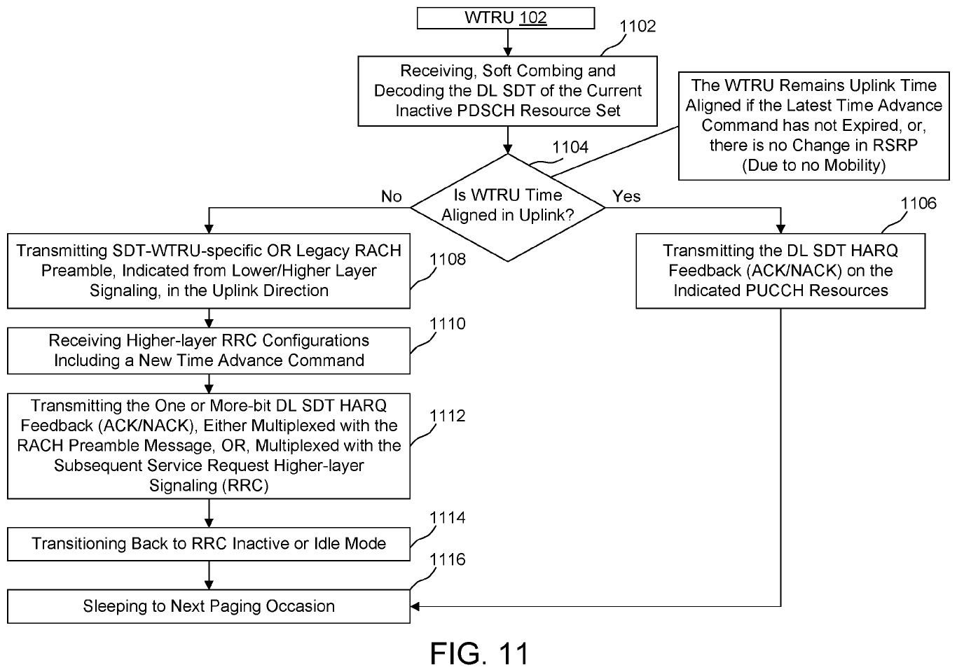

FIG. 11 is a diagram illustrating a representative procedure for downlink small data transmission feedback. In FIG. 11, it may be assumed that a DL SDT capable WTRU has previously received one or more DL SDT configurations and has decoded at least one DL SDT. The one or more DL SDT configurations may (e.g., respectively) include a DL SDT-specific RACH index which the inactive WTRU may use in cases where the DL SDT HARQ feedback may not be transmitted (e.g., are unable to be transmitted) on the indicated PUCCH resources, such as due to uplink time misalignment. It may also be assumed in FIG. 11 that an inactive WTRU may have performed soft combining to determine a DL SDT, such as from one or more activated PDSCH resource sets as described herein at 1102. As shown in FIG. 11, for a current paging occasion, the inactive WTRU may determine whether or not it is time aligned with the uplink RAN at 1104. For example, the inactive WTRU may determine it is time aligned with the uplink RAN, a latest time advance timer (e.g., time advance command) has not expired and/or there is no change in RSRP level(s) at the WTRU.

In FIG. 11, on condition that the inactive WTRU is (e.g., still) time aligned with the uplink RAN, the inactive WTRU may send the DL SDT HARQ feedback (e.g., one or multiple bit HARQ feedback) at 1106, such as for the at least one decoded DL SDT, over the indicated uplink control channel resources (e.g., PUCCH resources). The inactive WTRU may then proceed to sleep (e.g., deep sleep) until a next paging occasion, such as without transitioning to the RAN connected state.

In FIG. 11., on condition that the inactive WTRU is not time aligned with the uplink RAN, the inactive WTRU may trigger a temporary and/or DL SDT-specific RACH procedure at 1108. For example, the inactive WTRU may transmit a DL SDT WTRU-specific and/or a legacy RACH preamble, as indicated from lower and/or higher layer signaling, in the uplink direction to the RAN at 1108. For example, the inactive WTRU may send a DL SDT-specific RACH preamble on an (e.g., next) available and/or appropriate RACH occasion. The SDT-specific RACH indication may provided in the DL SDT lower and/or higher layer configurations. The inactive WTRU may receive a higher-layer RRC configuration which may include a (e.g., new) time advance indication at 1110. After, the inactive WTRU may transmit the one or more-bit DL SDT HARQ feedback at 1112. For example, the inactive WTRU may multiplex the one or more-bit DL SDT HARQ feedback with the SDT-specific RACH. For example, the inactive WTRU may multiplex the DL SDT HARQ feedback with a subsequent service request procedure (e.g., higher-layer RRC signaling). The inactive WTRU may then proceed to sleep at 1116 (e.g., deep sleep) until a next paging occasion, such as without transitioning to the RAN connected state at 1114.

The indication of a DL SDT-specific RACH preamble for DL SDT-capable UEs may serve to enhance the reliability of the HARQ feedback transmission for DL SDT receptions such as the RAR failure may be improved and isolated from that is of the legacy UEs, i.e., DL SDT-non-capable UEs.

In certain representative embodiments, determining whether the inactive WTRU is time aligned with the uplink RAN or not may depend on WTRU implementation. For example, a WTRU may use a standard time alignment timer (TAT), where the expiry of the TAT may indicate that the WTRU is no longer time aligned with the uplink RAN.

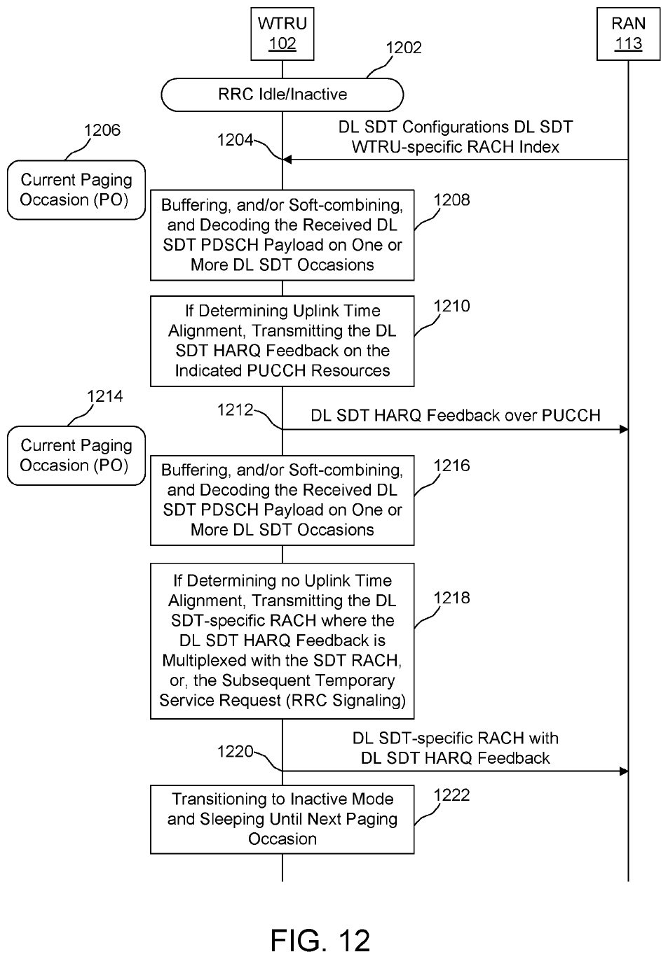

FIG. 12 is a diagram illustrating another representative communication sequence for downlink small data transmission. As shown in FIG. 12, a WTRU (e.g., idle, inactive and/or connected WTRU) at 1202 may receive from the RAN (e.g., a gNB) one or more DL SDT configurations, such as by high-layer signaling and/or lower-layer signaling as described herein, at 1204. At least one DL SDT configuration may include a DL SDT RACH index. For example, the DL SDT RACH index may be WTRU-specific. For a current paging occasion 1206, the inactive WTRU may proceed to buffering and/or decoding of one or more DL SDT payloads on the one or more (e.g., activated) PDSCH resource sets as described herein at 1208. For example, the inactive WTRU may receive one or more DL SDT payloads using the PDSCH resource sets of one or more (e.g., activated) DL SDT configurations at 1208. The WTRU may perform soft combining of the DL SDT payloads, for example. After, the inactive WTRU may determine whether or not there is uplink time alignment with the RAN at 1210. For example, the inactive WTRU may transmit DL SDT HARQ feedback (e.g., one or multiple bit HARQ feedback) over the indicated PUCCH resources on condition that the inactive WTRU is (e.g., still) time aligned with the uplink RAN at 1212.

For a next paging occasion 1214, the inactive WTRU may proceed to buffering and/or decoding of one or more DL SDT payloads on the one or more (e.g., activated) PDSCH resource sets as described herein at 1216. On condition that the inactive WTRU is not time aligned with the uplink RAN, the inactive WTRU may transmit DL SDT HARQ feedback (e.g., one or multiple bit HARQ feedback) which is multiplexed with a RACH preamble message (e.g., a SDT WTRU-specific preamble and/or legacy preamble) at 1220. As another example, the inactive WTRU may transmit DL SDT HARQ feedback (e.g., one or multiple bit HARQ feedback) which is multiplexed with a subsequent (e.g., temporary) service request (e.g., RRC signaling) at 1218.

In certain representative embodiments, a WTRU (e.g., an inactive WTRU) may transmit a DL SDT-specific RACH preamble on an available RACH occasion after determining it is being DL SDT-paged. For example, the RACH preamble may (or may not) include the WTRU-specific RNTI. The inactive WTRU may also be configured by one or more DL SDT configurations to detect and measure a (e.g., set of) paging-specific reference signal(s). The inactive WTRU may generate and/or transmit a DL SDT-specific CSI report while in inactive RAN state. For example, the DL SDT-specific CSI report may be multiplexed with the DL SDT-specific RACH. For example, the DL SDT-specific CSI report may also be multiplexed with a subsequent (e.g., temporary) service request (e.g., RRC signaling). After transmitting the DL SDT HARQ feedback, the WTRU may transition to inactive mode and sleep until a next paging occasion at 1222.

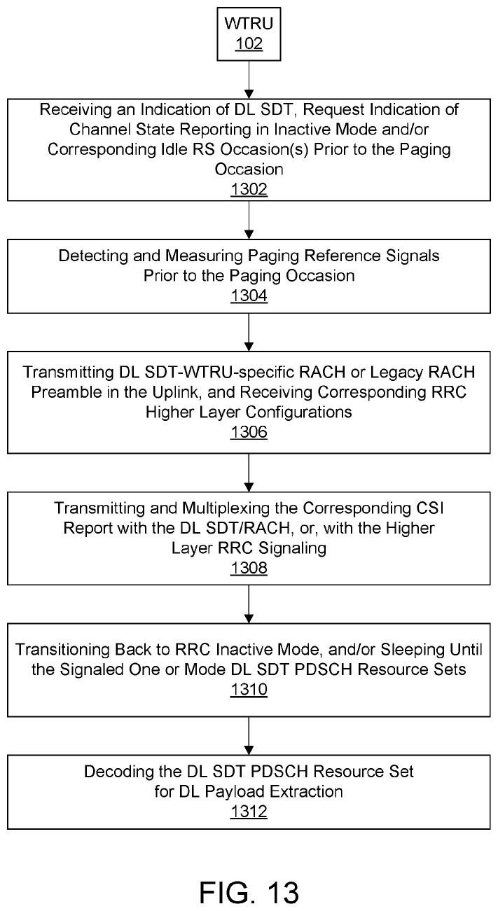

FIG. 13. is a diagram illustrating a representative procedure for channel state information reporting. As shown in FIG. 13, a WTRU (e.g., an inactive WTRU) may decode a DL SDT indication at 1302, such as part of an EPI DCI of a paging occasion. The DL SDT indication may by applicable to (e.g., only to) the particular WTRU. The inactive WTRU may receive a CSI reporting request and/or information for a (e.g., a set of) paging-specific reference signal(s), such as by a DL SDT configuration update. The inactive WTRU may proceed to detecting and measuring the corresponding paging reference signals at 1304. The inactive WTRU may formulate an inactive CSI report based on the measured paging reference signals. The inactive WTRU may transmit a SDT-specific RACH preamble or legacy RACH preamble at 1306, such as described herein, and the inactive WTRU may receive a corresponding higher-layer configuration (e.g., RRC signaling), such as a RAR from the RAN. For example, the inactive WTRU may multiplex the inactive CSI report with the SDT-specific RACH preamble. For example, the inactive WTRU may also multiplex the inactive CSI report with a subsequent (e.g., temporary) service request at 1308(e.g., RRC signaling which follows after transmission of the RACH preamble).

For example, the inactive WTRU may multiplex the inactive CSI report with the indicated DL SDT-specific RACH during an (e.g., next) available RACH occasion. Then, the inactive WTRU may return to sleep (e.g., deep sleep) over (e.g., all) the occasions of the paging DCI and paging record at 1310. The inactive WTRU may not perform any blind decoding of the paging DCI and/or the paging record. The inactive WTRU may wake up (e.g., slightly) before one or more activated DL SDT PDSCH resources (e.g., resource sets) and may receive and decode at least one DL SDT payload from the one or more activated DL SDT PDSCH resources at 1312. For example, the inactive WTRU may time the waking up to account for a power ramp up delay at the WTRU.

Transmission of the inactive CSI information may be on-demand with respect to the RAN. The inactive CSI information may allow the serving RAN (e.g., gNB or the like) to identify a best DL beam to use (e.g., select) for the WTRU which provided the inactive CSI report. For example, after receiving the inactive CSI report, the serving RAN may send a limited number of DL SDT PDSCH payload transmissions (e.g., only over the best DL beam). Moreover, the serving RAN may dynamically adjust a selected MCS level used for a subsequent DL SDT which may enable dynamic link adaptation for any DL SDTs and/or may lead to improving the spectral efficiency of the paging BWP.

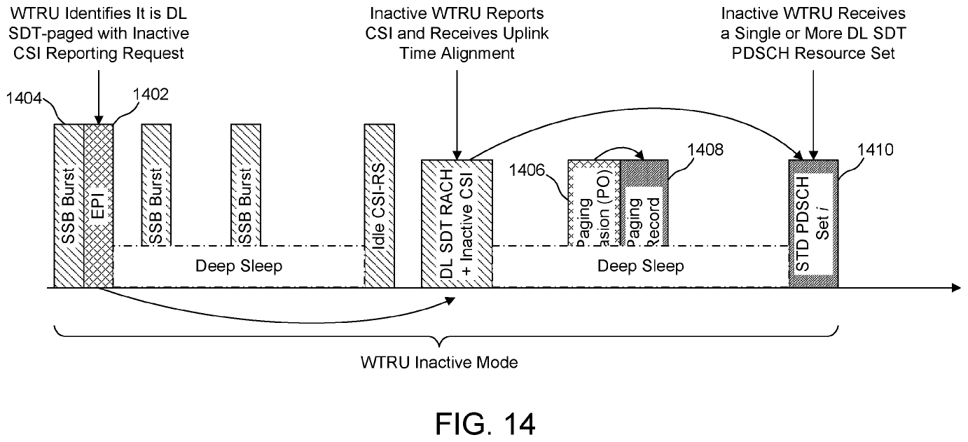

FIG. 14 is a diagram illustrating a representative procedure for configuring downlink small data transmission and CSI reporting. As shown in FIG. 14, an inactive WTRU may perform CSI reporting before receiving one or more DL SDT payloads. For example, the inactive WTRU may receive an EPI DCI 1402, such after a first SSB burst 1404 which precedes a current paging occasion 1406. The inactive WTRU may determine it is being DL SDT paged such as based on the presence of a DL SDT indication in the EPI DCI 1402. The EPI DCI may also include an inactive CSI reporting request (e.g., for the inactive WTRU). The inactive CSI reporting request may also be provided as part of the paging DCI and/or the paging record 1408.

The inactive WTRU may proceed to sleep (e.g., deep sleep) until one or more CSI-RS are transmitted (e.g., idle CSI-RS). The inactive WTRU may measure the CSI-RS and generate an inactive CSI report therefrom. The inactive CSI report may be transmitted by the inactive WTRU as part of a DL SDT RACH occasion. The inactive WTRU may receive information regarding uplink time alignment as part of the DL SDT RACH occasion. For example, the uplink time alignment may be used to keep the inactive WTRU in time alignment with the uplink RAN. As described herein, on condition that the WTRU determines it is time aligned with the uplink RAN, the WTRU may use the indicated PUCCH resources for the transmission of the HARQ feedback. On condition that the WTRU determines that it is not time aligned with the uplink RAN, the WTRU may multiplex the HARQ feedback in a RACH preamble. After the RACH occasion, the inactive WTRU may return to sleep (e.g., deep sleep) until a SDT PDSCH occasion 1410 (e.g., a first activated SDT PDSCH resource set i). for example, the inactive WTRU may sleep through the paging occasion and the paging record. As shown in FIG. 14, the inactive WTRU may receive a DL SDT using the SDT PDSCH resource set i. The SDT PDSCH resource set i may be configured (e.g., updated and/or activated) as shown in FIG. 4, for example. The inactive DL SDT may perform buffering, decoding and/or soft combining of the received DL SDT as described herein.

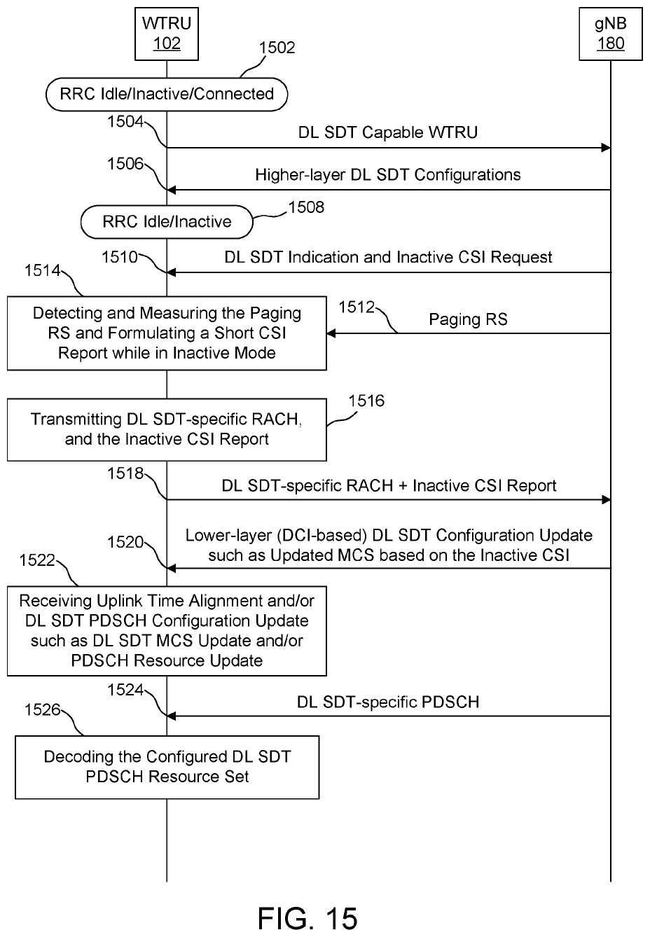

FIG. 15 is a diagram illustrating a representative communication sequence for downlink small data transmission and CSI reporting. As shown in FIG. 15, a WTRU at 1502 (e.g., idle, inactive and/or connected WTRU) may transmit a corresponding DL SDT capability indication in the RAN uplink direction at 1504 which may be stored in WTRU-specific core-network context information. The RAN (e.g., a gNB) may send one or more DL SDT configurations by high-layer signaling (e.g., by system information and/or RRC signaling) to the WTRU at 1506. The RAN (e.g., a gNB) may send an DL SDT configuration update relating to one or more DL SDT configurations by lower-layer signaling (e.g., by DCI) to the WTRU at 1506. At least one DL SDT configuration may include CSI reporting information. After, the WTRU may transition to idle or inactive mode at 1508, and the inactive WTRU may expect to receive a paging EPI DCI and/or a DL SDT indication from the RAN in a respective paging occasion at 1510. As shown in FIG. 15, the inactive WTRU may receive a DL SDT indication and/or an inactive CSI request from the serving RAN (e.g., gNB) at 1510. After, the RAN may transmit one or more RSs (e.g., paging-specific RSs) at 1512 and the inactive WTRU may detect and measure the received RSs at 1514. The inactive WTRU may formulate (e.g., generate) an inactive CSI report based on the measured RSs.

The inactive WTRU may proceed to transmit a DL SDT-specific RACH and the inactive CSI report to the RAN at 1516 and 1518. After, the RAN may send a lower-layer DL SDT configuration update (e.g., using DCI) to the inactive WTRU at 1520. The DL SDT configuration update may include, among other information, any of an updated MCS indication and/or updated PDSCH resources (e.g., to activate and/or deactivate). The RAN may also send the inactive WTRU an uplink time alignment at 1522.

The RAN may proceed to send a DL SDT payload at an indicated DL SDT PDSCH occasion as described herein at 1524. The inactive WTRU may perform decoding of the configured and/or updated DL SDT PDSCH resources (e.g., resource set) at 1526. DL SDT payload transmission may be repeated multiple times according, for example, to a number of DL SDT PDSCH occasions which are configured for the inactive WTRU.

In certain representative embodiments, a WTRU operating in RRC inactive mode (e.g., after receiving an RRC suspend message and/or a RRC suspend configuration and/or before sending a RRC resume message) may perform procedures for DL small data transmissions (DL SDT). The WTRU operating in the RRC inactive mode may perform DL SDT without establishing an RRC connection with a RAN node. A DL payload may be transmitted as part of paging signaling with may be directed to one or more inactive WTRUs as described herein. A DL SDT-capable WTRU may determine and/or decode a DL SDT paging indication. The WTRU may proceed to decode corresponding data using resources (e.g., PDSCH resources) for receiving a DL SDT payload associated with the DL SDT paging indication. For example, he DL SDT payload may be received using predefined transmission settings, such as a default modulation and coding scheme (MCS) and/or a default HARQ ID for feedback.

A DL SDT-capable WTRU may monitor and (e.g., blindly) decode a paging DCI (e.g., conventional paging DCI) and the associated record, respectively, to identify whether or not the WTRU has been (1) DL SDT-paged, (2) regularly paged, and/or (3) not being paged during the current paging occasion. An additional power consumption burden may be placed on other WTRUs, such as non-DL SDT-capable WTRUs, who also need to monitor and (e.g., blindly) decode DL SDT which may be intended for DL SDT-capable WTRUs. In procedures using EPI as described herein, the DL SDT information may be incorporated in the EPI (e.g., in a DCI or a sequence format) in order to indicate the various combinations of DL-SDT paged WTRU groups and conventional paging indications for non-DL SDT-capable WTRUs. This may lead to increasing, in some cases significantly, the size and/or complexity of the EPI decoding operation at a given WTRU. As another example, non-DL SDT-capable WTRUs may still need to monitor and blindly decode the EPI DCI and/or set of sequences which include DL SDT information.

In certain representative embodiments, a common paging procedure may be implemented for a DL SDT-capable WTRU and/or a non-DL SDT capable WTRU. For example, monitoring and blindly decoding paging PDCCH and/or DCI as well as decoding a corresponding paging PDSCH record may be superfluous and/or unneeded in order for a DL SDT-capable WTRU to determine whether it is being DL SDT paged or not. As another example, monitoring and blindly decoding DL SDT paging information may be superfluous and/or unneeded with respect to a non-DL SDT capable WTRU, and may lead to degraded power savings.

### DL SDT Early Paging Indication Procedures

In certain representative embodiments described above, at least one dedicated PDCCH and/or DCI search space may be used, such as in a DCI-based system, along with one or more associated DL SDT configurations which may be defined and/or configured for (e.g., only for) DL SDT-capable WTRUs. A DL SDT configuration may include any of one or more PDSCH resources, a selected MCS, a HARQ feedback mode, and/or a DL SDT-specific RACH preamble ID. For example, a non-DL SDT capable WTRU may be configured to not monitor the DL SDT-specific search spaces. For example, a DL SDT-capable WTRU may be configured to not need to monitor conventional paging DCI and/or a conventional paging record, such as in cases where DL

SDT paging is enabled and/or configured. In certain representative embodiments, a sequence-based DL SDT-specific early paging indication may be communicated such that any DL SDT WTRUs may be capable of (e.g., simultaneous) synchronization with a RAN node while identifying whether the DL SDT WTRUs have been DL SDT paged or not, such as without having to perform decoding on a full (e.g., regular) paging record. For example, regular paging may correspond to a conventional paging EPI, PDCCH transmission and paging record which may only support DL SDT non-capable WTRUs. A WTRU in RRC inactive mode (e.g., RAN inactive state) may avoid monitoring and blind decoding of unnecessary information (e.g., a non-DL SDT capable WTRU detecting DL SDT information) and power saving gains may be achieved.

In certain representative embodiments described above, a time (e.g., earliest possible time) to inform one or more DL SDT-capable WTRU about an upcoming and/or imminent DL SDT paging is to include a DL SDT paging indication as part of early paging DCI (e.g., EPI DCI). A EPI DCI and/or EPI sequence set procedure may be implemented by legacy WTRUs and/or non-DL SDT capable WTRUs in inactive mode (e.g., as an optional feature). For example, a RAN may disable transmitting of EPI DCI dynamically at a future time, and accordingly in such cases, the DL SDT-capable WTRUs may always blindly decode a regular paging DCI and/or paging record to extract whether there is a DL SDT paging indication for the WTRU or not.

In certain other representative embodiments, improved network flexibility may be achieved by separation of the various paging procedures from each other and/or incorporating procedures using DL SDT early paging indication (DL-SDT-EPI) and one or more corresponding DCI occasions and/or search spaces, respectively. A DL SDT-capable WTRU can be configured to monitor at least one (e.g., limited) search space for a DL-SDT-EPI DCI. For example, in inactive mode, a DL SDT-capable WTRU may attempt blind decoding of (e.g., all) possible occasions of the DL-SDT-EPI DCI. A DL-SDT-EPI DCI may include one or more DL SDT configurations needed for receiving and decoding the DL payload. A DL SDT configuration may include any of a DL SDT paging group ID, a selected MCS, a HARQ ID, one or more DL SDT PDSCH resources, a DL SDT-specific RACH preamble (e.g., to carry the DL SDT HARQ feedback, if configured). The DL SDT information in the DL-SDT-EPI DCI or the DL-SDT-EPI itself may be scrambled by a WTRU-specific RNTI or a paging RNTI or a paging-group RNTI.

For example, a WTRU-specific RNTI may be used for scrambling of the DL-SDT-EPI DCI. A DL SDT-capable WTRU provided and/or configured with the WTRU-specific RNTI may individually decode the DL-SDT-EPI DCI. The DL SDT-capable WTRU may receive and/or update one or more DL SDT configurations. An intended WTRU may proceed to wake up only during times of the DL SDT configured resources to receive and decode a DL SDT PDSCH payload. The intended WTRU may skip (e.g., deep sleep during) the paging DCI and paging record occasions. Other (e.g., non-paged) DL SDT-capable WTRUs may deep sleep until a next configured paging occasion (e.g., upon being unable to unscramble the DL-SDT-EPI DCI).

For example, a paging RNTI may be used for scrambling of the DL-SDT-EPI DCI. Any DL SDT-capable WTRU provided and/or configured with the paging RNTI may decode the DL-SDT-EPI DCI. On condition that the DL-SDT-EPI is decoded, each DL SDT-capable WTRU may read (e.g., decode) the paging DCI and corresponding paging record in order to determine (e.g., extract) a WTRU-specific ID which is subject to DL SDT paging. Other (e.g., non-paged) DL SDT-capable WTRUs may deep sleep until a next configured paging occasion (e.g., upon being unable to unscramble the DL-SDT-EPI DCI).

For example, a paging-group RNTI may be used for scrambling of the DL-SDT-EPI DCI. Any DL SDT-capable WTRU belonging to (e.g., configured with) the paging-group RNTI may decode the DL-SDT-EPI DCI. Any DL SDT-capable WTRU belonging to the paged DL SDT group may read (e.g., decode) the paging DCI and corresponding paging record in order to determine (e.g., extract) a WTRU-specific ID which is subject to DL SDT paging. Other (e.g., non-paged) DL SDT-capable WTRUs and/or any DL SDT-capable WTRU not belonging to the paged group may deep sleep until a next configured paging occasion (e.g., upon being unable to unscramble the DL-SDT-EPI DCI).

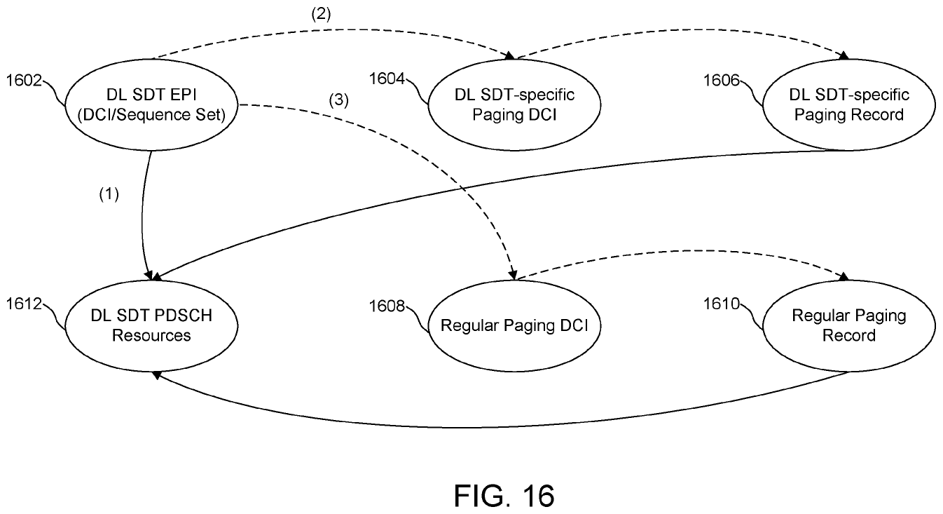

FIG. 16 is a diagram illustrating multiple DL SDT paging procedures. In certain representative embodiments, a DL SDT-specific EPI 1602 (e.g., implemented as DCI-based or sequence-based) may indicate to a DL SDT-capable WTRUs with a WTRU-specific ID that is being DL SDT paged alongside with either one or more explicit configurations and/or implicit configurations of PDSCH resources 1612. For example, an explicit configuration may include any of exact DL SDT PDSCH resources in terms of a starting OFDM symbol, allocation length, slot index, and/or PRB groups. For example, an implicit configuration may include an indication of a predefined and/or preconfigured PDSCH resource set. The DL SDT-capable WTRU which is indicated to be paged may skip monitoring of a corresponding paging DCI and/or paging record (e.g. sleeps) and may proceed at (1) to decoding the indicated PDSCH resources. In certain representative embodiments, the DL SDT EPI may be transmitted as DCI. For example, the DCI transmission may be associated with a corresponding search space that DL SDT-capable WTRUs may monitor and/or be configured to monitor. In certain representative embodiments, the DL SDT EPI may correspond to a sequence (or sequence set) which is selected from a pool of sequences (or a pool of sequence sets) and then transmitted to one or more WTRUs. The pool of sequences may correspond to different sets of DL SDT-capable WTRUs. For example, a first sequence in the pool of sequences may correspond to a first group of one or more DL SDT-capable WTRUs, and a second sequence in the pool of sequences may correspond to a second group of one or more DL SDT-capable WTRUs.

In certain other representative embodiments, a DL SDT-specific EPI may indicate a DL SDT paging for a group or all of the DL SDT capable WTRUs. For example, the DL SDT-capable WTRUs which are indicated to be paged may proceed at (2) to monitor and blindly decode a DL SDT-specific paging DCI 1604 and corresponding paging record 1606. As another example, the DL SDT-capable WTRUs which are indicated to be paged may proceed at (3) to monitor and decode a regular paging DCI 1608 and corresponding paging record 1610, respectively, in order to identify which DL SDT-capable WTRU has been paged and any associated DL SDT PDSCH reception configurations. The first example may impose additional resource overhead due to the addition of a defined DL SDT-specific paging DCI and paging record while the latter example may share a legacy paging DCI and paging record among DL SDT capable and incapable WTRUs—at the cost of legacy DL SDT non-capable WTRUs performing unnecessary decoding of information about the DL SDT configurations.

On condition that a DL-SDT-EPI DCI is detected, a DL SDT-capable WTRU may extract a dynamic DL SDT configuration and/or configuration update therefrom. Each DL SDT configuration, or update thereof, may include any of a HARQ ID, PDSCH resources, a MCS, and/or a DL SDT-specific RACH preamble to carry HARQ feedback. In certain representative embodiments, one or more configurations which may define the DL-SDT-EPI DCI include any of (1) a DL-SDT-EPI DCI search space time and/or frequency resources, (2) a validity duration, and/or (3) a periodicity of the DL-SDT-EPI DCI search space. For example, the DL-SDT-EPI DCI search space resources may define the possible occasions in terms of time and/or frequency resources over which a DL-SDT-EPI DCI and/or sequence set may be potentially transmitted and may be monitored by a (e.g., any) DL SDT-capable WTRUs. For example, the validity duration of the DL-SDT-EPI DCI may be provided as information indicating any of one or more paging occasions and/or an expiry timer (e.g., milliseconds, mini-slots, slots, sub-frames, frames). The validity duration may be applicable to a current DL-SDT-EPI DCI configuration over which the DL SDT capable WTRU may assume no changes to the DL-SDT-EPI DCI resources. For example, upon the validity timer lapsing, the DL SDT-capable WTRU may expect to be configured or re-configured with an updated DL SDT configuration (e.g., DL-SDT-EPI DCI resources). For example, if no DL-SDT-EPI DCI update is provided by the network, the DL SDT-capable WTRUs may assume there are no available DL-SDT-EPI DCI occasions, and may proceed to decode (e.g., always decode) a legacy paging DCI and paging record to check if they are being DL SDT-paged or not.

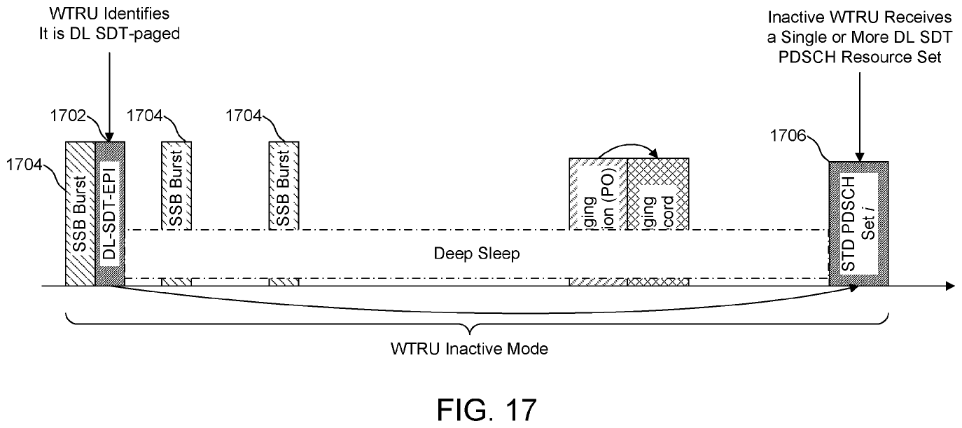

FIG. 17 is a diagram illustrating a representative procedure for DL SDT EPI DCI for early paging. As shown in FIG. 17, a DL-SDT-EPI DCI 1702 may be interspersed with SSB bursts 1704 (e.g., may follow a first SSB burst). The DL-SDT-EPI DCI 1702 may be transmitted using resources in a configured DL-SDT-EPI DCI search space. A DL SDT-capable WTRU, while in inactive mode, may decode (e.g., blindly decode) the DL-SDT-EPI DCI 1702 and identify that it or a group to which it belongs is being paged. The DL SDT-capable WTRU may proceed to sleep (e.g., deep sleep) until occurrences of one or more predefined and/or configured SDT PDSCH resource sets 1706. The DL SDT-capable WTRU may receive a DL SDT payload in any of the SDT PDSCH resource sets 1706 (e.g., while in inactive mode).

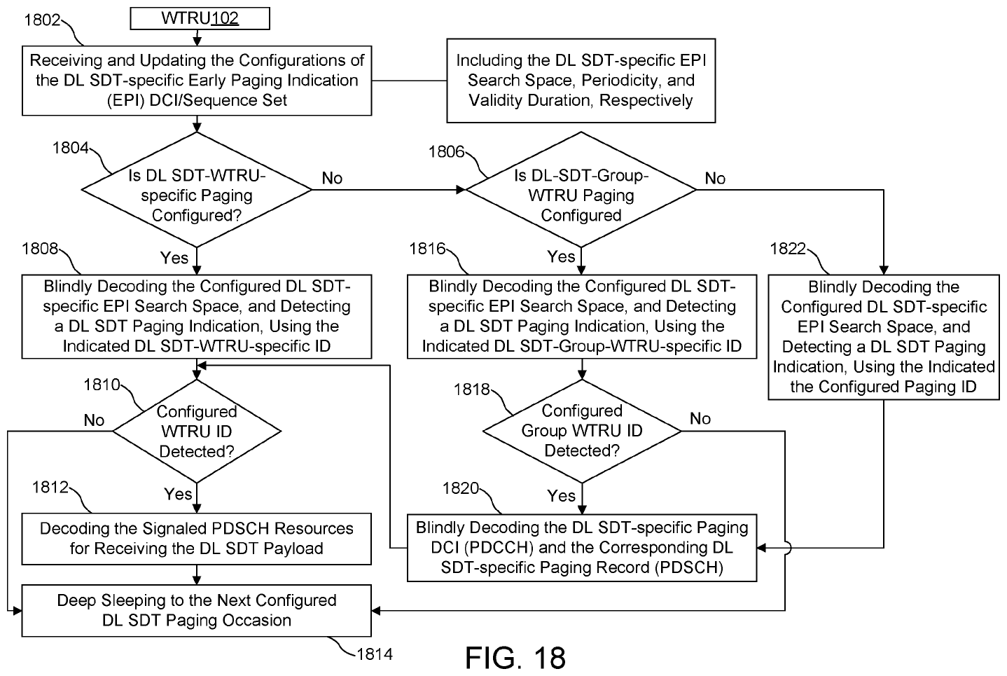

FIG. 18 is a diagram illustrating another representative procedure for downlink small data early paging indication downlink control information for early paging. As shown in FIG. 18 at 1802, a DL SDT-capable WTRU may receive and/or update DL-SDT-EPI DCI configurations including any of the DL-SDT-EPI DCI search space resources (e.g., time and/or frequency resources), periodicity, and/or validity duration of the DL-SDT-EPI DCI configuration. An inactive DL SDT-capable WTRU may determine whether a DL SDT WTRU-specific paging is configured at 1804 and/or whether a DL SDT group-specific paging is configured at 1806. The inactive DL SDT-capable WTRU may monitor and blindly decode at least one DL-SDT-EPI DCI search space.

For example, the WTRU may detect a DL SDT EPI, such as by using an indicated DL SDT WTRU-specific ID at 1808. On condition that the DL SDT WTRU-specific ID is detected at 1810, the WTRU may proceed to receive a DL SDT payload in any of the SDT PDSCH resource sets (e.g., while in inactive mode) at 1812. On condition that the DL SDT WTRU-specific ID is not detected, the WTRU may proceed to sleep until a next configured DL SDT paging occasion at 1814.

As another example, the WTRU may detect a DL SDT EPI, such as by using an indicated DL SDT group-specific ID at 1816. On condition that the DL SDT group-specific ID is detected at 1818, the WTRU may proceed to monitor and/or blindly decode a DL SDT-specific paging DCI and/or a corresponding DL SDT-specific paging record at 1820. The DL SDT-specific paging DCI may be received as a PDCCH transmission. The DL SDT-specific paging record may be received as a PDSCH transmission. On condition that the WTRU determines that is being paged, the WTRU may then proceed to receive a DL SDT payload in any of the SDT PDSCH resource sets (e.g., while in inactive mode) at 1812. On condition that the WTRU is not being paged (e.g., using the DL SDT-specific paging DCI and/or paging record), the WTRU may proceed to sleep until a next configured DL SDT paging occasion at 1814.

As another example, the WTRU may not be configured with a DL SDT WTRU-specific paging and may not be configured with a DL SDT group-specific paging. As shown in FIG. 18, the inactive DL SDT-capable WTRU may monitor and blindly decode at least one DL-SDT-EPI DCI search space, and may detect a DL SDT paging indication, such as by using a configured paging ID, at 1822. On condition that the configured paging ID is detected, the WTRU may proceed to monitor and/or blindly decode the DL SDT-specific paging DCI and/or the corresponding DL SDT-specific paging record at 1820. The DL SDT-specific paging DCI may be received as a PDCCH transmission. The DL SDT-specific paging record may be received as a PDSCH transmission. On condition that the WTRU determines that is being paged, the WTRU may then proceed to receive a DL SDT payload in any of the SDT PDSCH resource sets (e.g., while in inactive mode) at 1812. On condition that the WTRU is not being paged (e.g., using the DL SDT-specific paging DCI and/or paging record), the WTRU may proceed to sleep until a next configured DL SDT paging occasion at 1814.

In FIG. 18, the DL-SDT-EPI DCI may be scrambled by any paging-RNTI (e.g., for paging any DL SDT-capable WTRUs), paging-group RNTI (e.g., for paging a group of DL SDT-capable WTRUs), or WTRU-specific RNTI (e.g., for paging an individual DL SDT-capable WTRU). Inactive DL SDT-capable WTRUs may extract the DL SDT paging information as described herein, and any DL SDT-paged WTRUs may perform decoding of the DL SDT PDSCH resources (e.g., resource set and/or occasions) for DL SDT payload reception.

### DL SDT Feedback Procedures

In certain representative embodiments, a feedback procedure provides for a WTRU which is inactive and has received a DL SDT payload to feedback one or more bits of DL SDT-specific HARQ feedback. On condition that a WTRU (e.g, inactive and/or idle WTRUs) retains a time alignment to the RAN interface, such as by using the time advance/alignment timer (TAT) metric, the WTRU may transmit an uplink control information (UCI) signaling including the corresponding the DL SDT-specific HARQ feedback information. On condition the time alignment is expired or lapsed, the WTRU may trigger a temporary RACH procedure and RRC connection establishment as follows.

For example, a DL SDT-capable WTRU (e.g., in inactive/idle mode) may transmit a regular RACH preamble, and a subsequent RRC connection setup request. The one or more DL SDT-specific HARQ feedback bits may be included (e.g., multiplexed) in the RRC connection setup request. Upon transmitting the RRC connection setup request, the idle/inactive WTRU may not transition to connected mode.

As another example, a DL SDT-capable WTRU (e.g., in inactive/idle mode) may transmit a DL SDT-specific RACH preamble. The DL SDT-specific RACH preamble may be selected or configured from a set of DL SDT-specific preambles (or preamble pools), such as may be dedicated by the network to the DL SDT-capable WTRUs. As the configured DL SDT-specific RACH preambles (or preamble pools) can be associated with a DL SDT-specific HARQ ACK or NACK, the RAN node, upon receiving a certain DL SDT-specific RACH preamble, may identify whether a previous DL SDT transmission was successfully received or not.

The DL SDT-capable WTRU (e.g., in inactive/idle mode), when configured, may transmit UCI in the uplink direction to signal the corresponding DL SDT-specific HARQ feedback. In some cases, this may under-utilize the network resource overhead. Using RACH procedures, requires the DL SDT-capable WTRU (e.g., in inactive/idle mode) to trigger the RRC connection establishment signaling in order to multiplex the DL SDT-specific HARQ feedback. In some cases, this may increase the device power consumption. Using the DL SDT-specific RACH preamble pool(s) may avoid preamble collisions with non-SDT (e.g., regular) RACH transmission. In some cases, multiple DL SDT-capable WTRUs are paged within the same paging occasion, and the network may be unable to differentiate among the various DL SDT WTRUS. That is, the RAN node, upon receiving different DL SDT-specific RACH preambles, may not identify which DL SDT-capable WTRUs have received a DL SDT payload successfully and which have not.

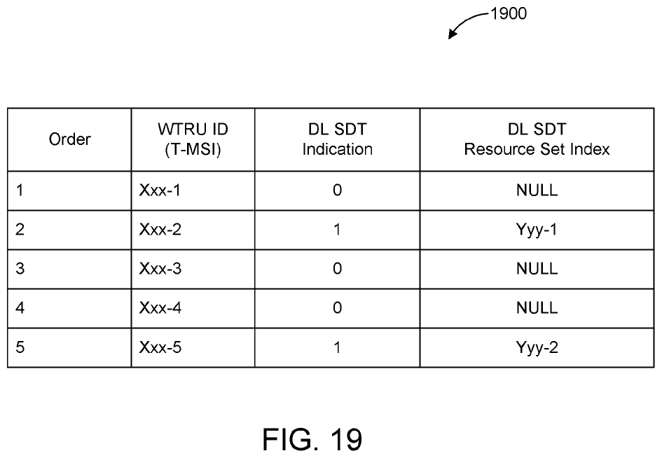

In certain representative embodiments, one or more DL SDT-capable WTRUs may perform procedures for transmitting DL SDT-specific HARQ feedback at a same time. FIG. 19 is a diagram illustrating a representative paging record 1900. A SDT EPI DCI and/or other paging DCI may include a DL SDT paging indication for one or more of the DL SDT-capable WTRUs (e.g, using different scrambling RNTIs). For example, there may be a DL SDT paging indication which is directed to one or more DL SDT paging groups. As explained herein, the DL SDT-capable WTRUs (e.g., in inactive and/or idle mode) may decode the corresponding paging record. Within the paging record (e.g., in a PDSCH transmission), the DL SDT paged-WTRUs may be identified. As shown in FIG. 19, the paged WTRUs may be identified by their corresponding IDs, such as a temporary mobile subscription identifier (T-MSI), respective DL SDT indications and DL SDT resource set configurations. For example, using the order of the WTRUs in the paging record, the idle/inactive WTRUs, which have been DL SDT paged, may each receive a DL SDT payload, using the indicated DL SDT transmission configurations. After, the WTRUs may select a certain DL SDT-specific RACH preamble, which is mapped to and/or associated with the DL SDT WTRU order in the paging record.

As an example, the RAN node may configure DL SDT-capable WTRUs with a pool of DL SDT RACH preambles and each preamble may be uniformly mapped to the WTRU order in the paging record. A DL SDT WTRU listed second in the paging record may select and use a second DL SDT-specific RACH preamble. As another example, a mapping among the WTRU order in the paging record and the DL SDT RACH preamble can be non-uniform where one or more DL SDT-specific RACH preamble(s) can be associated and mapped to a range of WTRU orders in the paging record. Such a non-uniform mapping may be useful for industrial IoT deployments where the number of the DL SDT-capable WTRUs may be significantly larger than the number of available DL SDT specific orthogonal RACH preambles. The mapping information may be signaled to the DL SDT-capable WTRUs using higher or lower layer signaling and may be indicated as part of any of system information, RRC connection establishment and release signaling, the EPI, paging DCI and/or paging record.

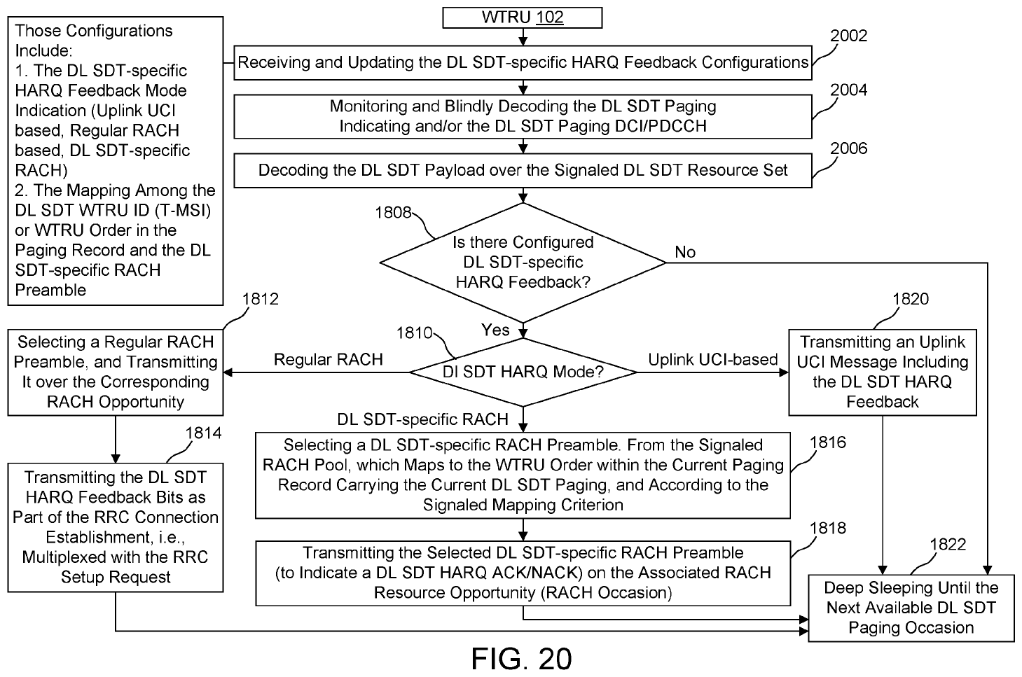

FIG. 20 is a diagram illustrating representative downlink small data transmission paging with feedback procedures. As shown in FIG. 20, a DL SDT-capable WTRU may receive and/or update one or more DL SDT-specific configurations with may include HARQ feedback information at 2002. In certain representative embodiments, a DL SDT-specific HARQ feedback configuration may include any of a DL SDT-specific HARQ feedback mode indication (e.g., uplink UCI based feedback, regular/non-SDT specific RACH based feedback, and/or DL SDT-specific RACH feedback), and/or a mapping indication (e.g., association between WTRU IDs, such as T-MSIs, or WTRU order in the paging record and DL SDT-specific RACH preambles). The DL SDT-capable WTRU (e.g, in inactive and/or idle mode) may monitor and blindly decode any of DL SDT EPI, DL SDT-specific paging DCI, regular (e.g., non-DL SDT specific) paging DCI, and/or a corresponding paging record to determine whether the WTRU is being DL SDT paged at 2004. On condition that the WTRU is being paged, the WTRU may proceed to receive and decode a DL SDT payload using one or more associated DL SDT PDSCH resource sets at 2006.

On condition that DL SDT-specific HARQ feedback has been configured at the WTRU at 1808, the WTRU may determine which DL SDT HARQ feedback procedure to use based on the DL SDT-specific HARQ feedback mode indication at 1810. For example, the DL SDT-specific HARQ feedback mode may be indicated (e.g., explicitly or implicitly) as regular/non-SDT specific RACH based feedback. After decoding the DL SDT payload, the WTRU (e.g., in inactive and/or idle mode) may select a RACH preamble and transmit the selected (e.g., non-DL SDT specific) preamble over a corresponding RACH occasion at 1812. The DL SDT HARQ feedback bits may then be transmitted as part of the RRC connection establishment procedure, such as being multiplexed with or as part of a RRC connection setup request, at 1814.

For example, the DL SDT-specific HARQ feedback mode may be indicated (e.g., explicitly or implicitly) as DL SDT-specific RACH feedback at 1810. After decoding the DL SDT payload, the WTRU (e.g., in inactive and/or idle mode) may select a DL SDT-specific RACH preamble, such as from a configured RACH preamble pool (e.g, an ACK pool and/or a NACK pool) at 1816. For example, the WTRU may select the DL SDT-specific RACH preamble from the pool of DL SDT-specific RACH preambles based on an order indicated by the paging record associated with the current DL SDT paging indication. The selection may further be based on any mapping criterion provided in the respective DL SDT-specific configuration. After, the WTRU (e.g., in inactive and/or idle mode) may transmit the selected DL SDT-specific RACH preamble over a corresponding RACH occasion (e.g., RACH resource opportunity) at 1818. The DL SDT-specific RACH preamble may be selected based on whether the DL SDT payload was successfully received and/or decoded.

For example, the DL SDT-specific HARQ feedback mode may be indicated (e.g., explicitly or implicitly) as uplink UCI based feedback at 1810. After decoding the DL SDT payload, the WTRU (e.g., in inactive and/or idle mode) may transmit an uplink UCI message which includes the DL SDT HARQ feedback bits at 1820. The transmission of the uplink UCI message may be conditioned upon valid time alignment with the RAN node or a non-lapsed alignment timer. Thereafter, the WTRU may sleep (e.g., deep sleep) until a next available DL SDT paging occasion at 1822.

In certain representative embodiments, a DL SDT-capable WTRU may receive and/or update any of (1) a DL SDT-specific feedback format (e.g., UCI-based, regular RACH, DL SDT-specific RACH), (2) at least one RACH preamble pools, (3) a mapping of WTRU order in paging record or WTRU IDs to certain DL SDT-specific RACH preambles for DL SDT-specific HARQ feedback. The WTRU (e.g., in idle and/or inactive mode) may detect a DL SDT paging indication as described herein, and decode a corresponding DL SDT payload. On condition that DL SDT-specific HARQ feedback has been enabled, the WTRU (e.g., in idle and/or inactive mode) may select a DL SDT-specific RACH preamble which is associated with a corresponding WTRU order in a current paging record, according to the indicated mapping criterion and/or the DL SDT-specific RACH preamble pool. The selected DL SDT-specific RACH preamble may be transmitted at a RACH occasion with the WTRU transitioning to connected mode.

### Signaling Enhancements for DL SDT Procedures

In certain representative embodiments, signaling from a WTRU to a RAN node in the uplink direction may include a DL SDT capability indication. The DL SDT capability indication may inform a serving cell and a 5G core network as to whether the WTRU supports receiving DL SDT while being in the inactive state or not. For a DL SDT-incapable WTRU, upon the arrival of a DL SDT payload, the DL SDT-incapable WTRU may trigger a legacy RACH procedure and transition to the connected RAN state. For example, a DL SDT capability indication may be an information element (IE) and/or may be included as any of (e.g., part of) (1) UECapabilityInformation which is transmitted over a PUSCH and/or a PUCCH; (2) a RRCSetupRequest message transmitted over the PUSCH and/or PUCCH; and/or (3) a RRCResumeRequest message over the PUSCH and/or PUCCH.

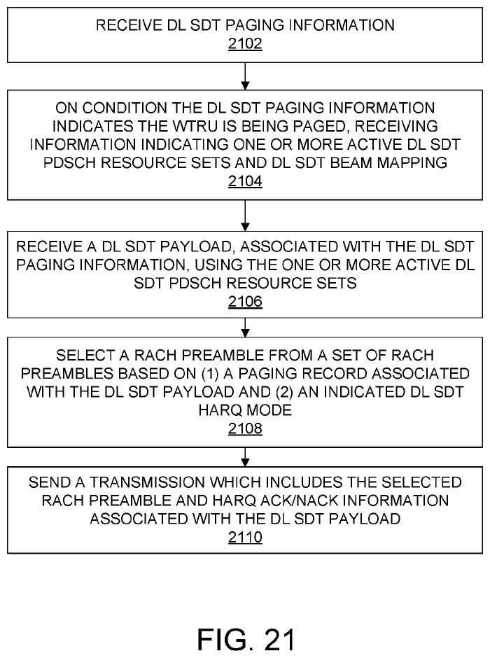

FIG. 21 is a diagram illustration a representative procedure for a WTRU 102 to receive a DL SDT payload and provide HARQ ACK/NACK feedback associated with the DL SDT payload. As shown in FIG. 21, the procedure may include the WTRU 102 receiving (e.g., from a network entity such as a gNB 180) DL SDT paging information at 2102. At 2104, on condition the DL SDT paging information indicates the WTRU 102 is being paged, the WTRU 102 may perform receiving (e.g., from the network entity) of information indicating one or more active DL SDT PDSCH resource sets and DL SDT beam mapping. For example, the DL SDT beam mapping may associate different beams with different ones of the (e.g., active) DL SDT PDSCH resource sets. As described herein, CSI reporting may be used by the network to select at least one of the beams and/or to activate at least one of the DL SDT PDSCH resource sets. After 2104, the WTRU may receive (e.g., from the network entity) a DL SDT payload, associated with the DL SDT paging information, using the one or more active DL SDT PDSCH resource sets at 2106. After 2106, the WTRU may proceed to select a RACH preamble from a set of RACH preambles based on (1) a paging record associated with the DL SDT payload and/or (2) an indicated DL SDT HARQ mode at 2108. At 2110, the WTRU may send (e.g., to the network entity) a transmission which includes the selected RACH preamble and HARQ ACK/NACK information associated with the DL SDT payload.

In certain representative embodiments, the DL SDT paging information may be received after receiving a connection release or suspend message. For example, the connection release or suspend message may be a radio resource control (RRC) message and/or may precede 2102 in FIG. 21.

In certain representative embodiments, the WTRU 102 may also send a transmission which includes information indicating one or more DL SDT capabilities of the WTRU. For example, the transmission which includes the information indicating the one or more DL SDT capabilities may be sent before receiving the DL SDT paging information.

In certain representative embodiments, the DL SDT paging information may be included in any of: (1) an early paging indication (EPI) downlink control information (DCI), (2) paging DCI, and/or (3) a paging record.

In certain representative embodiments, the WTRU 102 may receive information indicating one or more DL SDT physical downlink shared channel (PDSCH) resource sets. For example, the information indicating the one or more DL SDT PDSCH resource sets is included in any of: (1) system information, (2) a RRC message, (3) an early paging indication (EPI) downlink control information (DCI), (4) paging DCI, and/or (5) a paging record. In some embodiments, the information indicating the one or more DL SDT PDSCH resource sets may be received before receiving the DL SDT paging information. The one or more DL SDT PDSCH resource sets may include the one or more active DL SDT PDSCH resource sets.

In certain representative embodiments, the DL SDT beam mapping may associate the one or more active DL SDT PDSCH resource sets with one or more beams. For example, the DL SDT payload may be transmitted using at least one of the beams.

In certain representative embodiments, the transmission, which includes the selected RACH preamble and the HARQ ACK/NACK information associated with the DL SDT payload, may also include information indicating a HARQ process identifier associated with the DL SDT payload.

In certain representative embodiments, the DL SDT HARQ mode may be indicated to the WTRU 102 using any of the signaling and/or messaging described herein. The DL SDT HARQ mode may be associated with the set of RACH preambles. For example, a first mode may use a first set of RACH preambles and a second mode may use a second (e.g., different) set of RACH preambles.

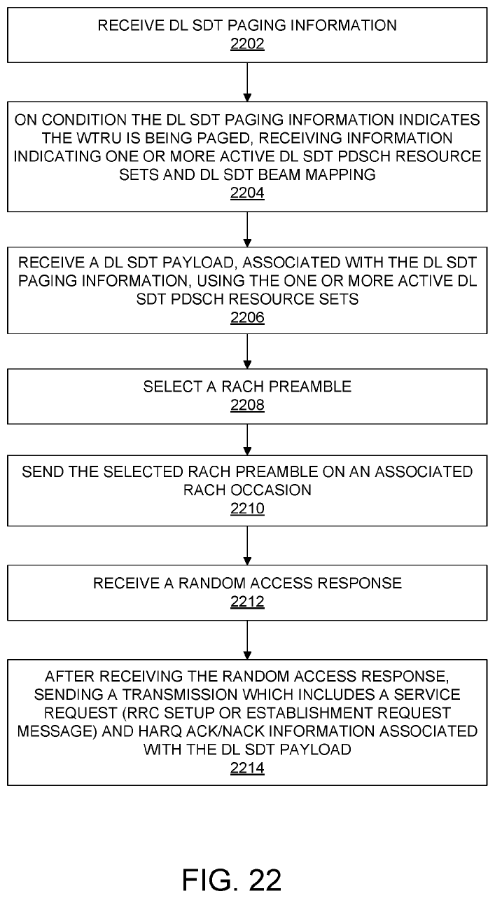

FIG. 22 is a diagram illustration another representative procedure for a WTRU 102 to receive a DL SDT payload and provide HARQ ACK/NACK feedback associated with the DL SDT payload. As shown in FIG. 22, the WTRU 102 may receive (e.g., from a network entity such as a gNB 180) DL SDT paging information at 2202. At 2204, on condition the DL SDT paging information indicates the WTRU is being paged, the WTRU 102 may receive (e.g., from the network entity) information indicating one or more active DL SDT PDSCH resource sets and DL SDT beam mapping. After 2204, the WTRU 102 may receive (e.g., from the network entity) a DL SDT payload, associated with the DL SDT paging information, using the one or more active DL SDT PDSCH resource sets at 2206. At 2208, the WTRU 102 may proceed to select a RACH preamble (e.g., from a set of RACH preambles). At 2210, the WTRU 102 may send (e.g., to the network entity) the selected RACH preamble during an associated RACH occasion. At 2212, the WTRU 102 may receive (e.g., from the network entity) a random access response. After receiving the random access response at 2212, the WTRU 102 may send (e.g., to the network entity) a transmission which includes a service request and HARQ ACK/NACK information associated with the DL SDT payload at 2214.

In certain representative embodiments, the DL SDT paging information may be received after receiving a connection release or suspend message. For example, the connection release or suspend message may be a radio resource control (RRC) message and/or may precede 2202 in FIG. 22.

In certain representative embodiments, the WTRU 102 may also send a transmission which includes information indicating one or more DL SDT capabilities of the WTRU. For example, the transmission which includes the information indicating the one or more DL SDT capabilities may be sent before receiving the DL SDT paging information.

In certain representative embodiments, the DL SDT paging information may be included in any of: (1) an early paging indication (EPI) downlink control information (DCI), (2) paging DCI, and/or (3) a paging record.

In certain representative embodiments, the WTRU 102 may receive information indicating one or more DL SDT physical downlink shared channel (PDSCH) resource sets. For example, the information indicating the one or more DL SDT PDSCH resource sets is included in any of: (1) system information, (2) a RRC message, (3) an early paging indication (EPI) downlink control information (DCI), (4) paging DCI, and/or (5) a paging record. In some embodiments, the information indicating the one or more DL SDT PDSCH resource sets may be received before receiving the DL SDT paging information. The one or more DL SDT PDSCH resource sets may include the one or more active DL SDT PDSCH resource sets.

In certain representative embodiments, the DL SDT beam mapping may associate the one or more active DL SDT PDSCH resource sets with one or more beams. For example, the DL SDT payload may be transmitted using at least one of the beams. As described herein, CSI reporting may be used by the network to select at least one of the beams and/or to activate at least one of the DL SDT PDSCH resource sets.

In certain representative embodiments, the transmission, which includes the selected RACH preamble and the HARQ ACK/NACK information associated with the DL SDT payload, may also include information indicating a HARQ process identifier associated with the DL SDT payload

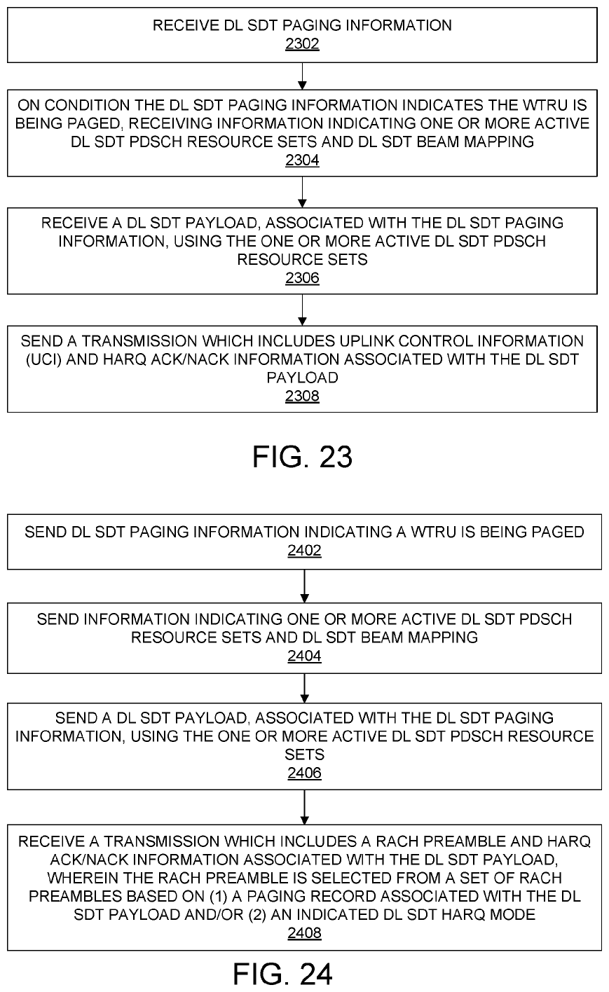

FIG. 23 is a diagram illustration yet another representative procedure for a WTRU 102 to receive a DL SDT payload and provide HARQ ACK/NACK feedback associated with the DL SDT payload. As shown in FIG. 23, the WTRU 102 may receive (e.g., from a network entity such as a gNB 180) DL SDT paging information at 2302. After 2302, on condition the DL SDT paging information indicates the WTRU 102 is being paged, the WTRU 102 may receive (e.g., from the network entity) information indicating one or more active DL SDT PDSCH resource sets and DL SDT beam mapping at 2304. At 2306, the WTRU 102 may receive (e.g., from the network entity) a DL SDT payload, associated with the DL SDT paging information, using the one or more active DL SDT PDSCH resource sets. At 2308, the WTRU 102 may send (e.g., to the network entity) a transmission which includes uplink control information (UCI) and HARQ ACK/NACK information associated with the DL SDT payload.

In certain representative embodiments, the DL SDT paging information may be received after receiving a connection release or suspend message. For example, the connection release or suspend message may be a radio resource control (RRC) message and/or may precede 2302 in FIG. 23.

In certain representative embodiments, the WTRU 102 may also send a transmission which includes information indicating one or more DL SDT capabilities of the WTRU. For example, the transmission which includes the information indicating the one or more DL SDT capabilities may be sent before receiving the DL SDT paging information.

In certain representative embodiments, the DL SDT paging information may be included in any of: (1) an early paging indication (EPI) downlink control information (DCI), (2) paging DCI, and/or (3) a paging record.

In certain representative embodiments, the WTRU 102 may receive information indicating one or more DL SDT physical downlink shared channel (PDSCH) resource sets. For example, the information indicating the one or more DL SDT PDSCH resource sets is included in any of: (1) system information, (2) a RRC message, (3) an early paging indication (EPI) downlink control information (DCI), (4) paging DCI, and/or (5) a paging record. In some embodiments, the information indicating the one or more DL SDT PDSCH resource sets may be received before receiving the DL SDT paging information. The one or more DL SDT PDSCH resource sets may include the one or more active DL SDT PDSCH resource sets.

In certain representative embodiments, the DL SDT beam mapping may associate the one or more active DL SDT PDSCH resource sets with one or more beams. For example, the DL SDT payload may be transmitted using at least one of the beams. As described herein, CSI reporting may be used by the network to select at least one of the beams and/or to activate at least one of the DL SDT PDSCH resource sets.

In certain representative embodiments, the transmission, which includes the UCI and the HARQ ACK/NACK information associated with the DL SDT payload, may also include information indicating a HARQ process identifier associated with the DL SDT payload.

FIG. 24 is a diagram illustration a representative procedure for a network entity (e.g., a base station such as a gNB 180) to send a DL SDT payload (e.g., to a WTRU 102) and receive HARQ ACK/NACK feedback associated with the DL SDT payload (e.g., from the WTRU 102). As shown in FIG. 24, the network entity may send DL SDT paging information indicating a WTRU 102 is being paged at 2402. At 2404, the network entity may send information indicating one or more active DL SDT PDSCH resource sets and DL SDT beam mapping. After 2404, the network entity may send a DL SDT payload, associated with the DL SDT paging information, using the one or more active DL SDT PDSCH resource sets at 2406. At 2408, the network entity may receive a transmission which includes a RACH preamble and HARQ ACK/NACK information associated with the DL SDT payload. For example, the RACH preamble may be selected (e.g., by the WTRU 102) from a set of RACH preambles based on (1) a paging record associated with the DL SDT payload and/or (2) an indicated DL SDT HARQ mode.

In certain representative embodiments, the DL SDT paging information may be sent after sending a connection release or suspend message. For example, the connection release or suspend message may be a radio resource control (RRC) message and/or may precede 2402 in FIG. 24.

In certain representative embodiments, the network entity may receive (e.g., from the WTRU 102) a transmission which includes information indicating one or more DL SDT capabilities of the WTRU 102. For example, the transmission which includes the information indicating the one or more DL SDT capabilities may be received before the network entity sends the DL SDT paging information.

In certain representative embodiments, the DL SDT paging information may be included in any of: (1) an early paging indication (EPI) downlink control information (DCI), (2) paging DCI, and/or (3) a paging record.

In certain representative embodiments, the network entity may send information indicating one or more DL SDT physical downlink shared channel (PDSCH) resource sets. For example, the information indicating the one or more DL SDT PDSCH resource sets is included in any of: (1) system information, (2) a RRC message, (3) an early paging indication (EPI) downlink control information (DCI), (4) paging DCI, and/or (5) a paging record. In some embodiments, the information indicating the one or more DL SDT PDSCH resource sets may be sent before sending the DL SDT paging information. The one or more DL SDT PDSCH resource sets may include the one or more active DL SDT PDSCH resource sets.

In certain representative embodiments, the DL SDT beam mapping may associate the one or more active DL SDT PDSCH resource sets with one or more beams. For example, the DL SDT payload may be transmitted using at least one of the beams. As described herein, CSI reporting may be used by the network to select at least one of the beams and/or to activate at least one of the DL SDT PDSCH resource sets.

In certain representative embodiments, the transmission, which includes the selected RACH preamble and the HARQ ACK/NACK information associated with the DL SDT payload, may also include information indicating a HARQ process identifier associated with the DL SDT payload.

In certain representative embodiments, the DL SDT HARQ mode may be indicated to the WTRU 102 using any of the signaling and/or messaging described herein. The DL SDT HARQ mode may be associated with the set of RACH preambles. For example, a first mode may use a first set of RACH preambles and a second mode may use a second (e.g., different) set of RACH preambles.

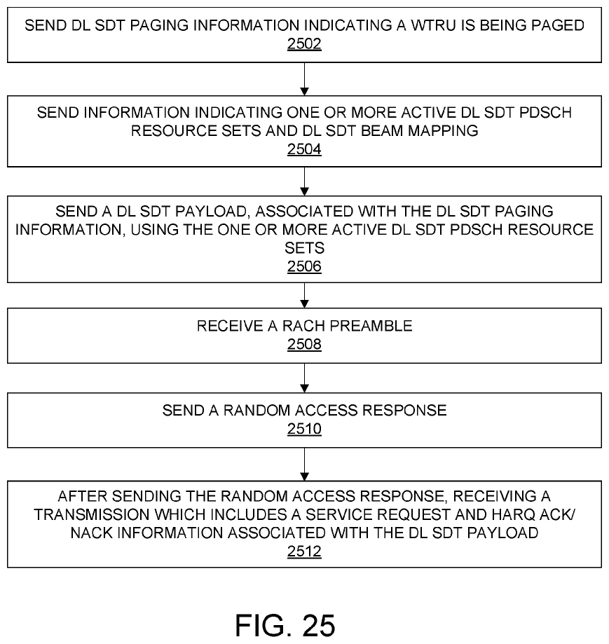

FIG. 25 is a diagram illustration another representative procedure for a network entity (e.g., a base station such as a gNB 180) to send (e.g., to a WTRU 102) a DL SDT payload and receive (e.g., from a WTRU 102) HARQ ACK/NACK feedback associated with the DL SDT payload. As shown in FIG. 25, the network entity may send DL SDT paging information indicating a WTRU 102 is being paged at 2502. At 2504, the network entity may send information indicating one or more active DL SDT PDSCH resource sets and DL SDT beam mapping. At 2506, the network entity may proceed to send a DL SDT payload, associated with the DL SDT paging information, using the one or more active DL SDT PDSCH resource sets. After sending the DL SDT payload, the network entity may receive a RACH preamble at 2508. At 2510, the network entity may send a random access response. After sending the random access response at 2510, the network entity may receive a transmission which includes a service request and HARQ ACK/NACK information associated with the DL SDT payload at 2512.

In certain representative embodiments, the DL SDT paging information may be sent after sending a connection release or suspend message. For example, the connection release or suspend message may be a radio resource control (RRC) message and/or may precede 2502 in FIG. 25.

In certain representative embodiments, the network entity may also receive a transmission which includes information indicating one or more DL SDT capabilities of the WTRU 102. For example, the transmission which includes the information indicating the one or more DL SDT capabilities may be received before sending the DL SDT paging information.

In certain representative embodiments, the DL SDT paging information may be included in any of: (1) an early paging indication (EPI) downlink control information (DCI), (2) paging DCI, and/or (3) a paging record.

In certain representative embodiments, the network entity may send information indicating one or more DL SDT physical downlink shared channel (PDSCH) resource sets. For example, the information indicating the one or more DL SDT PDSCH resource sets is included in any of: (1) system information, (2) a RRC message, (3) an early paging indication (EPI) downlink control information (DCI), (4) paging DCI, and/or (5) a paging record. In some embodiments, the information indicating the one or more DL SDT PDSCH resource sets may be sent before sending the DL SDT paging information. The one or more DL SDT PDSCH resource sets may include the one or more active DL SDT PDSCH resource sets.

In certain representative embodiments, the DL SDT beam mapping may associate the one or more active DL SDT PDSCH resource sets with one or more beams. For example, the DL SDT payload may be transmitted using at least one of the beams. As described herein, CSI reporting may be used by the network to select at least one of the beams and/or to activate at least one of the DL SDT PDSCH resource sets.

In certain representative embodiments, the transmission, which includes the selected RACH preamble and the HARQ ACK/NACK information associated with the DL SDT payload, may also include information indicating a HARQ process identifier associated with the DL SDT payload.

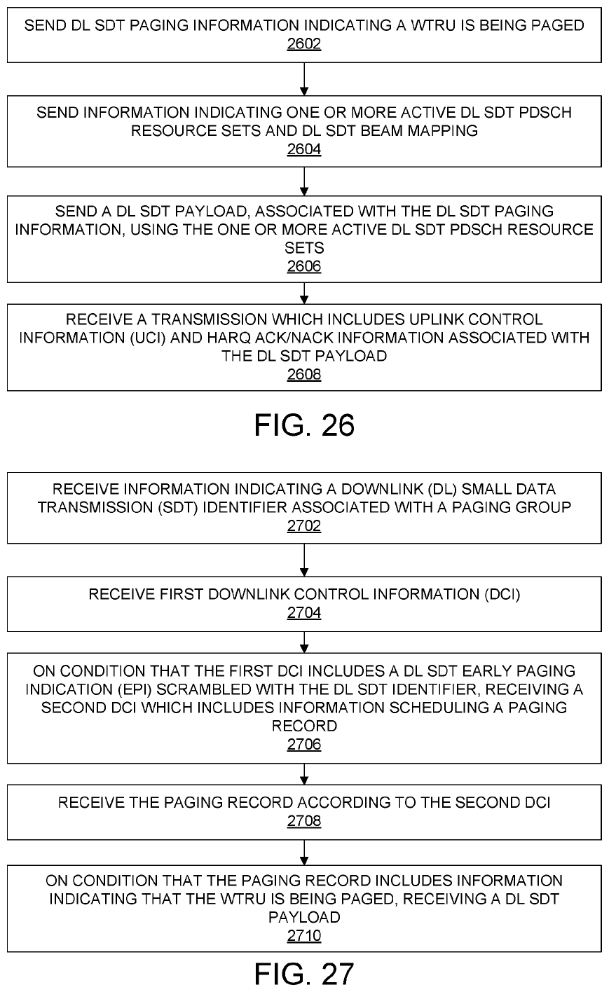

FIG. 26 is a diagram illustration yet another representative procedure for a network entity (e.g., a base station such as a gNB 180) to send (e.g., to a WTRU 102) a DL SDT payload and receive (e.g., from the WTRU 102) HARQ ACK/NACK feedback associated with the DL SDT payload. As shown in FIG. 26, the network entity may send DL SDT paging information indicating a WTRU 102 is being paged at 2602. At 2604, the network entity may send information indicating one or more active DL SDT PDSCH resource sets and DL SDT beam mapping. At 2606, the network entity may send a DL SDT payload, associated with the DL SDT paging information, using the one or more active DL SDT PDSCH resource sets. After 2606, the network entity may receive (e.g., from the WTRU 102) a transmission which includes uplink control information (UCI) and HARQ ACK/NACK information associated with the DL SDT payload at 2608.

In certain representative embodiments, the DL SDT paging information may be sent after sending a connection release or suspend message. For example, the connection release or suspend message may be a radio resource control (RRC) message and/or may precede 2602 in FIG. 26.

In certain representative embodiments, the network entity may receive a transmission which includes information indicating one or more DL SDT capabilities of the WTRU 102. For example, the transmission which includes the information indicating the one or more DL SDT capabilities may be sent before receiving the DL SDT paging information.

In certain representative embodiments, the DL SDT paging information may be included in any of: (1) an early paging indication (EPI) downlink control information (DCI), (2) paging DCI, and/or (3) a paging record.

In certain representative embodiments, the WTRU 102 may receive information indicating one or more DL SDT physical downlink shared channel (PDSCH) resource sets. For example, the information indicating the one or more DL SDT PDSCH resource sets is included in any of: (1) system information, (2) a RRC message, (3) an early paging indication (EPI) downlink control information (DCI), (4) paging DCI, and/or (5) a paging record. In some embodiments, the information indicating the one or more DL SDT PDSCH resource sets may be received before receiving the DL SDT paging information. The one or more DL SDT PDSCH resource sets may include the one or more active DL SDT PDSCH resource sets.

In certain representative embodiments, the DL SDT beam mapping may associate the one or more active DL SDT PDSCH resource sets with one or more beams. For example, the DL SDT payload may be transmitted using at least one of the beams. As described herein, CSI reporting may be used by the network to select at least one of the beams and/or to activate at least one of the DL SDT PDSCH resource sets.

In certain representative embodiments, the transmission, which includes the UCI and the HARQ ACK/NACK information associated with the DL SDT payload, may also include information indicating a HARQ process identifier associated with the DL SDT payload.

FIG. 27 is a diagram illustration a representative procedure for a WTRU 102 to receive a DL SDT payload. As shown in FIG. 27, the WTRU 102 may receive (e.g., from a network entity such as a gNB 180) information indicating a downlink (DL) small data transmission (SDT) identifier associated with a paging group at 2702. At 2704, the WTRU 102 may receive (e.g., from the network entity) first downlink control information (DCI). On condition that the first DCI at 2704 includes a DL SDT early paging indication (EPI) scrambled with the DL SDT identifier, the WTRU 102 may receive a second DCI which includes information scheduling a paging record at 2706. At 2708, the WTRU 102 may receive (e.g., from the network entity) the paging record according to the second DCI. At 2710, on condition that the paging record includes information indicating that the WTRU is being paged, the WTRU 102 may receive (e.g., from the network entity) a DL SDT payload.

In certain representative embodiments, the first DCI may be an EPI DCI.

In certain representative embodiments, the second DCI may be a paging DCI.

In certain representative embodiments, the WTRU 102 may select a RACH preamble from a set of RACH preambles as described herein. For example, the RACH preamble may be selected based on (1) a paging record associated with the DL SDT payload and/or (2) an indicated DL SDT HARQ mode. Further, the WTRU 102 may send a transmission which includes the selected RACH preamble and HARQ ACK/NACK information associated with the DL SDT payload.

In certain representative embodiments, the WTRU 102 may select the RACH preamble using a position of the WTRU included in the paging record associated with the DL SDT payload.

In certain representative embodiments, the WTRU 102 may select the RACH preamble using a position of the paging group included in the paging record associated with the DL SDT payload.

In certain representative embodiments, the WTRU 102 may select the RACH preamble using a mapping between the set of RACH preambles and WTRUs included in the paging record associated with the DL SDT payload.

In certain representative embodiments, the WTRU 102 may select a RACH preamble and send the selected RACH preamble on an associated RACH occasion. The WTRU 102 may receive a random access response. After receiving the random access response, the WTRU 102 may send a transmission which includes a service request and HARQ ACK/NACK information associated with the DL SDT payload.

In certain representative embodiments, the WTRU 102 may send a transmission which includes uplink control information (UCI) and HARQ ACK/NACK information associated with the DL SDT payload.

In certain representative embodiments, the WTRU 102 may select a RACH preamble from a set of RACH preambles based on the first DCI. The WTRU may send a transmission which includes the selected RACH preamble and HARQ ACK/NACK information associated with the DL SDT payload.

In certain representative embodiments, the WTRU 102 the first downlink control information (DCI) may be received after receiving a connection release or suspend message. For example, the connection release or suspend message may be a RRC message.

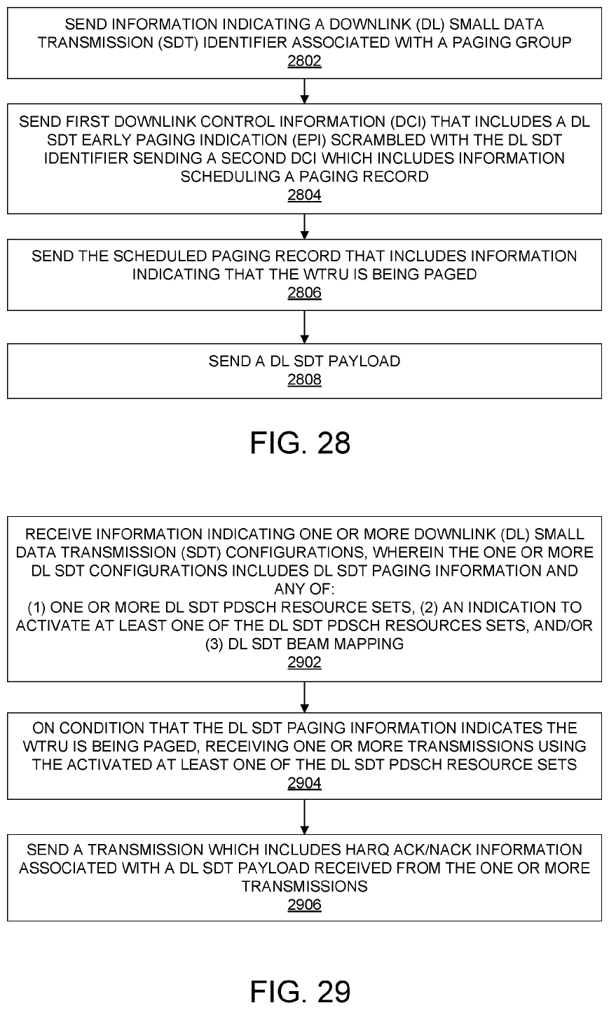

FIG. 28 is a diagram illustration a representative procedure for a network entity (e.g., a base station such as a gNB 180) to send (e.g., to a WTRU 102) a DL SDT payload. As shown in FIG. 28, the network entity may send information indicating a downlink (DL) small data transmission (SDT) identifier associated with a paging group at 2802. At 2804, the network entity may send first downlink control information (DCI) that includes a DL SDT early paging indication (EPI) scrambled with the DL SDT identifier. At 2806, the network entity may send a second DCI which includes information scheduling a paging record. At 2810, the network entity may send the scheduled paging record that includes information indicating that the WTRU is being paged. After 2810, the network entity may proceed with sending a DL SDT payload at 2812.

In certain representative embodiments, the first DCI may be an EPI DCI.

In certain representative embodiments, the second DCI may be a paging DCI.

In certain representative embodiments, the WTRU 102 may select a RACH preamble from a set of RACH preambles as described herein. For example, the RACH preamble may be selected based on (1) a paging record associated with the DL SDT payload and/or (2) an indicated DL SDT HARQ mode. Further, the WTRU 102 may send (e.g., to the network entity) a transmission which includes the selected RACH preamble and HARQ ACK/NACK information associated with the DL SDT payload.

In certain representative embodiments, the WTRU 102 may select the RACH preamble using a position of the WTRU included in the paging record associated with the DL SDT payload.

In certain representative embodiments, the WTRU 102 may select the RACH preamble using a position of the paging group included in the paging record associated with the DL SDT payload.

In certain representative embodiments, the WTRU 102 may select the RACH preamble using a mapping between the set of RACH preambles and WTRUs included in the paging record associated with the DL SDT payload.

In certain representative embodiments, the WTRU 102 may select a RACH preamble and send the selected RACH preamble on an associated RACH occasion. The WTRU 102 may receive a random access response (e.g., from the network entity). After receiving the random access response, the WTRU 102 may send (e.g., to the network entity) a transmission which includes a service request and HARQ ACK/NACK information associated with the DL SDT payload.

In certain representative embodiments, the WTRU 102 may send (e.g., to the network entity) a transmission which includes uplink control information (UCI) and HARQ ACK/NACK information associated with the DL SDT payload.

In certain representative embodiments, the WTRU 102 may select a RACH preamble from a set of RACH preambles based on the first DCI. The WTRU may send (e.g., to the network entity a transmission which includes the selected RACH preamble and HARQ ACK/NACK information associated with the DL SDT payload.

In certain representative embodiments, the first downlink control information (DCI) may be sent by the network entity after sending a connection release or suspend message. For example, the connection release or suspend message may be a RRC message.

FIG. 29 is a diagram illustration a representative procedure for configuring a WTRU 102 to receive (e.g., from a network entity such as a gNB 180) a DL SDT payload. As shown in FIG. 29, the WTRU 102 may receive (e.g., from the network entity) information indicating one or more downlink (DL) small data transmission (SDT) configurations. For example, the one or more DL SDT configurations may include DL SDT paging information and any of: (1) one or more DL SDT PDSCH resource sets, (2) an indication to activate at least one of the DL SDT PDSCH resources sets, and/or (3) DL SDT beam mapping at 2902. On condition that the DL SDT paging information indicates the WTRU 102 is being paged, the WTRU 102 may receive one or more transmissions using the activated at least one of the DL SDT PDSCH resource sets at 2904. For example, the DL SDT PDSCH resource sets may be activated as described herein. After 2904, the WTRU 102 may proceed to send a transmission which includes HARQ ACK/NACK information associated with a DL SDT payload received from the one or more transmissions at 2906.

In certain representative embodiments, the WTRU 102 may combine (e.g., perform soft-combining on) the received one or more transmissions to determine the DL SDT payload.

In certain representative embodiments, the WTRU 102 may select a RACH preamble from a set of RACH preambles. For example, the RACH preamble may be selected based on (1) a paging record associated with the DL SDT payload and/or (2) an indicated DL SDT HARQ mode. The transmission may include the selected RACH preamble and the HARQ ACK/NACK information associated with the DL SDT payload.

In certain representative embodiments, the WTRU 102 may select a RACH preamble. The WTRU 102 may then send the selected RACH preamble on an associated RACH occasion. After, the WTRU 102 may receive a random access response. The WTRU 102 may then send the transmission which includes a service request (e.g., a RRC setup or establishment request message) and the HARQ ACK/NACK information associated with the DL SDT payload.

In certain representative embodiments, the WTRU 102 the transmission may include uplink control information (UCI) and the HARQ ACK/NACK information associated with the DL

In certain representative embodiments, the information indicating one or more downlink (DL) small data transmission (SDT) configurations may be received after receiving a connection release or suspend message. For example, the connection release or suspend message may be a radio resource control (RRC) message.

In certain representative embodiments, the WTRU 102 may send a transmission which includes information indicating one or more DL SDT capabilities of the WTRU. For example, the transmission which includes the information indicating the one or more DL SDT capabilities may be sent before receiving the information indicating one or more DL SDT configurations at 2902.

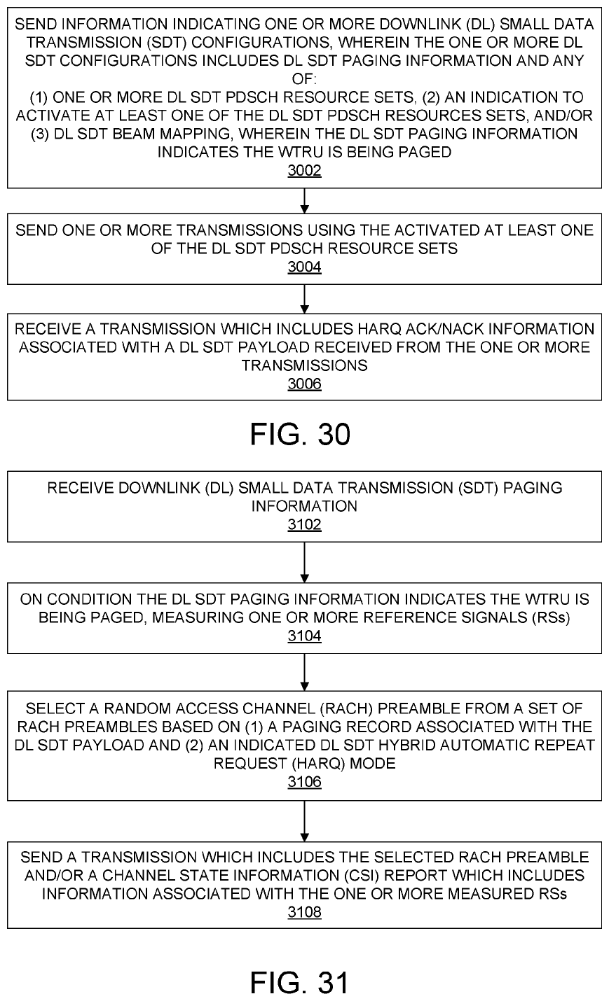

FIG. 30 is a diagram illustration a representative procedure for a network entity (e.g., a base station such as a gNB 180) to configure a WTRU 102 to receive a DL SDT payload. As shown in FIG. 30, the network entity may send information indicating one or more downlink (DL) small data transmission (SDT) configurations at 3002. For example, the one or more DL SDT configurations may include DL SDT paging information and any of: (1) one or more DL SDT PDSCH resource sets, (2) an indication to activate at least one of the DL SDT PDSCH resources sets, and/or (3) DL SDT beam mapping. The DL SDT paging information may indicate the WTRU 102 is being paged. At 3004, the network entity may send one or more transmissions using the activated at least one of the DL SDT PDSCH resource sets. After 3004, the network entity may receive a transmission which includes HARQ ACK/NACK information associated with a DL SDT payload received from the one or more transmissions.

In certain representative embodiments, the WTRU 102 may combine (e.g., perform soft-combining on) the received one or more transmissions to determine the DL SDT payload.

In certain representative embodiments, the WTRU 102 may select a RACH preamble from a set of RACH preambles. For example, the RACH preamble may be selected based on (1) a paging record associated with the DL SDT payload and/or (2) an indicated DL SDT HARQ mode. The transmission may include the selected RACH preamble and the HARQ ACK/NACK information associated with the DL SDT payload.

In certain representative embodiments, the WTRU 102 may select a RACH preamble. The WTRU 102 may then send the selected RACH preamble on an associated RACH occasion. After, the WTRU 102 may receive a random access response. The WTRU 102 may then send the transmission which includes a service request (e.g., a RRC setup or establishment request message) and the HARQ ACK/NACK information associated with the DL SDT payload.

In certain representative embodiments, the WTRU 102 the transmission may include uplink control information (UCI) and the HARQ ACK/NACK information associated with the DL

In certain representative embodiments, the information indicating one or more downlink (DL) small data transmission (SDT) configurations may be received after receiving a connection release or suspend message. For example, the connection release or suspend message may be a radio resource control (RRC) message.

In certain representative embodiments, the network entity may receive (e.g., from the WTRU 102) a transmission which includes information indicating one or more DL SDT capabilities of the WTRU 102. For example, the transmission which includes the information indicating the one or more DL SDT capabilities may be received before sending the information indicating one or more DL SDT configurations at 2902.

FIG. 31 is a diagram illustration a representative procedure for a WTRU 102 to send (e.g., to a network entity such as a gNB 180) a CSI report. As shown in FIG. 31, the WTRU 102 may receive downlink (DL) small data transmission (SDT) paging information at 3102. On condition the DL SDT paging information indicates the WTRU 102 is being paged, the WTRU 102 may proceed to perform any of 3106 and 3108. For example, at 3104, the WTRU 102 may measure one or more (e.g., paging) reference signals (RSS) at 3104. After 3104, the WTRU 102 may select a random access channel (RACH) preamble from a set of RACH preambles at 3106. For example, the RACH preamble may be selected based on (1) a paging record associated with the DL SDT payload and/or (2) an indicated DL SDT hybrid automatic repeat request (HARQ) mode. At 3108, the WTRU 102 may send (e.g., to the network entity) a transmission which includes the selected RACH preamble and a channel state information (CSI) report which includes information associated with the one or more measured (e.g., paging) RSs.

In certain representative embodiments, the DL SDT paging information may be included in any of: (1) an early paging indication (EPI) downlink control information (DCI), (2) paging DCI, and/or (3) a paging record.

In certain representative embodiments, the WTRU 102 may receive information indicating a request for the CSI report which is included in any of: (1) system information, (2) a radio resource control (RRC) message, (3) an early paging indication (EPI) downlink control information (DCI), (4) paging DCI, and/or (5) a paging record.

In certain representative embodiments, the WTRU 102 may receive configuration information indicating time/frequency resources of the one or more paging RSs. For example, the configuration information may include a periodicity associated with the CSI report. For example, the configuration information may include one or more triggers associated with the CSI report.

In certain representative embodiments, the information indicating the configuration information may be included in any of: (1) system information, (2) a radio resource control (RRC) message, (3) an early paging indication (EPI) downlink control information (DCI), (4) paging DCI, and/or (5) a paging record.

In certain representative embodiments, the WTRU 102 may receive information to activate or deactivate configuration information.

In certain representative embodiments, the WTRU 102 may receive information indicating one or more DL SDT physical downlink shared channel (PDSCH) resource sets.

In certain representative embodiments, the WTRU 102 may, after sending the CSI report, receive a DL SDT payload, associated with the DL SDT paging information, using the one or more DL SDT PDSCH resource sets.

In certain representative embodiments, the DL SDT paging information may be received after receiving a connection release or suspend message. For example, the connection release or suspend message is a radio resource control (RRC) message.

In certain representative embodiments, the service request may be a radio resource control (RRC) message. For example, the RRC message may be a RRC setup or establishment request message.

In certain representative embodiments, the DL SDT HARQ mode may be included in any of: (1) system information, (2) a radio resource control (RRC) message, (3) an early paging indication (EPI) downlink control information (DCI), (4) paging DCI, and/or (5) a paging record.

In certain representative embodiments, the DL SDT HARQ mode indicates that HARQ feedback is to be provided for a DL SDT payload associated with DL SDT paging information. For example, a first mode may use a first set of RACH preambles and a second mode may use a second (e.g., different) set of RACH preambles.

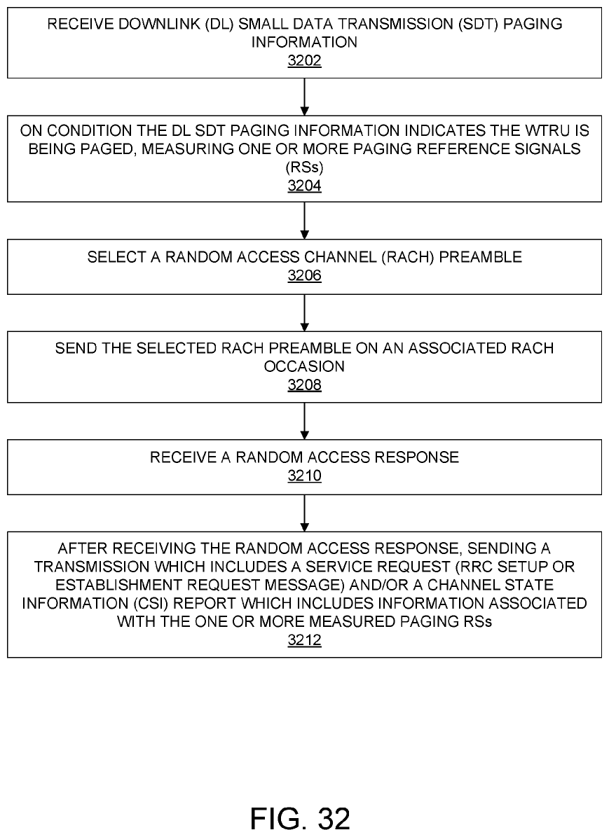

FIG. 32 is a diagram illustration another representative procedure for a WTRU 102 to send (e.g., to a network entity such as a base station) a CSI report. As shown in FIG. 32, the WTRU 102 may receive downlink (DL) small data transmission (SDT) paging information at 3202. On condition the DL SDT paging information indicates the WTRU 102 is being paged at 3204, the WTRU 102 may proceed to proceed to perform any of 3206, 3208, 3210 and 3212. For example, at 3204, the WTRU 102 may measure one or more (e.g., paging) RSs. At 3206, the WTRU 102 may select a random access channel (RACH) preamble. After 3206, the WTRU 102 may proceed to send the selected RACH preamble during an associated RACH occasion. At 3208, the WTRU 102 may receive a random access response. After receiving the random access response, the WTRU 102 may send a transmission which includes a service request and a channel state information (CSI) report which includes information associated with the one or more measured (e.g., paging) RSs.

In certain representative embodiments, the DL SDT paging information may be included in any of: (1) an early paging indication (EPI) downlink control information (DCI), (2) paging DCI, and/or (3) a paging record.

In certain representative embodiments, the WTRU 102 may receive information indicating a request for the CSI report which is included in any of: (1) system information, (2) a radio resource control (RRC) message, (3) an early paging indication (EPI) downlink control information (DCI), (4) paging DCI, and/or (5) a paging record.

In certain representative embodiments, the WTRU 102 may receive configuration information indicating time/frequency resources of the one or more paging RSs. For example, the configuration information may include a periodicity associated with the CSI report. For example, the configuration information may include one or more triggers associated with the CSI report.

In certain representative embodiments, the information indicating the configuration information may be included in any of: (1) system information, (2) a radio resource control (RRC) message, (3) an early paging indication (EPI) downlink control information (DCI), (4) paging DCI, and/or (5) a paging record.

In certain representative embodiments, the WTRU 102 may receive information to activate or deactivate configuration information.

In certain representative embodiments, the WTRU 102 may receive information indicating one or more DL SDT physical downlink shared channel (PDSCH) resource sets.

In certain representative embodiments, the WTRU 102 may, after sending the CSI report, receive a DL SDT payload, associated with the DL SDT paging information, using the one or more DL SDT PDSCH resource sets.

In certain representative embodiments, the DL SDT paging information may be received after receiving a connection release or suspend message. For example, the connection release or suspend message is a radio resource control (RRC) message.

In certain representative embodiments, the service request may be a radio resource control (RRC) message. For example, the RRC message may be a RRC setup or establishment request message.

In certain representative embodiments, the DL SDT HARQ mode may be included in any of: (1) system information, (2) a radio resource control (RRC) message, (3) an early paging indication (EPI) downlink control information (DCI), (4) paging DCI, and/or (5) a paging record.

In certain representative embodiments, the DL SDT HARQ mode indicates that HARQ feedback is to be provided for a DL SDT payload associated with DL SDT paging information. For example, a first mode may use a first set of RACH preambles and a second mode may use a second (e.g., different) set of RACH preambles.

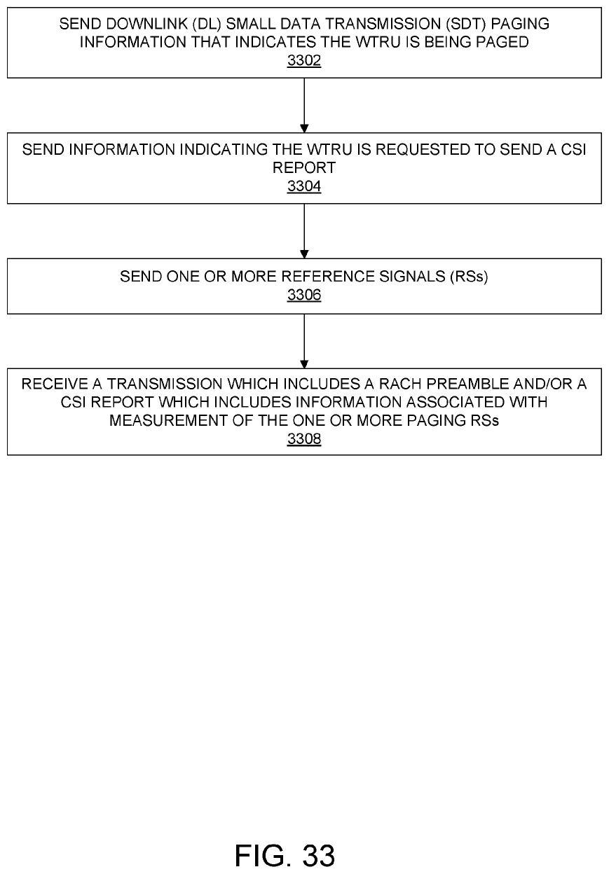

FIG. 33 is a diagram illustration a representative procedure for a network entity (e.g., a base station such as a gNB 180) to receive (e.g., from a WTRU 102) a CSI report. As shown in FIG. 33, the network entity may send downlink (DL) small data transmission (SDT) paging information that indicates a WTRU 102 is being paged at 3302. At 3304, the network entity may send information indicating the WTRU 102 is requested to send a CSI report. At 3306, the network entity may send one or more (e.g., paging) reference signals (RSS). After 3306, the network entity may receive a transmission which includes a RACH preamble and a CSI report which includes information associated with measurement of the one or more (e.g., paging) RSs at 3308. The RACH preamble may be selected (e.g., by the WTRU 102) from a set of RACH preambles as described herein. For example, the selection of the RACH preamble (e.g., by the WTRU 102) may be based on (1) a paging record associated with the DL SDT payload and/or (2) an indicated DL SDT hybrid automatic repeat request (HARQ) mode.

In certain representative embodiments, the DL SDT paging information may be included in any of: (1) an early paging indication (EPI) downlink control information (DCI), (2) paging DCI, and/or (3) a paging record.

In certain representative embodiments, the network entity may send (e.g., to the WTRU 102) information indicating a request for the CSI report which is included in any of: (1) system information, (2) a radio resource control (RRC) message, (3) an early paging indication (EPI) downlink control information (DCI), (4) paging DCI, and/or (5) a paging record.

In certain representative embodiments, the network entity may send (e.g., to the WTRU 102) configuration information indicating time/frequency resources of the one or more paging RSs. For example, the configuration information may include a periodicity associated with the CSI report. For example, the configuration information may include one or more triggers associated with the CSI report.

In certain representative embodiments, the information indicating the configuration information may be included in any of: (1) system information, (2) a radio resource control (RRC) message, (3) an early paging indication (EPI) downlink control information (DCI), (4) paging DCI, and/or (5) a paging record.

In certain representative embodiments, the network entity may send (e.g., to the WTRU 102) information to activate or deactivate configuration information.

In certain representative embodiments, the network entity may send (e.g., to the WTRU 102) information indicating one or more DL SDT physical downlink shared channel (PDSCH) resource sets.

In certain representative embodiments, the network entity may send (e.g., to the WTRU 102), after sending the CSI report, a DL SDT payload, associated with the DL SDT paging information, using the one or more DL SDT PDSCH resource sets.

In certain representative embodiments, the DL SDT paging information may be sent after sending a connection release or suspend message. For example, the connection release or suspend message may be a radio resource control (RRC) message.

In certain representative embodiments, the service request may be a radio resource control (RRC) message. For example, the RRC message may be a RRC setup or establishment request message.

In certain representative embodiments, the DL SDT HARQ mode may be included in any of: (1) system information, (2) a radio resource control (RRC) message, (3) an early paging indication (EPI) downlink control information (DCI), (4) paging DCI, and/or (5) a paging record.

In certain representative embodiments, the DL SDT HARQ mode indicates that HARQ feedback is to be provided for a DL SDT payload associated with DL SDT paging information. For example, a first mode may use a first set of RACH preambles and a second mode may use a second (e.g., different) set of RACH preambles.

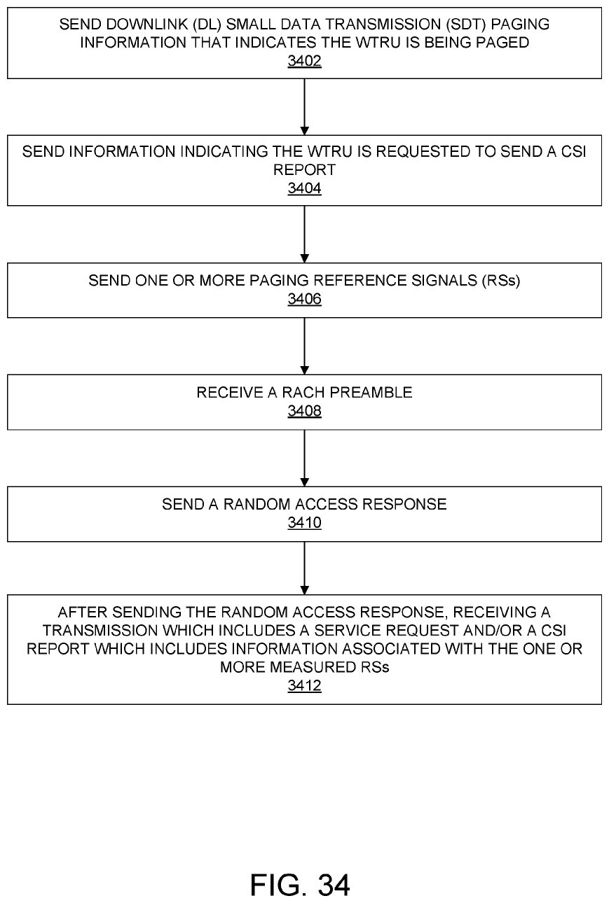

FIG. 34 is a diagram illustration another representative procedure for a network entity (e.g., a base station such as a gNB 180) to receive (e.g., from a WTRU 102) a CSI report. As shown in FIG. 34, the network entity may send downlink (DL) small data transmission (SDT) paging information that indicates a WTRU 102 is being paged at 3402. At 3404, the network entity may send information indicating the WTRU is requested to send a CSI report. After 3404, the network entity may send one or more (e.g., paging) reference signals (RSs) at 3406. At 3408, the network entity may receive a RACH preamble. For example, the RACH preamble may be selected (e.g., by the WTRU 102) as described herein. The network entity may send a random access response at 3410. After sending the random access response at 3408, the network entity may receive a transmission which includes a service request and a CSI report which includes information associated with the one or more measured (e.g., paging RSs) at 3412.

In certain representative embodiments, the DL SDT paging information may be included in any of: (1) an early paging indication (EPI) downlink control information (DCI), (2) paging DCI, and/or (3) a paging record.

In certain representative embodiments, the WTRU 102 may receive information indicating a request for the CSI report which is included in any of: (1) system information, (2) a radio resource control (RRC) message, (3) an early paging indication (EPI) downlink control information (DCI), (4) paging DCI, and/or (5) a paging record.

In certain representative embodiments, the WTRU 102 may receive configuration information indicating time/frequency resources of the one or more paging RSs. For example, the configuration information may include a periodicity associated with the CSI report. For example, the configuration information may include one or more triggers associated with the CSI report.

In certain representative embodiments, the information indicating the configuration information may be included in any of: (1) system information, (2) a radio resource control (RRC) message, (3) an early paging indication (EPI) downlink control information (DCI), (4) paging DCI, and/or (5) a paging record.

In certain representative embodiments, the WTRU 102 may receive information to activate or deactivate configuration information.

In certain representative embodiments, the WTRU 102 may receive information indicating one or more DL SDT physical downlink shared channel (PDSCH) resource sets.

In certain representative embodiments, the WTRU 102 may, after sending the CSI report, receive a DL SDT payload, associated with the DL SDT paging information, using the one or more DL SDT PDSCH resource sets.

In certain representative embodiments, the DL SDT paging information may be received after receiving a connection release or suspend message. For example, the connection release or suspend message is a radio resource control (RRC) message.

In certain representative embodiments, the service request may be a radio resource control (RRC) message. For example, the RRC message may be a RRC setup or establishment request message.

In certain representative embodiments, the DL SDT HARQ mode may be included in any of: (1) system information, (2) a radio resource control (RRC) message, (3) an early paging indication (EPI) downlink control information (DCI), (4) paging DCI, and/or (5) a paging record.

In certain representative embodiments, the DL SDT HARQ mode indicates that HARQ feedback is to be provided for a DL SDT payload associated with DL SDT paging information. For example, a first mode may use a first set of RACH preambles and a second mode may use a second (e.g., different) set of RACH preambles.

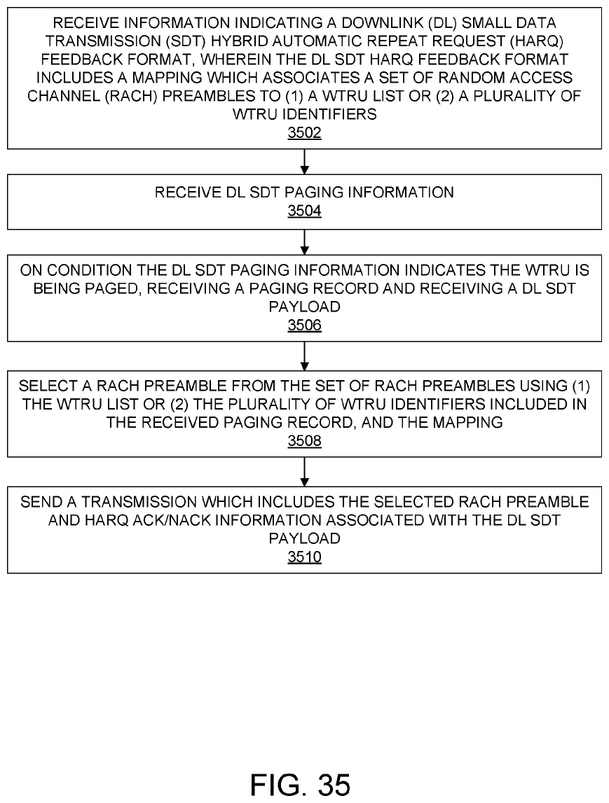

FIG. 35 is a diagram illustration a representative procedure for a WTRU 102 to receive (e.g., from a network entity such as a base station) a DL SDT payload. As shown in FIG. 35, the WTRU 102 may receive information indicating a downlink (DL) small data transmission (SDT) hybrid automatic repeat request (HARQ) feedback format at 3502. For example, the DL SDT HARQ feedback format may include a mapping which associates a set of random access channel (RACH) preambles to (1) a WTRU list and/or (2) a plurality of WTRU identifiers. After 3502, the WTRU 102 may receive DL SDT paging information at 3504. On condition the DL SDT paging information indicates the WTRU 102 is being paged, the WTRU 102 may receive a paging record at 3506 and may receive a DL SDT payload. At 3508, the WTRU 102 may select a RACH preamble from the set of RACH preambles. For example, the RACH preamble may be selected using the mapping and (1) the WTRU list and/or (2) the plurality of WTRU identifiers included in the received paging record. The WTRU 102 may proceed to send a transmission which includes the selected RACH preamble and HARQ ACK/NACK information associated with the DL SDT payload at 3510.

In certain representative embodiments, the DL SDT HARQ feedback format may be received after receiving a connection release or suspend message. For example, the connection release or suspend message may be a radio resource control (RRC) message and/or may precede 3502 in FIG. 35.

In certain representative embodiments, the WTRU 102 may also send a transmission which includes information indicating one or more DL SDT capabilities of the WTRU. For example, the transmission which includes the information indicating the one or more DL SDT capabilities may be sent before receiving the DL SDT paging information and/or the DL SDT HARQ feedback format.

In certain representative embodiments, the DL SDT HARQ feedback format may be included in any of: (1) an early paging indication (EPI) downlink control information (DCI), (2) paging DCI, and/or (3) a paging record.

In certain representative embodiments, the WTRU 102 may receive information indicating one or more DL SDT physical downlink shared channel (PDSCH) resource sets. For example, the information indicating the one or more DL SDT PDSCH resource sets is included in any of: (1) system information, (2) a RRC message, (3) an early paging indication (EPI) downlink control information (DCI), (4) paging DCI, and/or (5) a paging record. In some embodiments, the information indicating the one or more DL SDT PDSCH resource sets may be received before receiving the DL SDT paging information and/or the DL SDT HARQ feedback format.

In certain representative embodiments, a DL SDT beam mapping may associate the one or more active DL SDT PDSCH resource sets with one or more beams. For example, the DL SDT payload may be transmitted using at least one of the beams. As described herein, CSI reporting may be used by the network to select at least one of the beams and/or to activate at least one of the DL SDT PDSCH resource sets.

In certain representative embodiments, the transmission, which includes the selected RACH preamble and the HARQ ACK/NACK information associated with the DL SDT payload, may also include information indicating a HARQ process identifier associated with the DL SDT payload.

In certain representative embodiments, the DL SDT HARQ feedback format may be indicated to the WTRU 102 using any of the signaling and/or messaging described herein. A DL SDT HARQ mode may be associated with the DL SDT HARQ feedback format and/or the set of RACH preambles. For example, a first mode may use a first set of RACH preambles and a second mode may use a second (e.g., different) set of RACH preambles.

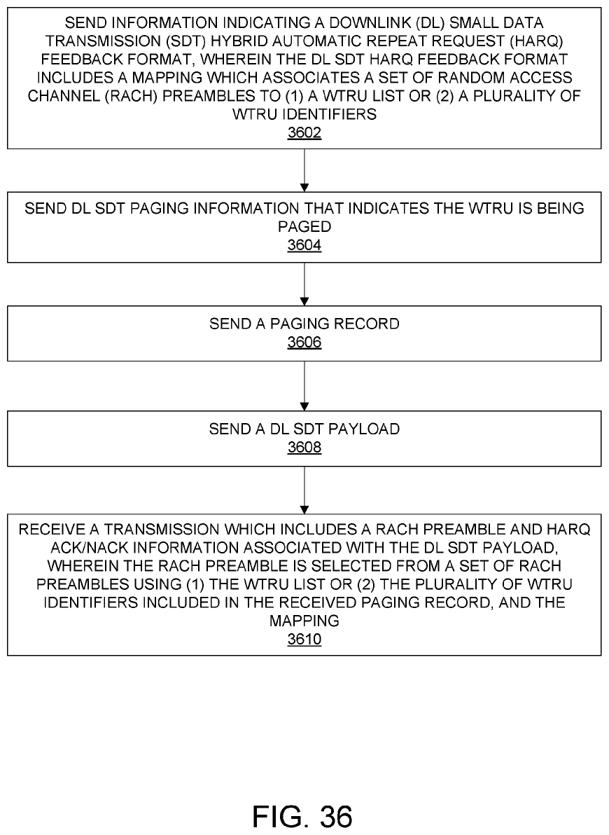

FIG. 36 is a diagram illustration another representative procedure for a network entity (e.g., a base station such as a gNB 180) to receive (e.g., from a WTRU 102) a DL SDT payload. As shown in FIG. 36, the network entity may send (e.g., to the WTRU 102) information indicating a downlink (DL) small data transmission (SDT) hybrid automatic repeat request (HARQ) feedback format at 3602. For example, the DL SDT HARQ feedback format includes a mapping which associates a set of random access channel (RACH) preambles to (1) a WTRU list or (2) a plurality of WTRU identifiers. At 3604, the network entity may send DL SDT paging information that indicates the WTRU 102 is being paged. At 3606, the network entity may send a paging record. At 3608, the network entity may send a DL SDT payload. After 3608, the network entity may receive a transmission (e.g., from the WTRU 102) which includes a RACH preamble and HARQ ACK/NACK information associated with the DL SDT payload. The RACH preamble may be selected (e.g., by the WTRU 102) from a set of RACH preambles. For example, the RACH preamble may be selected using the mapping and (1) the WTRU list and/or (2) the plurality of WTRU identifiers included in the received paging record.

In certain representative embodiments, the DL SDT HARQ feedback format may be received after receiving a connection release or suspend message. For example, the connection release or suspend message may be a radio resource control (RRC) message and/or may precede 3602 in FIG. 36.

In certain representative embodiments, the network entity may receive a transmission which includes information indicating one or more DL SDT capabilities of the WTRU 102. For example, the transmission which includes the information indicating the one or more DL SDT capabilities may be received before sending the DL SDT paging information and/or the DL SDT HARQ feedback format.

In certain representative embodiments, the DL SDT HARQ feedback format may be included in any of: (1) an early paging indication (EPI) downlink control information (DCI), (2) paging DCI, and/or (3) a paging record.

In certain representative embodiments, the WTRU 102 may receive information indicating one or more DL SDT physical downlink shared channel (PDSCH) resource sets. For example, the information indicating the one or more DL SDT PDSCH resource sets is included in any of: (1) system information, (2) a RRC message, (3) an early paging indication (EPI) downlink control information (DCI), (4) paging DCI, and/or (5) a paging record. In some embodiments, the information indicating the one or more DL SDT PDSCH resource sets may be sent to the WTRU 102 before sending the DL SDT paging information and/or the DL SDT HARQ feedback format.

In certain representative embodiments, a DL SDT beam mapping may associate the one or more active DL SDT PDSCH resource sets with one or more beams. For example, the DL SDT payload may be transmitted using at least one of the beams. As described herein, CSI reporting may be used by the network to select at least one of the beams and/or to activate at least one of the DL SDT PDSCH resource sets.

In certain representative embodiments, the transmission, which includes the selected RACH preamble and the HARQ ACK/NACK information associated with the DL SDT payload, may also include information indicating a HARQ process identifier associated with the DL SDT payload.

In certain representative embodiments, the DL SDT HARQ feedback format may be indicated to the WTRU 102 using any of the signaling and/or messaging described herein. A DL SDT HARQ mode may be associated with the DL SDT HARQ feedback format and/or the set of RACH preambles. For example, a first mode may use a first set of RACH preambles and a second mode may use a second (e.g., different) set of RACH preambles.

In certain representative embodiments, signaling from a RAN node to a WTRU in the downlink direction may include any of a DL SDT paging indication, one or more DL SDT PDSCH resources, a DL SDT selected MCS, a DL SDT HARQ process ID, a DL SDT transport block (TB) size, DL SDT PDSCH-beam association information, a DL SDT PUCCH control resource indication, a DL SDT CSI report request indication, and/or a DL SDT-specific RACH preamble index. The signaling from the RAN to the WTRU in the downlink direction may be provided as one or more IEs and/or may be included as any of (e.g., part of) (1) system information (e.g., SIB1) transmitted over the PBCH, (2) a RRCReconfiguration message transmitted over the PDCCH and/or PDSCH, (3) a RRCConnectionRelease message transmitted over the PDCCH and/or PDSCH, (4) a RRC suspend indication message transmitted over the PDCCH and/or PDSCH, (5) EPI DCI transmitted over the PDCCH, (6) paging DCI for a certain PO transmitted over the PDCCH, and/or (7) a paging record transmitted over the PDSCH.

In certain representative embodiments, a method may be implemented by a WTRU 102 and the method may include receiving information indicating a DL SDT configuration including one or more PDSCH resource sets. Further, the WTRU 102 may receive any of an EPI DCI, a paging DCI, and/or a paging record for a paging occasion. The WTRU 102 may determine whether a DL SDT indication is present in any of the EPI DCI, the paging DCI and/or the paging record for the paging occasion, and, on condition that the DL SDT indication is determined to be present, the WTRU 102 may receive the DL SDT using the one or more PDSCH resource sets. The WTRU 102 may have a suspended radio resource control (RRC) connection to the RAN for at least a duration of the receiving (e.g., from the RAN) of any of the EPI DCI, the paging DCI, and/or the paging record for the paging occasion and the receiving (e.g., from the RAN) of the DL SDT using the one or more PDSCH resource sets.

In certain representative embodiments, the receiving of the paging record may use a PDSCH resource set of the one or more PDSCH resource sets.

In certain representative embodiments, the WTRU 102 may transmit information indicating a DL SDT capability prior to receiving the information indicating the DL SDT configuration of one or more PDSCH resource sets.

In certain representative embodiments, the receiving of the paging DCI, and/or the paging record for the paging occasion may include decoding the paging DCI and/or the paging record using any of a common paging radio network temporary identifier (RNTI), a paging-group RNTI, a common DL SDT RNTI, and/or a group of DL SDT RNTI.

In certain representative embodiments, the DL SDT configuration may include an association (e.g., a mapping) between one or more DL beams and the one or more PDSCH resource sets. For example, the receiving of the DL SDT using the one or more PDSCH resource sets may include receiving the one or more DL beams associated with the one or more DL SDT PDSCH resource sets, and decoding the one or more PDSCH resource sets. As described herein, CSI reporting may be used by the network to select at least one of the beams and/or to activate at least one of the DL SDT PDSCH resource sets.

In certain representative embodiments, the WTRU 102 may perform combining of DL SDT transmissions corresponding to the decoded one or more PDSCH resource sets to determine the received DL SDT payload.

In certain representative embodiments, the WTRU 102 may receive information activating and/or updating the one or more PDSCH resource sets prior to receiving the DL SDT.

In certain representative embodiments, the WTRU 102 may, on condition that the DL SDT indication is determined to be present in the EPI DCI, trigger a sleep mode until a time, associated with the one or more PDSCH resource sets, prior to receiving the DL SDT using the one or more PDSCH resource sets.

In certain representative embodiments, the WTRU 102 may transmit information indicating a hybrid automatic repeat request (HARQ) acknowledgment or negative acknowledgment (ACK/NACK) and/or a HARQ process identifier using one or more physical uplink control channel (PUCCH) resources after receiving the DL SDT while the WTRU 102 has the suspended radio resource control (RRC) connection to the RAN. As an example, the DL SDT configuration may include information indicating the one or more PUCCH resources.

In certain representative embodiments, the WTRU 102 may determine whether the WTRU 102 is in time alignment with the RAN. On condition that the WTRU is in time alignment with the RAN, the WTRU 102 may transmit information indicating a hybrid automatic repeat request (HARQ) acknowledgment or negative acknowledgment (ACK/NACK) using one or more physical uplink control channel (PUCCH) resources for the DL SDT reception feedback.

In certain representative embodiments, the WTRU 102 may determine whether the WTRU 102 is required to measure and report channel state information (CSI), while the WTRU 102 has the suspended radio resource control (RRC) connection to the RAN. For example, on condition that WTRU is requested (e.g., indicated) to report CSI, the WTRU 102 may measure one or more reference signals and transmit a random access channel (RACH) preamble or a service request message which is multiplexed with a CSI report based on the measured one or more reference signals.

In certain representative embodiments, the WTRU 102 may determine whether the WTRU 102 is in time alignment with the RAN. On condition that the WTRU 102 is out of time alignment with the RAN, the WTRU 102 may transmit a random access channel (RACH) preamble which is multiplexed with information indicating a hybrid automatic repeat request (HARQ) acknowledgment or negative acknowledgment (ACK/NACK) for the DL SDT reception.

In certain representative embodiments, the WTRU 102 may measure one or more reference signals. On condition that the WTRU is out of time alignment with the RAN, the WTRU 102 may transmit a random access channel (RACH) preamble which is multiplexed with information indicating the HARQ ACK/NACK for the DL SDT and a channel state information (CSI) report of the measured one or more reference signals while WTRU has the suspended RRC connection to the RAN.

In certain representative embodiments, the WTRU 102 may receive information indicating a time alignment with the RAN after transmitting the RACH preamble.

In certain representative embodiments, the WTRU 102 may transmit a random access channel (RACH) preamble which is multiplexed with information indicating a hybrid automatic repeat request (HARQ) acknowledgment or negative acknowledgment (ACK/NACK) and/or a HARQ process identifier after receiving the DL SDT. For example, the DL SDT configuration may include information indicating the RACH preamble and/or a RACH preamble group or set which includes the RACH preamble.

In certain representative embodiments, the WTRU 102 may determine whether the WTRU is in time alignment with the RAN. On condition that the WTRU is out of time alignment with the RAN, the WTRU 102 may transmit a service request message which is multiplexed with information indicating a hybrid automatic repeat request (HARQ) acknowledgment or negative acknowledgment (ACK/NACK) after receiving the DL SDT.

In certain representative embodiments, the WTRU 102 may measure one or more reference signals. On condition that the WTRU is out of time alignment with the RAN, the WTRU 102 may transmit a service request message which is multiplexed with information indicating the HARQ ACK/NACK for the DL SDT and a channel state information (CSI) report of the measured one or more reference signals.

In certain representative embodiments, the WTRU 102 may receive information indicating a time alignment with the RAN after transmitting the service request message.

In certain representative embodiments, the DL SDT configuration may include information indicating the one or more PDSCH resource sets and information indicating any of a modulation coding scheme of the DL SDT, a hybrid automatic repeat request (HARQ) feedback request, a HARQ process identifier, a transport block size of the DL SDT, an association of the one or more PDSCH resource sets and one or more DL beams, a validity time period for the PDSCH resource sets, one or more physical uplink control channel (PUCCH) resource sets for DL SDT reception feedback, a channel state information (CSI) report request, and/or a random access channel (RACH) preamble associated with the DL SDT.

In certain representative embodiments, the information indicating the DL SDT configuration may be received as part of any of a physical broadcast channel (PBCH) transmission, a physical downlink control channel (PDCCH) transmission, and/or a physical downlink shared channel (PDSCH) transmission.

In certain representative embodiments, a method may be implemented by a WTRU 102 which includes receiving a downlink small data transmission (DL SDT) identifier (ID) associated with the WTRU 102. Further, the WTRU 102 may receive, using time and/or frequency resources associated with a DL SDT search space, downlink control information (DCI) which includes a DL SDT early paging indicator (EPI). On condition that the DL SDT EPI is scrambled with the DL SDT ID, the WTRU 102 may receive a DL SDT payload using one or more sets of DL SDT physical downlink shared channel (PDSCH) resources.

In certain representative embodiments, a method may be implemented by a WTRU 102 which includes receiving a downlink small data transmission (DL SDT) identifier (ID) associated with a paging group. Further, the WTRU 102 may receive, using time and/or frequency resources associated with a DL SDT search space, first downlink control information (DCI) which includes information indicating DL SDT early paging. On condition that the DL SDT EPI is scrambled with the DL SDT ID, the WTRU 102 may receive second DCI which schedules a paging record. The WTRU 102 may receive the paging record. On condition that the paging record includes information indicating that the WTRU 102 is paged for DL SDT, receiving a DL SDT payload using one or more sets of DL SDT physical downlink shared channel (PDSCH) resources.

In certain representative embodiments, a method may be implemented by a WTRU 102 which includes receiving a downlink small data transmission (DL SDT) identifier (ID) associated with DL SDT. Further, the WTRU 102 may receive, using time and/or frequency resources associated with a DL SDT search space, first downlink control information (DCI) which includes information indicating DL SDT early paging. On condition that the DL SDT EPI is scrambled with the DL SDT ID, the WTRU 102 may receive second DCI which schedules a paging record. The WTRU 102 may receive the paging record. On condition that the paging record includes information indicating that the WTRU 102 is paged for DL SDT, the WTRU 102 may receive a DL SDT payload using one or more sets of DL SDT physical downlink shared channel (PDSCH) resources.

In certain representative embodiments, the WTRU 102 may, before receiving any of the first DCI, the second DCI, the paging record, and/or the SL SDT payload, receive a radio resource control (RRC) release message which suspends an RRC connection from the WTRU to a base station.

In certain representative embodiments, the WTRU 102 may, after receiving the SL SDT payload, send a radio resource control (RRC) resume or re-establishment message to a base station.

In certain representative embodiments, the WTRU 102 may receive information indicating any of the time and/or frequency resources associated with the DL SDT search space, a validity duration of the DL SDT search space, and/or a periodicity of the DL SDT search space.

In certain representative embodiments, a method may be implemented by a WTRU 102 and the method may include the WTRU 102 receiving information indicating a configuration which includes a downlink (DL) small data transmission (SDT) hybrid automatic repeat request (HARQ) feedback mode. On condition that the WTRU 102 is being paged for DL SDT, the WTRU 102 may receive a DL SDT payload using one or more sets of DL SDT physical downlink shared channel (PDSCH) resources. The WTRU 102 may proceed to transmit uplink control information which includes DL SDT HARQ feedback information associated with the DL SDT payload according to the indicated DL SDT HARQ mode.

In certain representative embodiments, a method may be implemented by a WTRU 102 and the method may include the WTRU 102 receiving information indicating a configuration which includes a downlink (DL) small data transmission (SDT) hybrid automatic repeat request (HARQ) feedback mode. On condition that the WTRU 102 is being paged for DL SDT, the WTRU 102 may receive a DL SDT payload using one or more sets of DL SDT physical downlink shared channel (PDSCH) resources. The WTRU 102 may transmit a random access channel (RACH) preamble at a RACH occasion according to the indicated DL SDT HARQ mode. The WTRU 102 may transmit a RRC connection resume or re-establishment request according to the indicated DL SDT HARQ mode, and the RRC connection resume or re-establishment request may include DL SDT HARQ feedback information associated with the DL SDT payload.

In certain representative embodiments, a method may be implemented by a WTRU 102 and the method may include the WTRU 102 receiving information indicating a configuration which includes a downlink (DL) small data transmission (SDT) hybrid automatic repeat request (HARQ) feedback mode. On condition that the WTRU is being paged for DL SDT, the WTRU 102 may receive a DL SDT payload using one or more sets of DL SDT physical downlink shared channel (PDSCH) resources. The WTRU 102 may select a random access channel (RACH) preamble from a set of RACH preambles based on a paging record associated with the DL SDT payload according to the indicated DL SDT HARQ mode. The WTRU 102 may transmit the selected RACH preamble which includes DL SDT HARQ feedback information associated with the DL SDT payload according to the indicated DL SDT HARQ mode.

In certain representative embodiments, the RACH preamble may be selected based on a mapping of a WTRU ID of the WTRU to information indicated in the paging record.

In certain representative embodiments, the RACH preamble may be selected based on an order in which information indicating the WTRU is located in the paging record.

In certain representative embodiments, the WTUR 102, before receiving the paging record, and/or the SL SDT payload, may receive a radio resource control (RRC) release message which suspends an RRC connection from the WTRU to a base station.

In certain representative embodiments, the WTRU 102, after receiving the SL SDT payload, may send a radio resource control (RRC) resume or re-establishment message to a base station.

In certain representative embodiments, the set of RACH preambles may be associated with an acknowledgment of receiving and/or decoding the DL SDT payload.

In certain representative embodiments, the set of RACH preambles may be associated with a negative acknowledgment of receiving and/or decoding the DL SDT payload.

In certain representative embodiments, the set of RACH preambles may be associated with a group of WTRUs.

In certain representative embodiments, the received configuration information may include an indication of an association between the WTRU and the selected RACH preamble.

In certain representative embodiments, a size of a DL SDT payload may be any of the sizes and/or ranges shown in Table 1.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-ID. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 6 or means-plus-function claim format, and any claim without the terms “means for” is not so intended.

What is claimed is:

1. A method implemented by a wireless transmit/receive unit (WTRU), the method comprising:
receiving downlink (DL) small data transmission (SDT) paging information;
on condition the DL SDT paging information indicates the WTRU is being paged, measuring one or more reference signals (RSs);
selecting a random access channel (RACH) preamble from a set of RACH preambles based on (1) a paging record associated with the DL SDT paging information and/or (2) a DL SDT hybrid automatic repeat request (HARQ) mode; and
sending a transmission which includes the selected RACH preamble and/or a channel state information (CSI) report which includes information associated with the one or more measured RSs.

2. A method implemented by a wireless transmit/receive unit (WTRU), the method comprising:
receiving downlink (DL) small data transmission (SDT) paging information;
on condition the DL SDT paging information indicates the WTRU is being paged, measuring one or more reference signals (RSs);
selecting a random access channel (RACH) preamble;
sending the selected RACH preamble during an associated RACH occasion;
receiving a random access response; and
after receiving the random access response, sending a transmission which includes a service request and/or a channel state information (CSI) report which includes information associated with the one or more measured RSs.

3. The method of any of claims 1-2, wherein the DL SDT paging information is included in any of: (1) an early paging indication (EPI) downlink control information (DCI), (2) paging DCI, and/or (3) a paging record.

4. The method of any of claims 1-3, further comprising:
receiving information indicating a request for the CSI report which is included in any of: (1) system information, (2) a radio resource control (RRC) message, (3) an early paging indication (EPI) downlink control information (DCI), (4) paging DCI, and/or (5) a paging record.

5. The method of any of claims 1-4, further comprising:
receiving configuration information indicating time/frequency resources of the one or more RSs.

6. The method of claim 5, wherein the configuration information includes a periodicity associated with the CSI report.

7. The method of claim 5, wherein the configuration information includes one or more triggers associated with the CSI report.

8. The method of any of claims 5-7, wherein the information indicating the configuration information is included in any of: (1) system information, (2) a radio resource control (RRC) message, (3) an early paging indication (EPI) downlink control information (DCI), (4) paging DCI, and/or (5) a paging record.

9. The method of any of claims 5-8, further comprising:
receiving information to activate or deactivate configuration information.

10. The method of any of claims 1-9, further comprising:
receiving information indicating one or more DL SDT physical downlink shared channel (PDSCH) resource sets.

11. The method of claim 10, further comprising:
after sending the CSI report, receiving a DL SDT payload, associated with the DL SDT paging information, using the one or more DL SDT PDSCH resource sets.

12. The method of any of claims 1-11, wherein the DL SDT paging information is received after receiving a connection release or suspend message.

13. The method of claim 12, wherein the connection release or suspend message is a radio resource control (RRC) message.

14. The method of claim 2, wherein the service request is a radio resource control (RRC) message.

15. The method of claim 14, wherein the RRC message is a RRC setup or establishment request message.

16. The method of claim 1, wherein the DL SDT HARQ mode is included in any of: (1) system information, (2) a radio resource control (RRC) message, (3) an early paging indication (EPI) downlink control information (DCI), (4) paging DCI, and/or (5) a paging record.

17. The method of any of claims 1 and 16, wherein the DL SDT HARQ mode indicates that HARQ feedback is to be provided for a DL SDT payload associated with DL SDT paging information.

18. A wireless transmit/receive unit (WTRU) comprising:
a processor and a transceiver which are configured to:
receive downlink (DL) small data transmission (SDT) paging information;
on condition the DL SDT paging information indicates the WTRU is being paged, measure one or more reference signals (RSs);
select a random access channel (RACH) preamble from a set of RACH preambles based on (1) a paging record associated with the DL SDT paging information and/or (2) a DL SDT hybrid automatic repeat request (HARQ) mode; and
send a transmission which includes the selected RACH preamble and/or a channel state information (CSI) report which includes information associated with the one or more measured RSs.

19. A wireless transmit/receive unit (WTRU):
a processor and a transceiver which are configured to:
receive downlink (DL) small data transmission (SDT) paging information;
on condition the DL SDT paging information indicates the WTRU is being paged, measure one or more reference signals (RSs);
select a random access channel (RACH) preamble;
send the selected RACH preamble during an associated RACH occasion;
receive a random access response; and
after receiving the random access response, send a transmission which includes a service request and a channel state information (CSI) report which includes information associated with the one or more measured RSs.

20. The WTRU of any of claims 18-19, wherein the DL SDT paging information is included in any of: (1) an early paging indication (EPI) downlink control information (DCI), (2) paging DCI, and/or (3) a paging record.

21. The WTRU of any of claims 18-20, wherein the processor and transceiver are configured to:
receive information indicating a request for the CSI report which is included in any of: (1) system information, (2) a radio resource control (RRC) message, (3) an early paging indication (EPI) downlink control information (DCI), (4) paging DCI, and/or (5) a paging record.

22. The WTRU of any of claims 18-21, wherein the processor and transceiver are configured to:
receive configuration information indicating time/frequency resources of the one or more RSs.

23. The WTRU of claim 22, wherein the configuration information includes a periodicity associated with the CSI report.

24. The WTRU of claim 22, wherein the configuration information includes one or more triggers associated with the CSI report.

25. The WTRU of any of claims 22-24, wherein the configuration information is included in any of: (1) system information, (2) a radio resource control (RRC) message, (3) an early paging indication (EPI) downlink control information (DCI), (4) paging DCI, and/or (5) a paging record.

26. The WTRU of any of claims 22-25, wherein the processor and transceiver are configured to:
receive information to activate or deactivate the configuration information.

27. The WTRU of any of claims 18-26, wherein the processor and transceiver are configured to:
receive information indicating one or more DL SDT physical downlink shared channel (PDSCH) resource sets.

28. The WTRU of claim 27, wherein the processor and transceiver are configured to:
after sending the CSI report, receive a DL SDT payload, associated with the DL SDT paging information, using the one or more DL SDT PDSCH resource sets.

29. The WTRU of any of claims 18-28, wherein the DL SDT paging information is received after receiving a connection release or suspend message.

30. The WTRU of claim 18, wherein the connection release or suspend message is a radio resource control (RRC) message.

31. The WTRU of claim 9, wherein the service request is a radio resource control (RRC) message.

32. The WTRU of claim 31, wherein the RRC message is a RRC setup or establishment request message.

33. The WTRU of claim 18, wherein the DL SDT HARQ mode is included in any of: (1) system information, (2) a radio resource control (RRC) message, (3) an early paging indication (EPI) downlink control information (DCI), (4) paging DCI, and/or (5) a paging record.

34. The WTRU of any of claims 18 and 33, wherein the DL SDT HARQ mode indicates that HARQ feedback is to be provided for a DL SDT payload associated with DL SDT paging information.
